(19) United States
(12) Patent Application Publication
(10) Pub. No.: US 2024/0359551 A1
(43) Pub. Date: Oct. 31, 2024

(54) OFF-ROAD VEHICLE

(71) Applicant: Arctic Cat Inc., Thief River Falls, MN (US)

(72) Inventors: Ethan Klaphake, Thief River Falls, MN (US); Gregory Anderson, Thief River Falls, MN (US); Brent Gilge, Thief River Falls, MN (US); Daniel Song, Thief River Falls, MN (US); Lucas Purcell, Thief River Falls, MN (US); Zachary Pritchard, Thief River Falls, MN (US); Hector Coronel Aispuro, Thief River Falls, MN (US); Nathan Deselich, Thief River Falls, MN (US); Alexander Tiemann, Thief River Falls, MN (US); Alex Stirewalt, Thief River Falls, MN (US); John Braniff, Thief River Falls, MN (US); Derek Sorenson, Thief River Falls, MN (US)

(21) Appl. No.: 18/764,146

(22) Filed: Jul. 3, 2024

Related U.S. Application Data
(63) Continuation-in-part of application No. 18/583,801, filed on Feb. 21, 2024.
(63) Continuation-in-part of application No. 18/395,929, filed on Dec. 26, 2023.
(60) Provisional application No. 63/543,461, filed on Oct. 10, 2023.
(60) Provisional application No. 63/572,140, filed on Mar. 29, 2024.
(60) Provisional application No. 63/543,461, filed on Oct. 10, 2023.
(60) Provisional application No. 63/447,525, filed on Feb. 22, 2023.
(60) Provisional application No. 63/437,254, filed on Jan. 5, 2023.

(51) Int. Cl. B60K 5/04; B60D 1/48; B60G 7/00; B60K 5/12; B60K 11/04; B60K 11/06; B60K 17/04; B60K 35/21; B60N 2/20; F01N 13/18; F02M 35/04; F02M 35/16

(52) U.S. Cl. CPC B60K 5/04; B60D 1/48; B60G 7/001; B60K 5/1208; B60K 11/04; B60K 11/06; B60K 17/04; B60K 35/21; B60N 2/20; F01N 13/1805; F02M 35/04; F02M 35/162

(57) ABSTRACT

The present disclosure relates to an off-road vehicle having different features such as a frame having a frame structure, an engine assembly, an exhaust assembly, an engine mount assembly, a suspension assembly, a plurality of wheels, a hitch assembly, and other associated components. Embodiments of the present disclosure also describe a removable frame member facilitating the installation of the engine assembly from a seating area into a rearward portion of the vehicle. The off-road vehicle may further include an engine air intake assembly, an engine cooling assembly, a continuously variable transmission (CVT) cooling assembly, a vehicle cabin cooling assembly, a CVT housing assembly, a door assembly, a dashboard assembly, and other components.

### PRIORITY CLAIMS

This non-provisional application claims the benefit of priority from U.S. Provisional Application Ser. No. 63/543,461 filed Oct. 10, 2023, and 63/572,140 filed Mar. 29, 2024; is a continuation-in-part of the co-pending Non-provisional application Ser. No. 18/583,801 filed Feb. 21, 2024, which claims priority of Provisional Application Ser. No. 63/447,525 filed Feb. 22, 2023; is a continuation-in-part of the co-pending Non-provisional application Ser. No. 18/395,929 filed Dec. 26, 2023, which claims Provisional Application Ser. No. 63/437,254 filed Jan. 5, 2023; the entirety of each of which is incorporated herein by reference.

### INCORPORATION BY REFERENCE

The following application is hereby incorporated by reference: U.S. application Ser. No. 18/671,970, titled “ENGINE VALVE CONFIGURATION”, filed on May 22, 2024.

### FIELD OF THE DISCLOSURE

The present disclosure generally relates to off-road vehicles. More particularly, the present disclosure relates to off-road vehicles and their components.

### BACKGROUND

Vehicles can be classified based on their applications, such as on-road vehicles and off-road vehicles. Examples of the on-road vehicles include motorbikes; automobiles such as sedan, hatchbacks, wagons, sport-utility vehicles (SUV). Examples of the off-road vehicles include recreational off-highway vehicles (ROV) such as all-terrain vehicles (ATVs) and side-by-sides or utility terrain vehicles (UTVs, both utility and sport), enduro and motocross motorcycles, and the like. Of course, some of these vehicles cross over between some on-road use and some off-road use. In summary, the designs and structures of such vehicles differ to one degree or another due to their end applications. More particularly, a design of a frame structure, an engine assembly, and an exhaust assembly of an off-road vehicle may vary as compared to those of an on-road vehicle. For instance, space required by the on-road vehicle might not be as much of a constraint. Hence, a frame structure of the on-road vehicle is generally larger/bigger as compared to an off-road vehicle. It is advantageous for the off-road vehicle to have a design of frame, engine, and transaxle such that a minimal space is advantageous to keep a compact overall footprint. Also, due to high impact and forces generated by highly variable terrain, the frame structures of off-road vehicles might need to be stronger and more resilient.

As mentioned above, the off-road vehicles, for example side-by-side vehicles, are used for adventure activities, such as hunting, trail riding, and racing. The side-by-side vehicles include seating for a driver and passenger in a side-by-side arrangement. Due to space constraints and performance concerns of a side-by-side vehicle, this side-by-side seating often pushes an engine assembly to a tight space between a seating area and a rear axle. Such placement of the engine assembly towards a rear end of the vehicle provides desired balance to the vehicle while driving so as to limit excessive forward pitching of the vehicle and keep the vehicle stable through rough terrain at variable speeds. Apart from the stability, it is important to control noise, vibration, and harshness (NVH) of the vehicle for providing a better riding experience. However, some of the vehicle components conflict with each other due to the tight space constraints. Such configuration might cause excessive heat generation, deterioration of vehicle components and the like due to friction, oversized vehicles to fit all components, and non-ideal mass distribution thereby reducing performance of the vehicle, increasing weight and vehicle size, increasing maintenance cost, and increasing installation and maintenance difficulties. For example, a rear suspension assembly may conflict with the engine assembly, which might affect both components' performance.

In addition, the arrangement/placement of the exhaust assembly might be critical for vehicle performance. The arrangement of the exhaust assembly for an on-road vehicle might be different from that of an off-road vehicle. In the prevalent off-road vehicles, the exhaust gases are expelled from the engine into the exhaust assembly from a front side of the engine and an air intake is on a rear side of the engine. Such configuration might be overly complex, provide lower flexibility, and cause the engine to consume more power. Further, the exhaust assembly is generally mounted to a separate mounting structure connected to the frame. Such existing mounting arrangements require additional flexible couplers in order to accommodate the flexing and stresses involved. However, such additional flexible couplers are heavy and expensive.

Further, the off-road vehicles may be used for performing heavy-duty work. Work might include transporting cargo, hauling equipment, towing loads, and the like. Different external loads may be externally attached to vehicles using a receiver hitch. Various receiver hitches are used for attaching external loads to the vehicle using cargo carriers, racks, and/or drawbars, depending on the desired load or trailer. Examples receiver hitches include bumper mount receiver hitches, classes I-V receiver hitches, and the like. Different vehicles might have different designs of receiver hitches to connect the external loads. Based on an external load to carry, sizes of the receiver hitch vary. For instance, a class V (or heavy duty) receiver hitch has different design as compared to a bumper mount receiver hitch. Furthermore, off-road vehicles may be involved in recovery efforts for other stuck vehicles or the vehicle itself might be stuck. Common recovery methods involve attaching a chain or recovery strap to a safety chain cut-out or loop on the receiver hitch. In some other instances a ball mount may be used for recovery. Significant loads may be introduced in such recovery efforts. Often the loads are off-axis from the longitudinal axis of the vehicle.

The off-road vehicles may use compact receiver hitches or hitch mounts due to the compact size of the overall vehicle. Such hitch mounts are generally attached to a single frame member without significant surrounding support. When a heavy external load is attached to the vehicle or during recovery efforts, the loads might damage the hitch or even the vehicle frame to which the hitch is secured. In an absence of a significant support and lack of appropriate load distribution, a portion or the whole hitch mount may be bent, broken, or dismantled due to movement of vehicles in, for example, uneven path or a steep curve, as the torque applied to the drawbar or the safety chain loops/cut-outs, and hence to the hitch mount.

For these and other reasons, designs and structures of several components of the vehicles are critical for the off-road vehicles. To provide a better performance of the off-road vehicles, different modifications are being made while designing one or more components of off-road vehicles.

### SUMMARY OF THE DISCLOSURE

The present disclosure sets forth an off-road vehicle that extends in a longitudinal direction parallel to a horizontal plane. The off-road vehicle includes different features such as a frame, an engine assembly, an exhaust assembly, an engine mount assembly, a suspension assembly, a plurality of wheels, a hitch assembly, and other associated components. The suspension assembly comprises a front suspension assembly and a rear suspension assembly. The off-road vehicle may further include an engine air intake assembly, an engine cooling assembly, a continuously variable transmission (CVT) cooling assembly, a vehicle cabin cooling assembly, a CVT housing assembly, a door assembly, and other components.

In some embodiments, the engine mount assembly is configured for attaching the engine assembly to the frame. The engine assembly includes a front part and a rear part. The frame comprises a front frame coupling and a rear frame coupling. The engine mount assembly comprises a front mount assembly for attaching the front part of the engine assembly to the front frame coupling of the frame. The engine mount assembly also comprises a rear mount assembly for attaching the rear part of the engine assembly to the rear frame coupling of the frame.

In some embodiments, the rear mount assembly comprises a rear mount bracket. The rear mount bracket is defined by a rear central portion having a first side edge, a second side edge, and a supporting flange extending upwardly from each of the first side edge and the second side edge. The rear mount bracket is configured to be attached to a rear part of the engine assembly at the supporting flange thereof. The rear mount assembly also comprises a rear transverse bar defined by a first end, a second end, and a rear central part extending therebetween. The rear transverse bar is configured to be attached to the rear central portion of the rear mount bracket at a first top surface of the rear central part. Further, the rear mount assembly also comprises a pair of rear isolators configured to be attached to the rear transverse bar and to the frame.

In some embodiments, the frame for the off-road vehicle extending in a longitudinal direction of the vehicle and defining a seating area and an engine area. The frame comprises a front frame structure, a first side structure, and a second side structure. In said embodiment, the front frame structure facilitates the installation of the engine assembly from the seating area to the engine area. The front frame structure comprises a first side portion defining a first side, and a second side portion defining a second side. The first side portion is configured to be attached to the first side structure and a second side portion defining the second side thereof. The second side portion is configured to be attached to the second side structure. The front frame structure further comprises a front central portion configured to be removably attached between the first side portion and the second side portion. The front central portion comprises a first member, a second member, and a first cross member attached therebetween. The front central portion is positioned in a lateral direction of the vehicle and at least partially forward to the installed engine assembly.

In some embodiments, the present disclosure sets forth a method of installing an engine assembly in an off-road vehicle using the engine mount assembly as described above. The method comprises the steps of: attaching the rear transverse bar with the pair of rear isolators, attaching a rear part of the engine assembly with the rear mount bracket, receiving the engine assembly within the seating area, guiding the engine assembly to the engine area from the seating area, attaching the rear transverse bar with the rear mount bracket, attaching a front part of the engine assembly with the front engine mount assembly, and attaching the removable front central portion with the first side portion and the second side portion.

In some embodiments, the exhaust assembly is configured to be coupled to the rear mount assembly. The exhaust assembly includes an exhaust muffler, an exhaust pipe, and a muffler mount bracket. The exhaust pipe includes a first pipe coupled to an exhaust manifold and a second pipe coupled to the exhaust muffler. The muffler mount bracket is defined by a head end and a tail end. The muffler mount bracket is coupled to the exhaust muffler at the head end and to the rear mount assembly at the tail end.

In some embodiments, the rear suspension assembly comprises a pair of rear upper A-arms and a pair of rear lower A-arms. Each of the pair of the rear upper A-arms comprises a rear upper forward member and a rear upper rearward member. The rear upper forward member of each of the pair of the rear upper A-arms comprises a first section extending from a first wheel mounting end, a second section attached to the first section at least at a first angle and extending towards the rear side of the vehicle, and a third section attached to the second section and extending towards the frame, thereby forming a curved rear upper forward member.

The curved rear upper forward member of each of the pair of the rear upper A-arms is configured to facilitate positioning of a rear damping member rearward thereto, which provides an additional space and prevents conflict with a continuously variable transmission (CVT) assembly or a transaxle assembly. Further, each of the pair of the rear upper A-arms and the pair of the rear lower A-arms is mounted to the frame at a corresponding rear pivot location that is positioned rearwardly towards the rear side of the vehicle. The pair of the rear upper A-arms and the pair of the rear lower A-arms having such mounting facilitate rearward positioning of an engine or the transaxle assembly or the CVT assembly.

In some embodiments, the hitch assembly comprises a base plate and a top member configured to be coupled to the base plate. The base plate and the top member, when coupled, form a second cavity corresponding to a drawbar for receiving the drawbar therewithin. The base plate may comprise a second top surface. The top member may be defined by a pair of side walls and a top wall. The top member may be configured to be coupled to the second top surface of the base plate by the pair of side walls, thereby making a second cavity for receiving a drawbar therewithin.

In some embodiments, the hitch assembly further comprises a pair of supporting plates coupled to the second top surface of the base plate. Each of the pair of supporting plates includes a cut-out portion that is configured to receive the top member therewithin.

### BRIEF DESCRIPTION OF THE DRAWINGS

A more complete understanding of the present disclosure may be derived by referring to the detailed description and claims when considered in connection with the Figures, wherein like reference numerals refer to similar elements throughout the Figures.

FIGS. 1A-1B illustrate exemplary front perspective views of off-road vehicles.

FIG. 1C illustrates an exemplary isometric view of an off-road vehicle from front and side of the vehicle in accordance with the present disclosure.

FIGS. 1D-1E illustrate exemplary side views of an off-road vehicle in accordance with the present disclosure.

FIG. 1F illustrates an exemplary isometric view of an off-road vehicle from rear and side of the vehicle in accordance with the present disclosure.

FIG. 1G illustrates an exemplary front view of an off-road vehicle in accordance with the present disclosure.

FIG. 1H illustrates an exemplary rear view of an off-road vehicle in accordance with the present disclosure.

FIG. 1I illustrates an exemplary top view of an off-road vehicle in accordance with the present disclosure.

FIGS. 2A-2B illustrate exemplary isometric views of a frame with an engine assembly secured therewith in accordance with the present disclosure.

FIGS. 2C-2D illustrate exemplary side views of a frame with an engine assembly secured therewith in accordance with the present disclosure.

FIG. 2E illustrates an exemplary rear view of a frame with an engine assembly secured therewith in accordance with the present disclosure.

FIG. 2F illustrates an exemplary top view of a frame with an engine assembly secured therewith in accordance with the present disclosure.

FIG. 2G illustrates an exemplary bottom view of a frame with an engine assembly secured therewith in accordance with the present disclosure.

FIGS. 2H-2I illustrate exemplary isometric views of a frame, without a rollover protection structure (ROPS) and a skid plate, with an engine assembly secured therewith in accordance with the present disclosure.

FIGS. 2J-2K illustrate exemplary side views of a frame, without a rollover protection structure (ROPS) and a skid plate, with an engine assembly secured therewith in accordance with the present disclosure.

FIG. 2L illustrates an exemplary rear view of a frame, without a rollover protection structure (ROPS) and a skid plate, with an engine assembly secured therewith in accordance with the present disclosure.

FIG. 2M illustrates an exemplary top view of a frame, without a rollover protection structure (ROPS) and a skid plate, with an engine assembly secured therewith in accordance with the present disclosure.

FIG. 2N illustrates an exemplary bottom view of a frame, without a rollover protection structure (ROPS) and a skid plate, with an engine assembly secured therewith in accordance with the present disclosure.

FIGS. 20-2P illustrate exemplary isometric views of a frame of an off-road vehicle in accordance with the present disclosure.

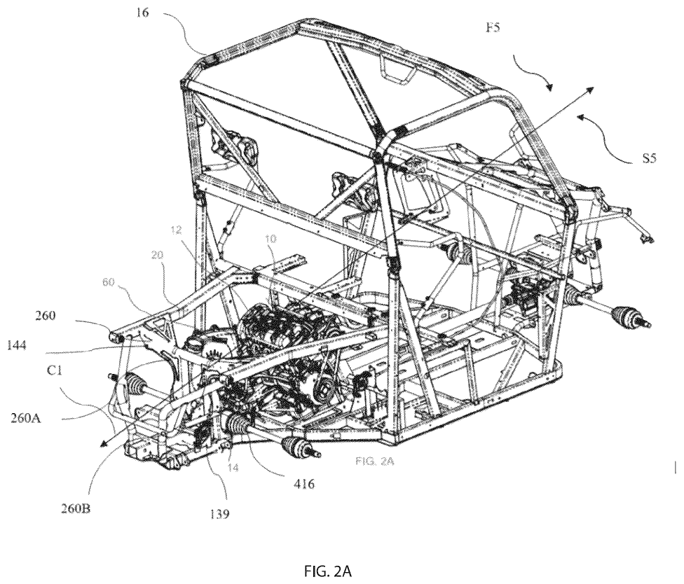

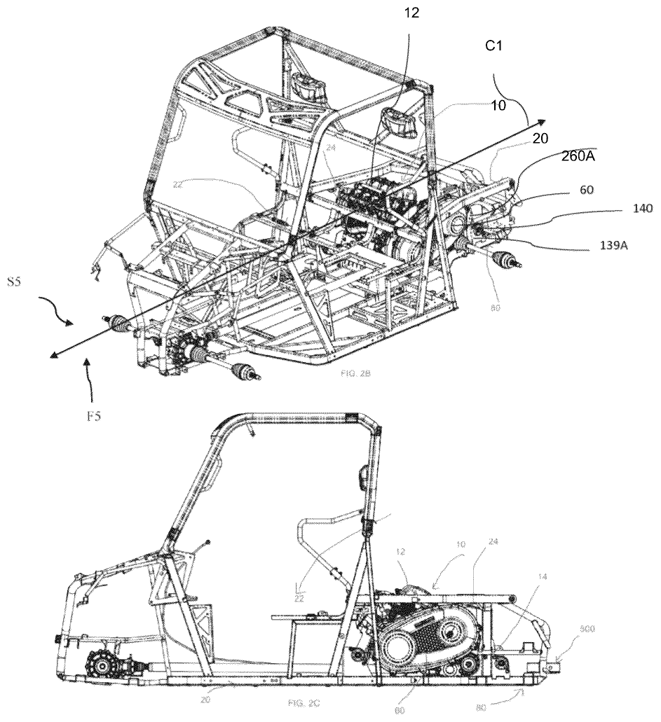

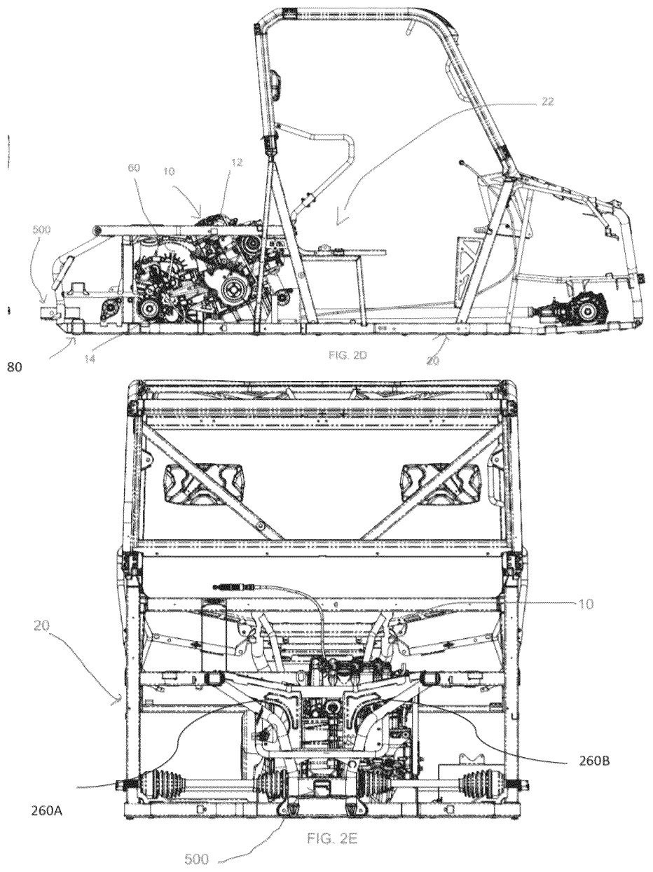

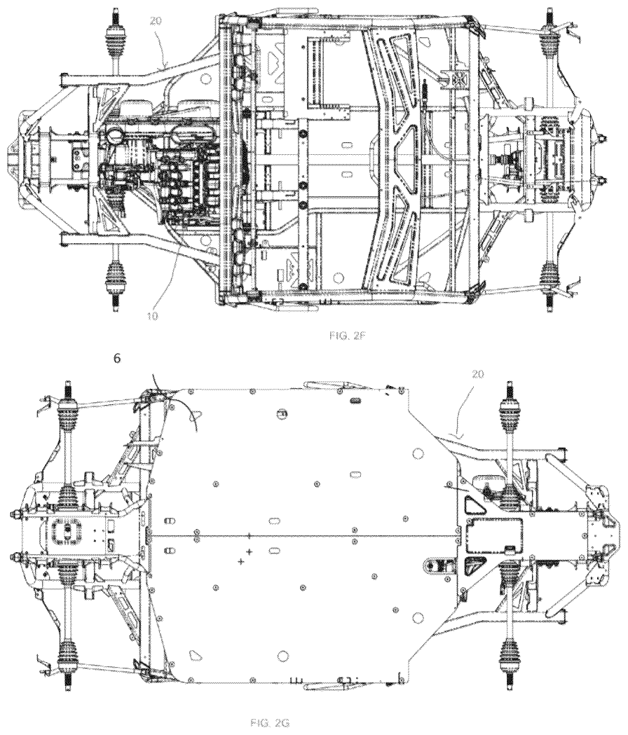

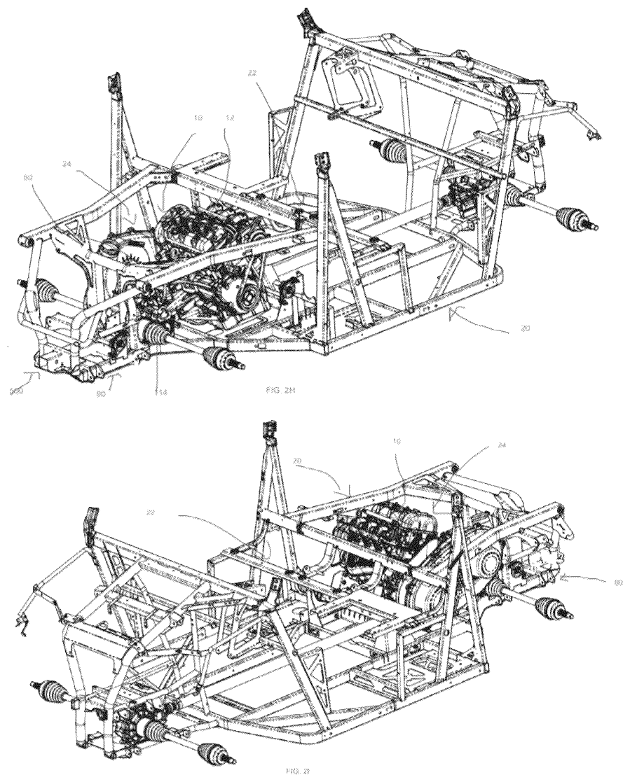

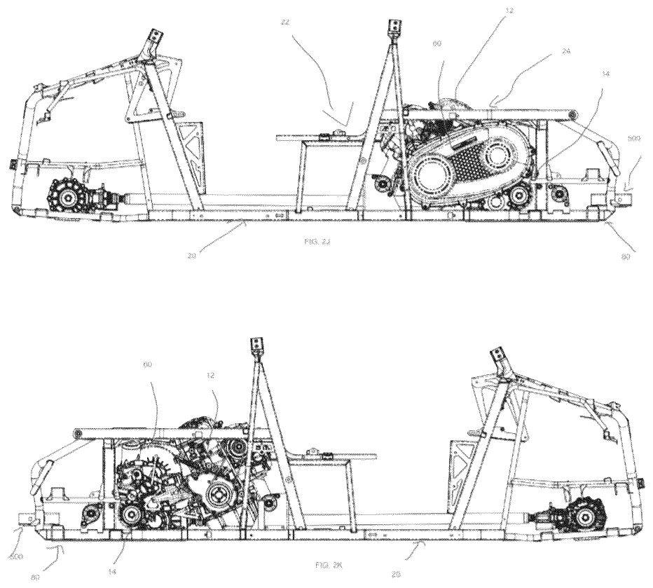

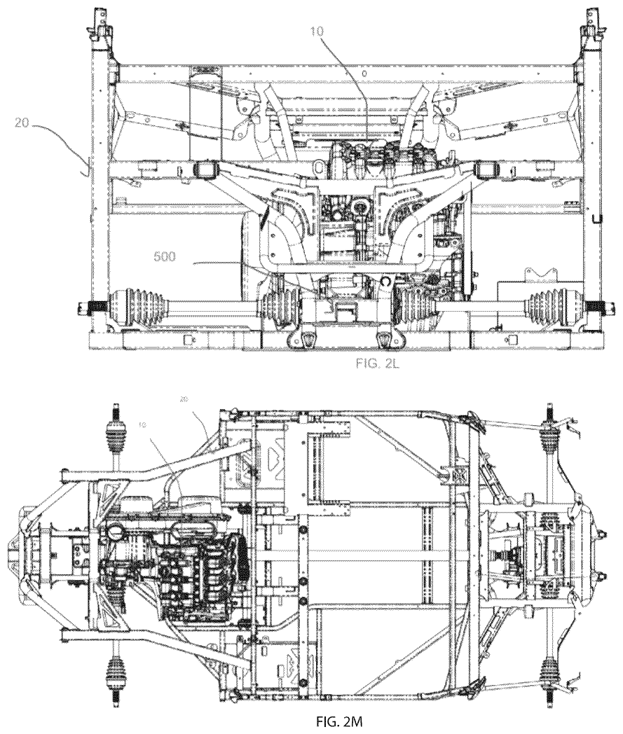

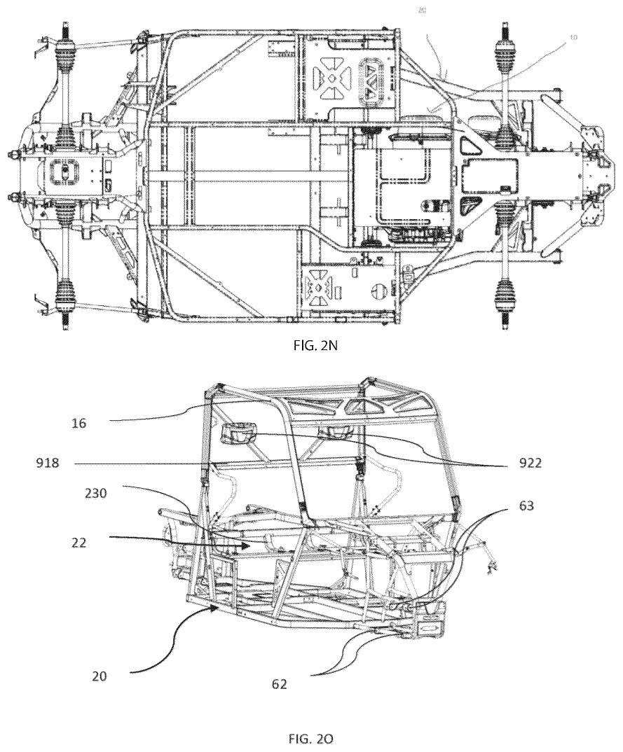

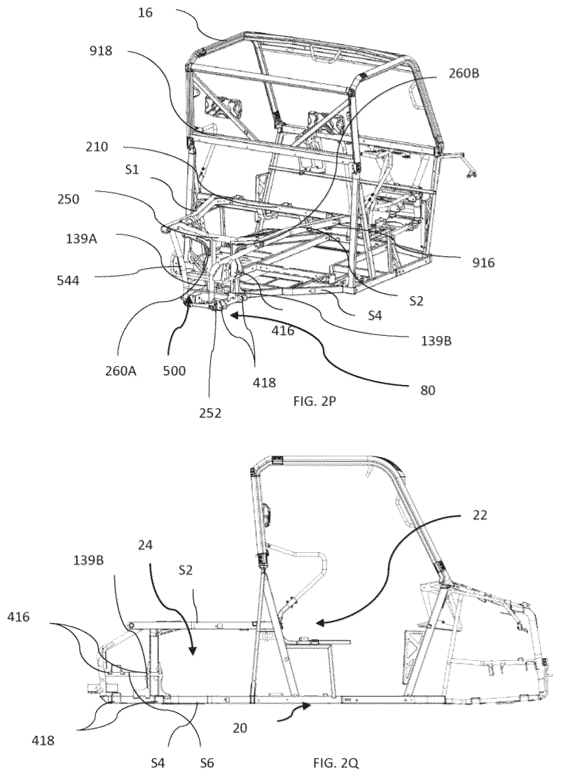

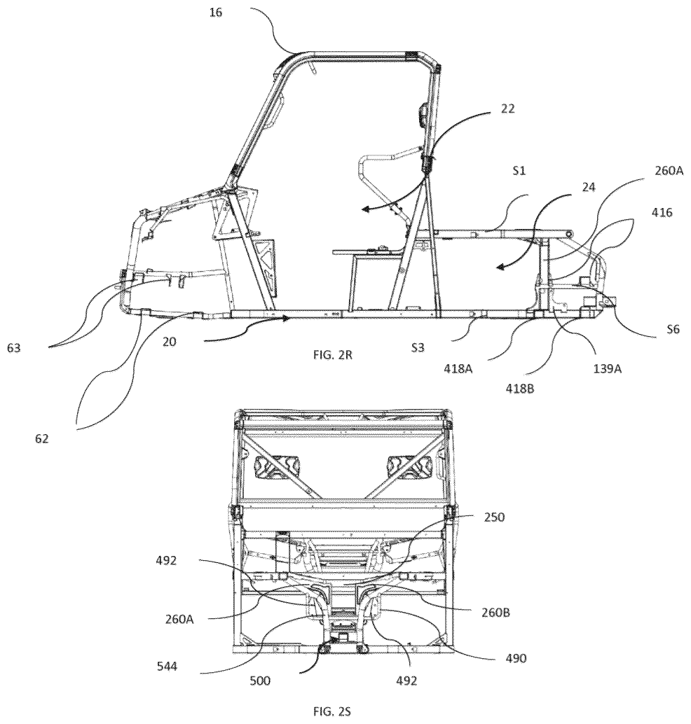

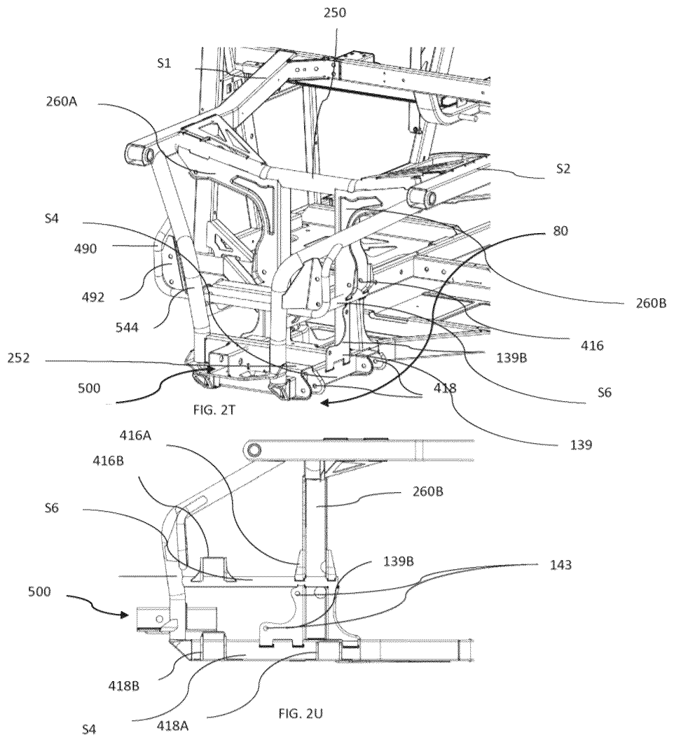

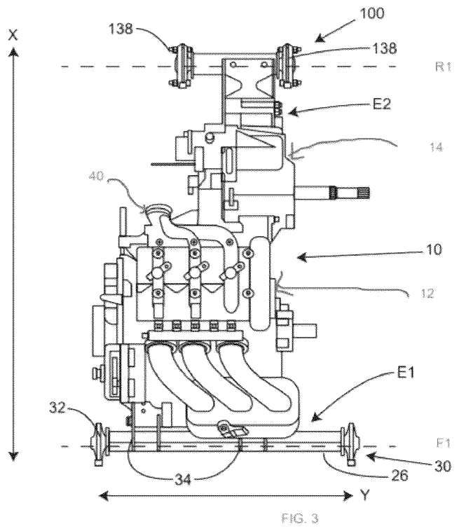

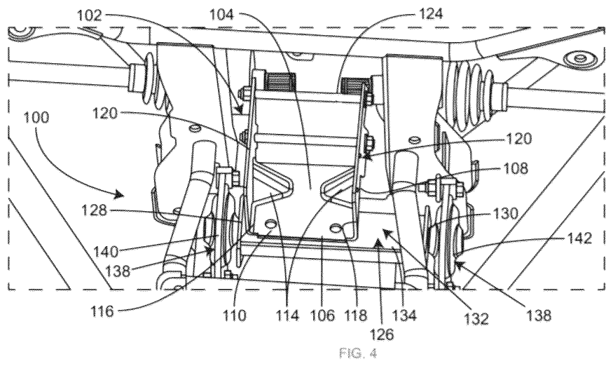

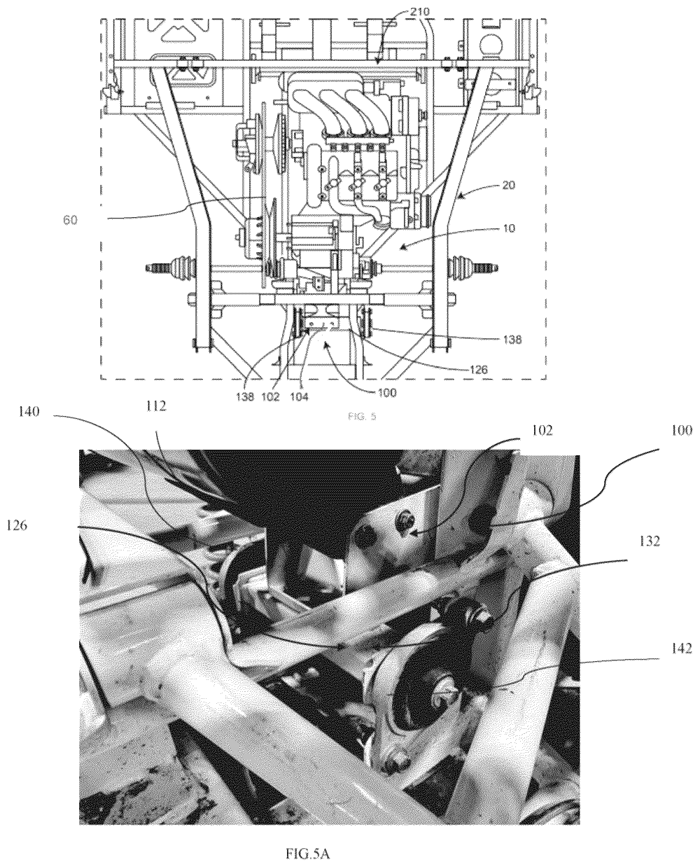

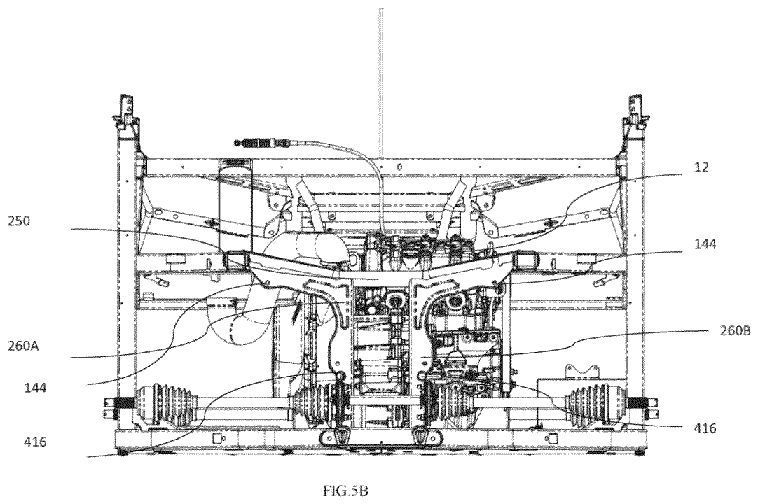

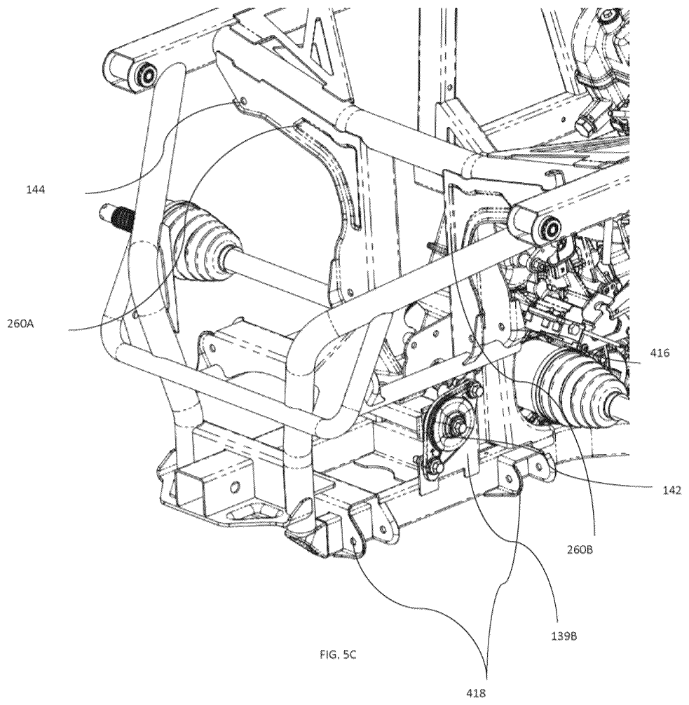

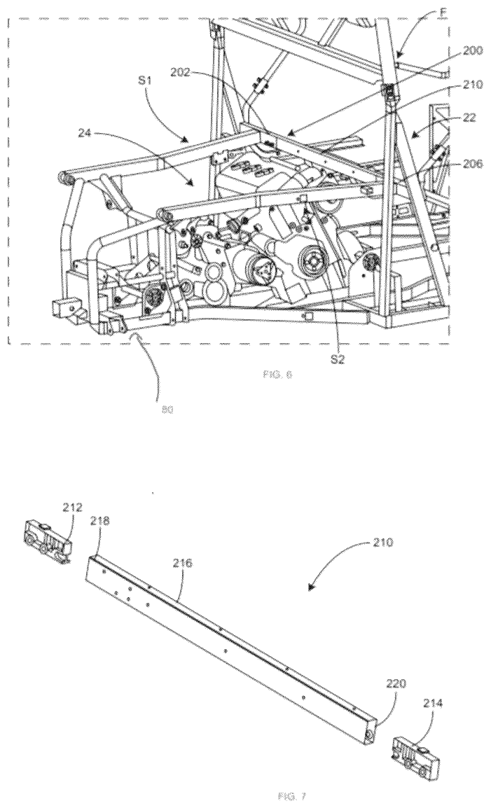

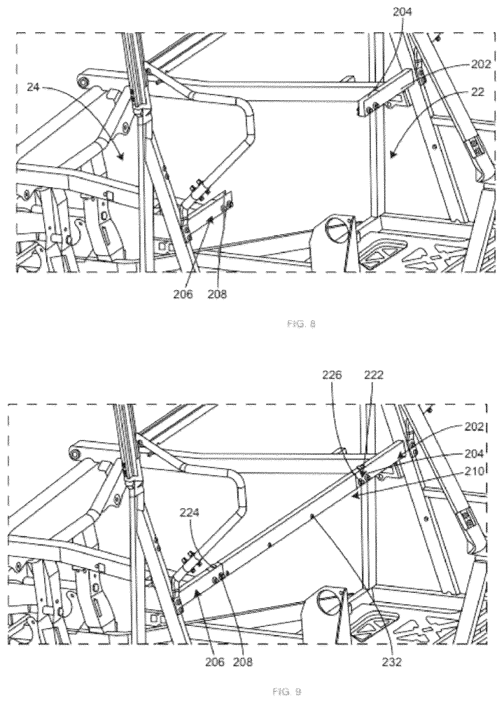

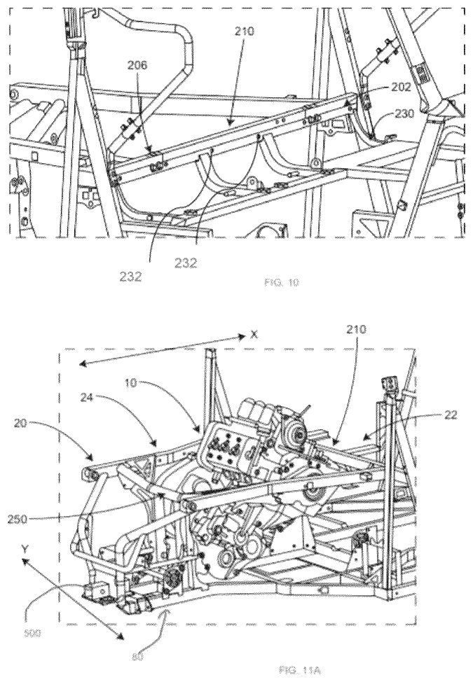

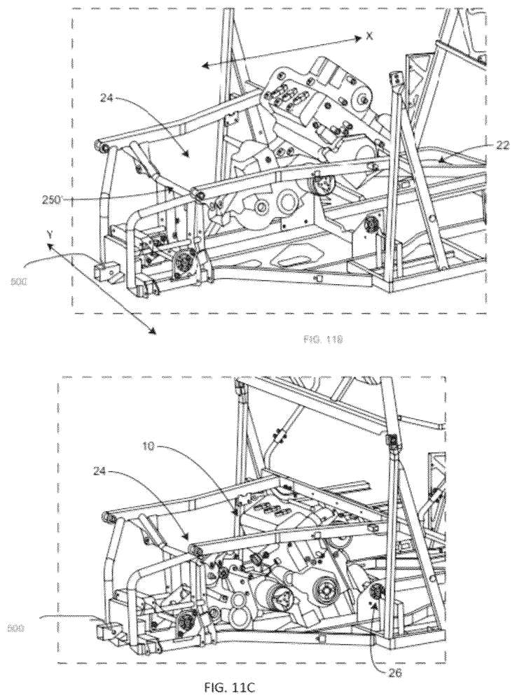

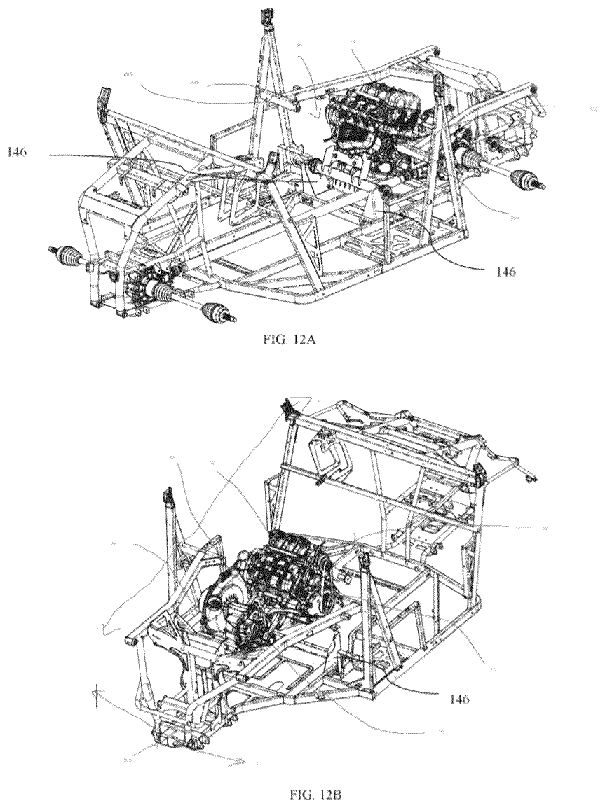

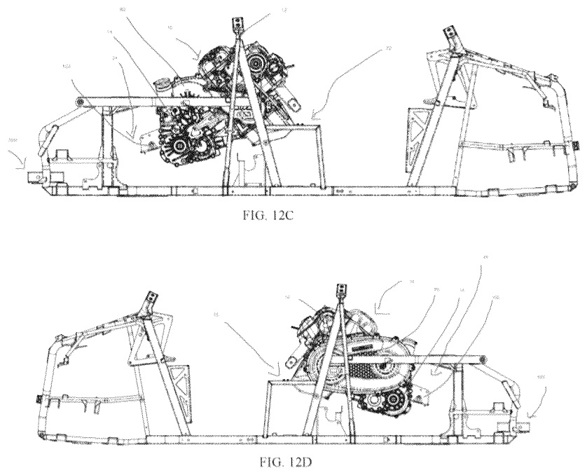

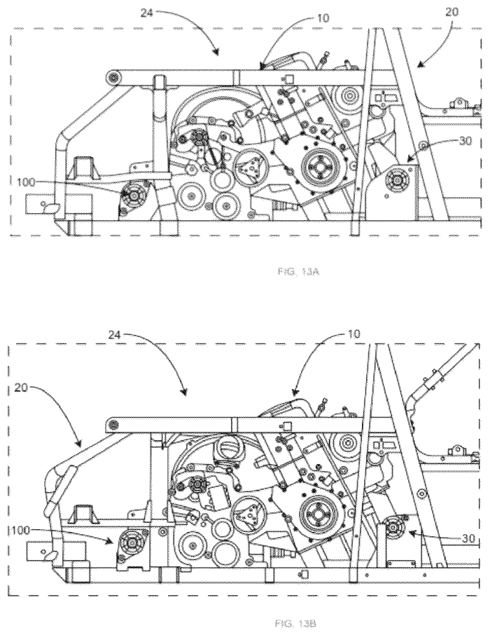

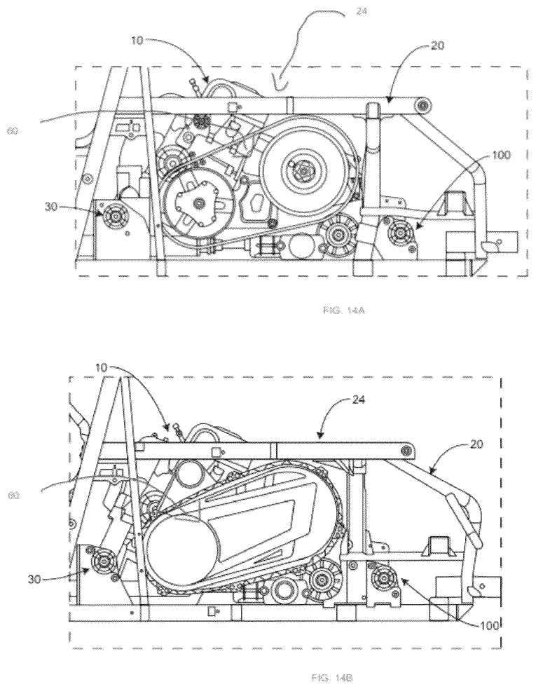

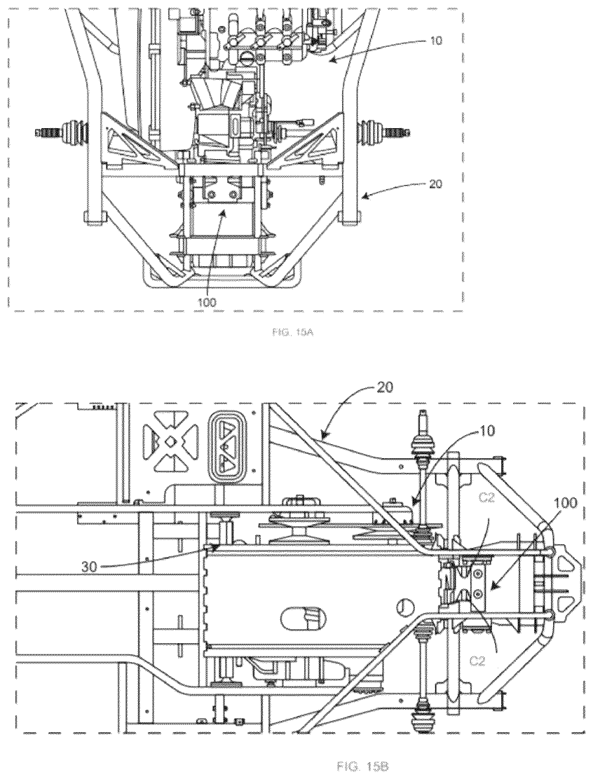

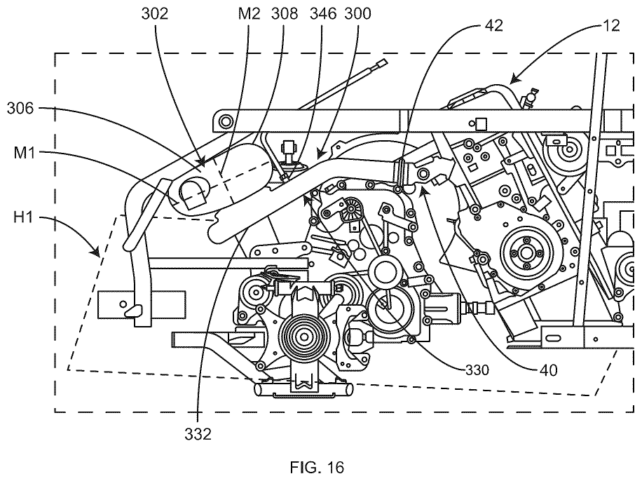

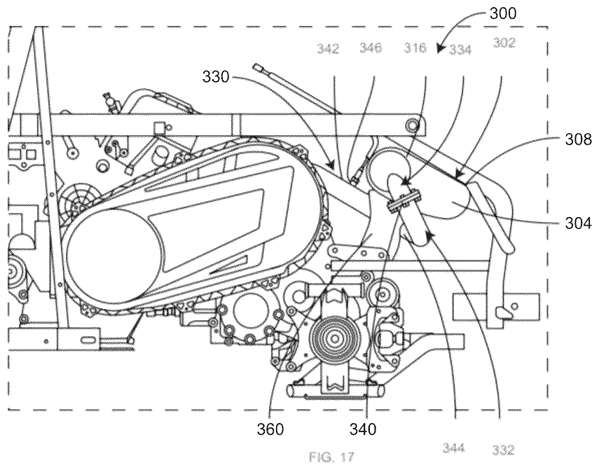

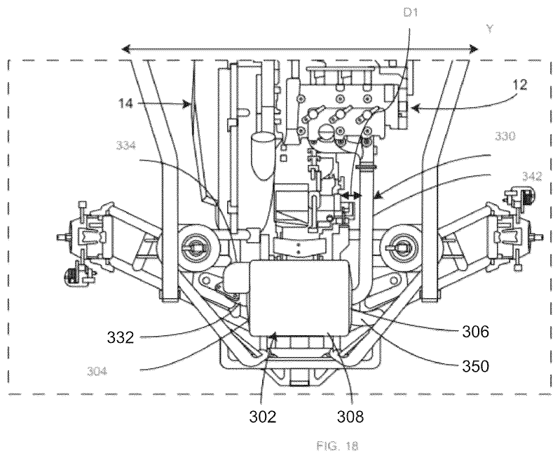

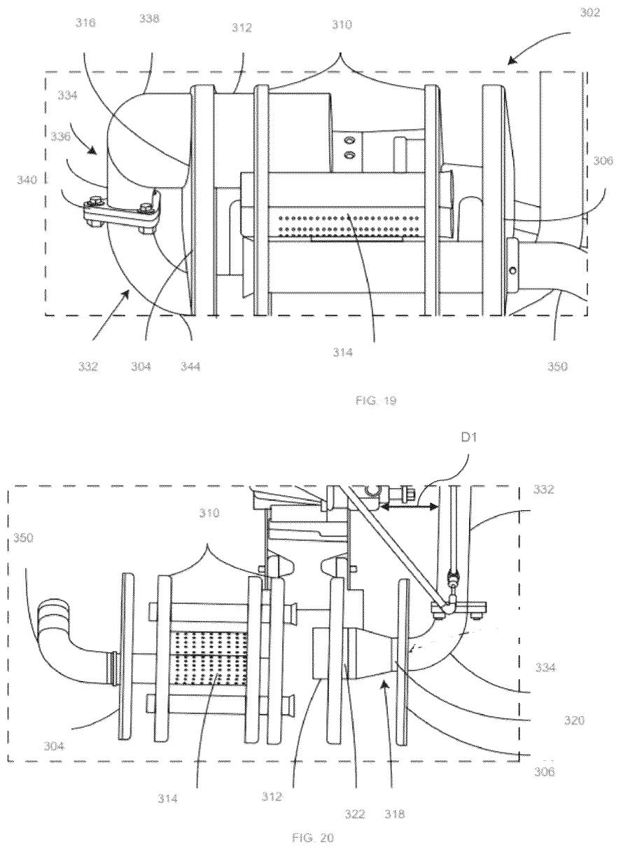

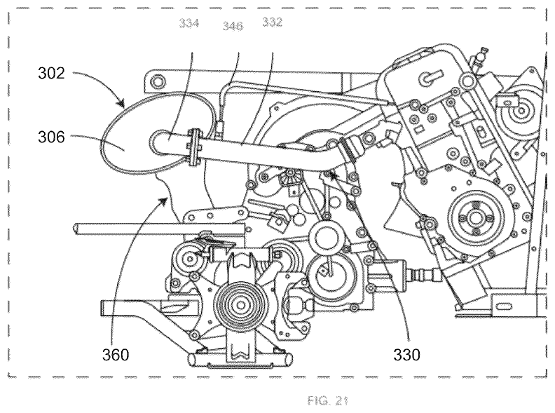

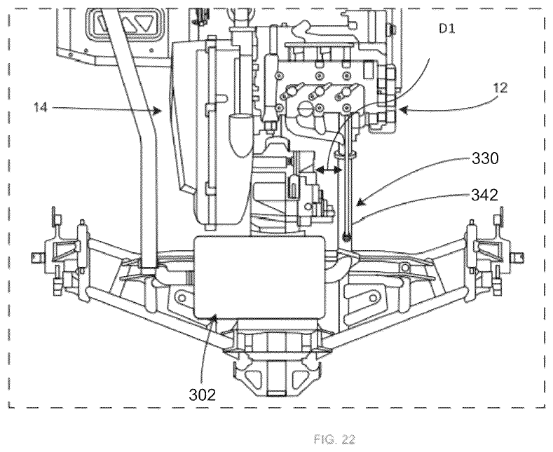

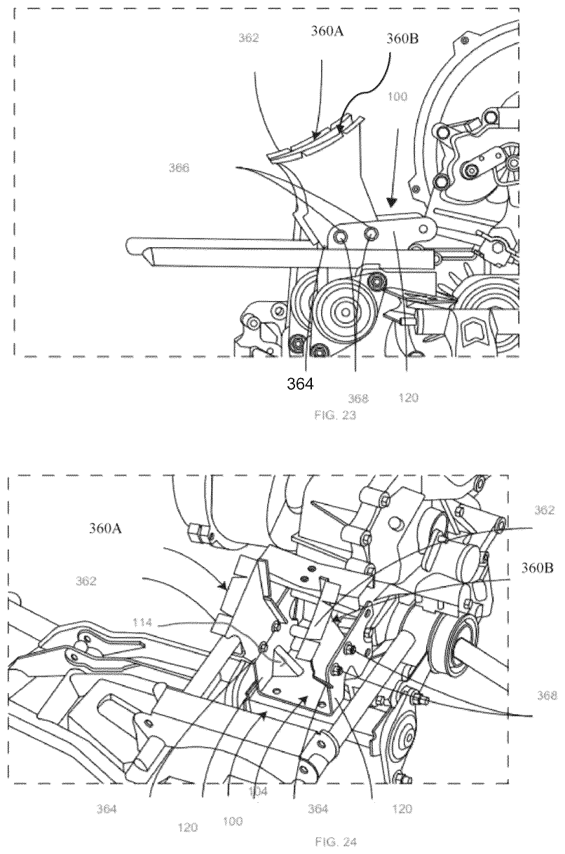

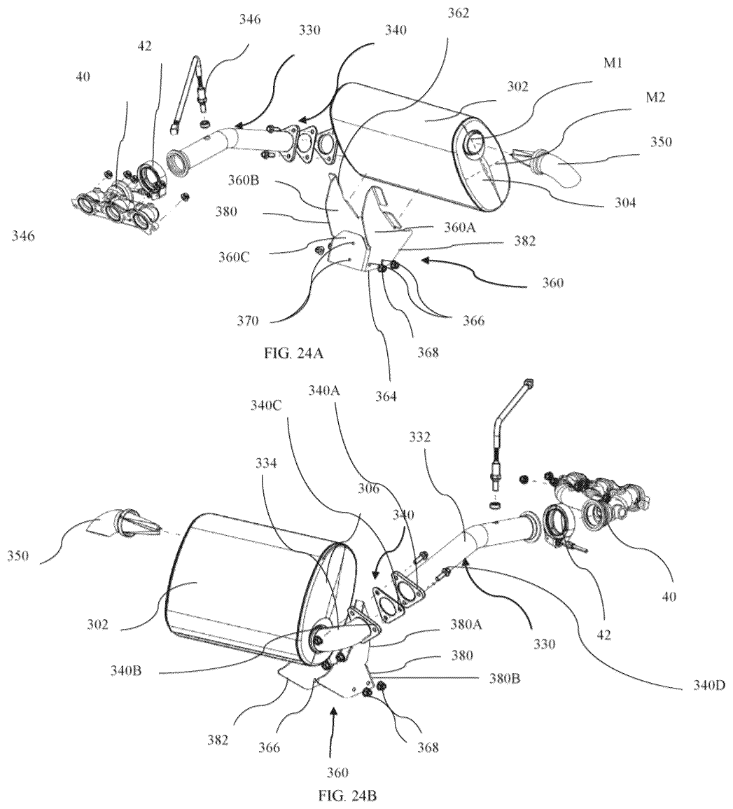

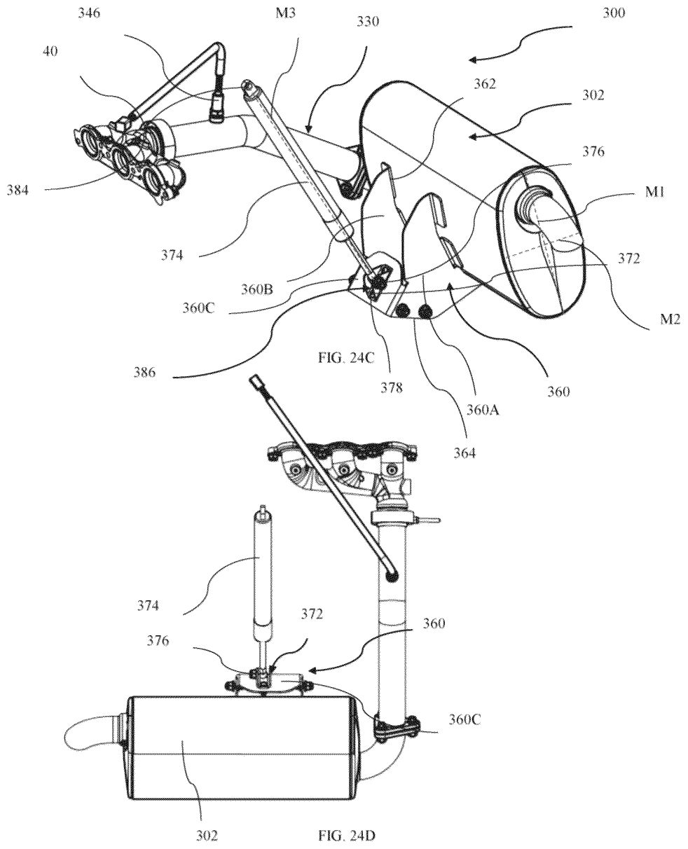

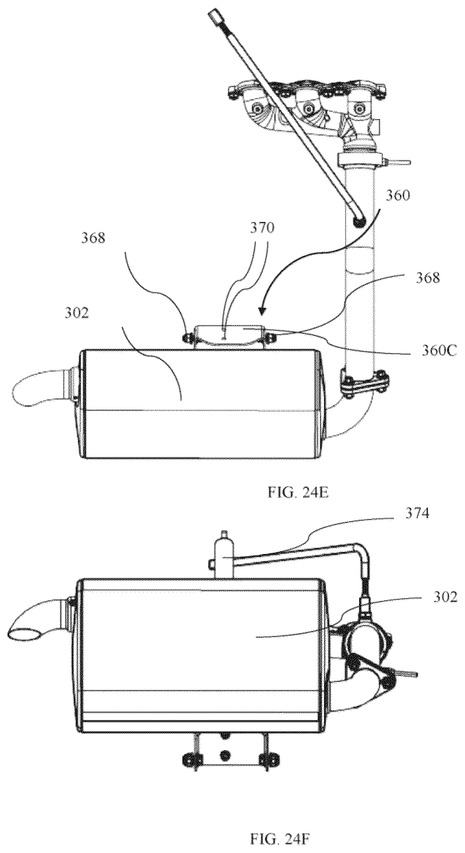

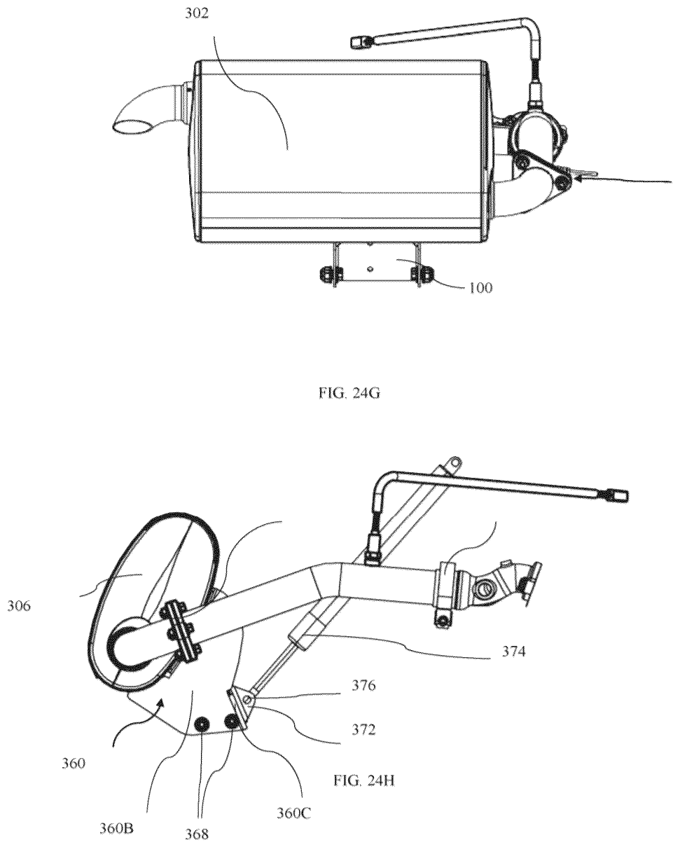

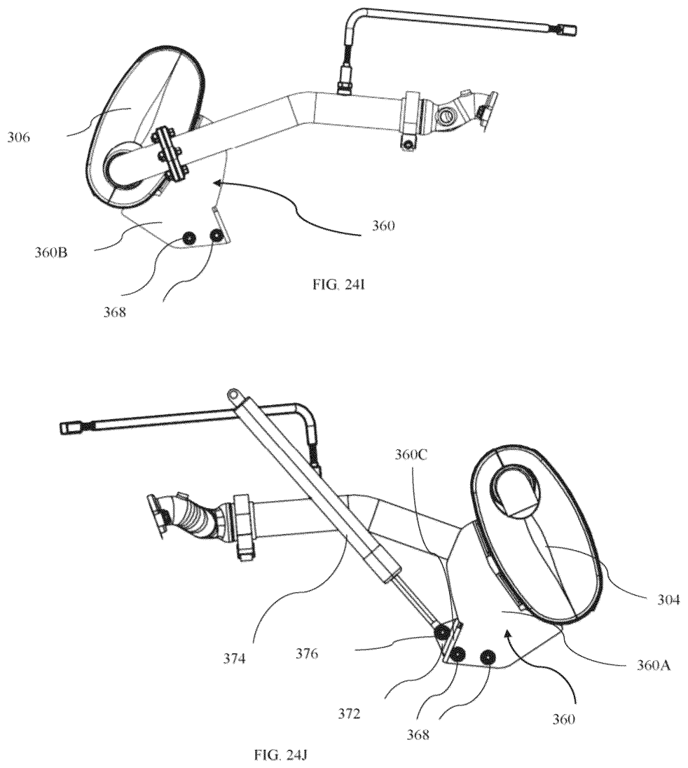

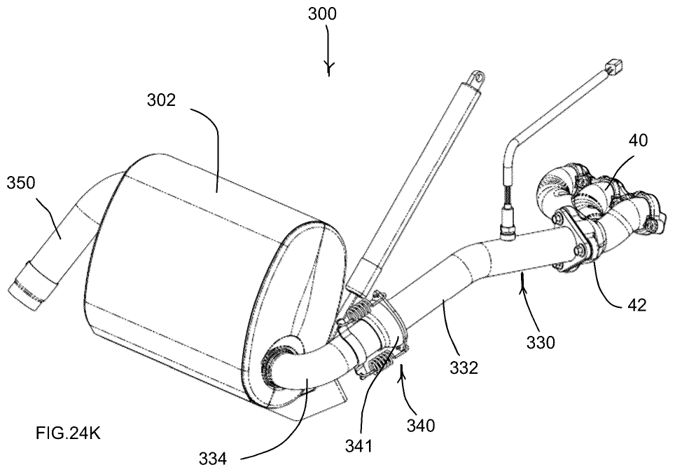

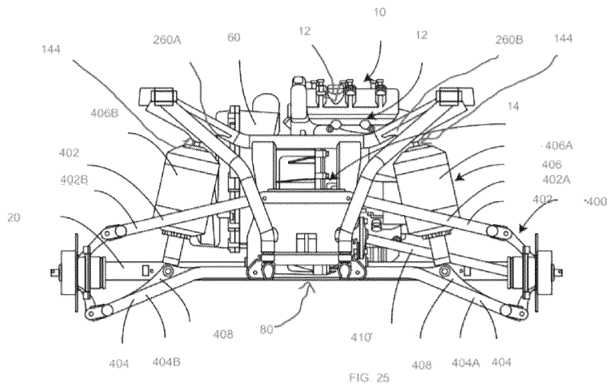

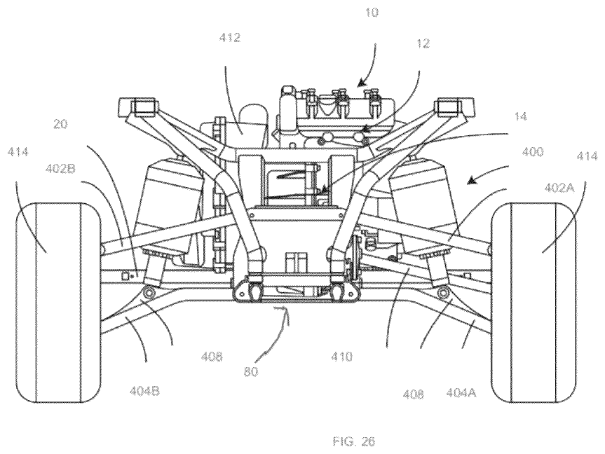

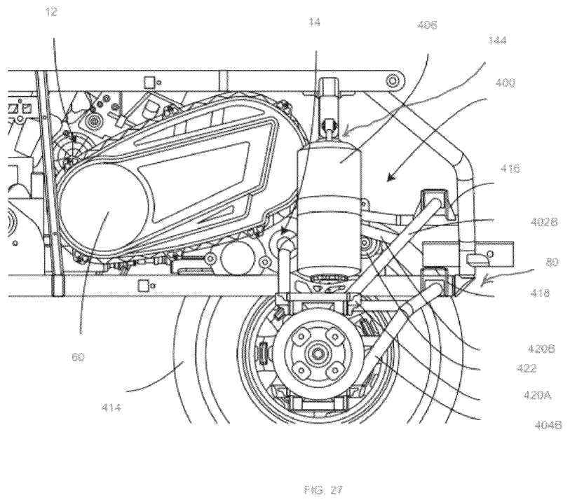

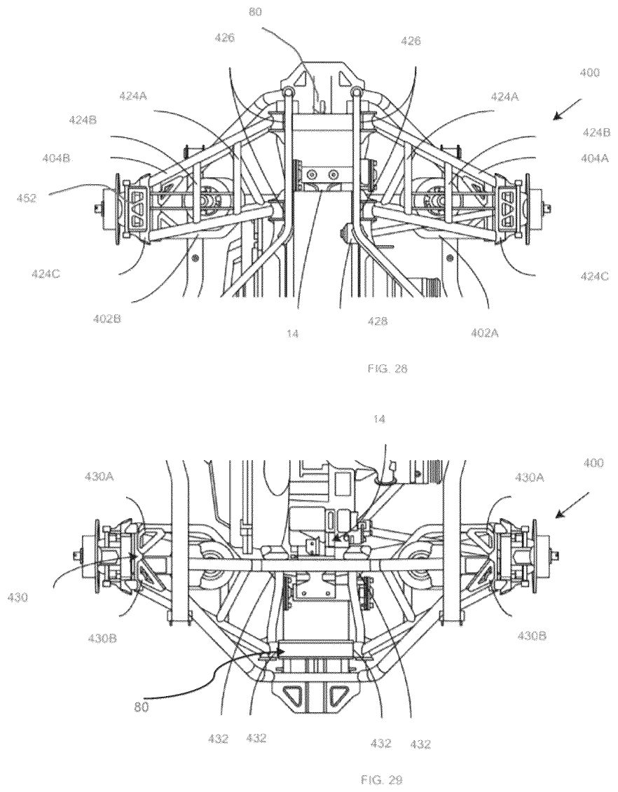

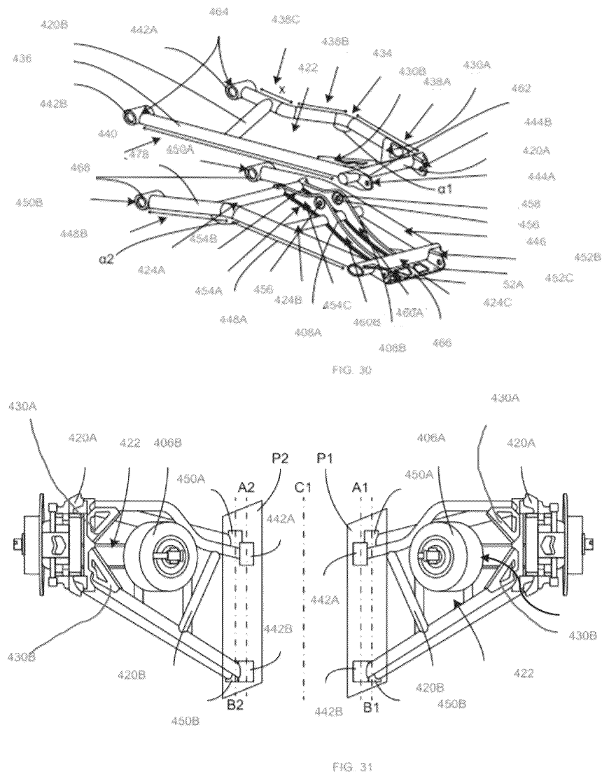

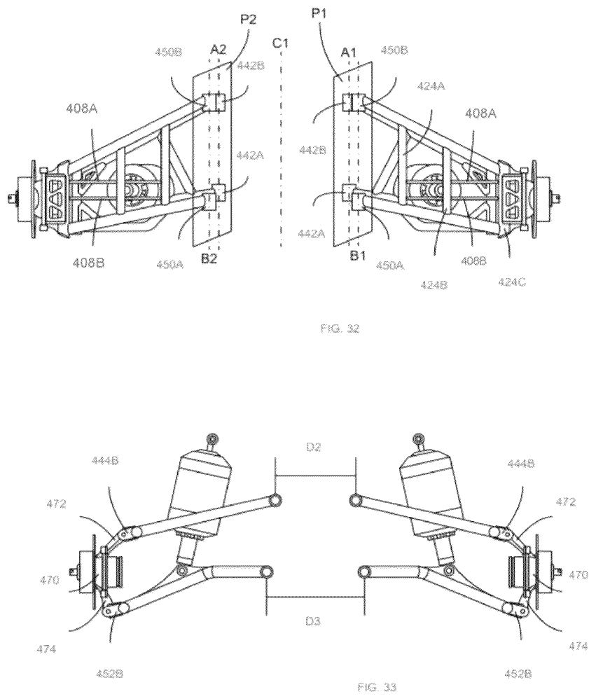

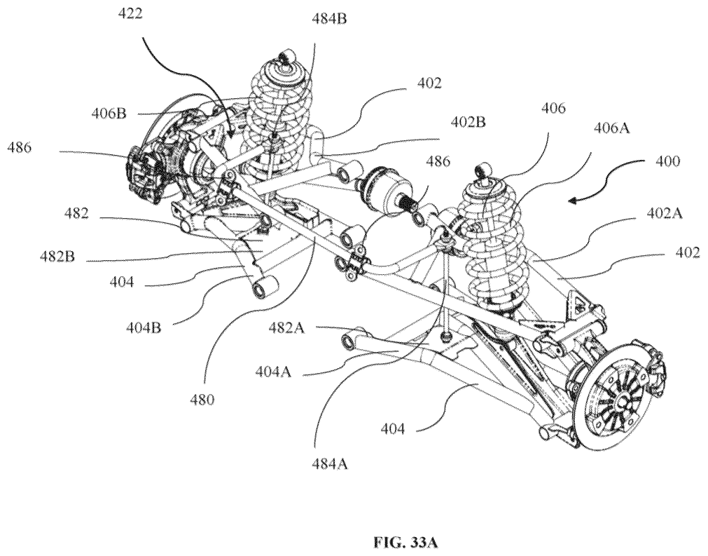

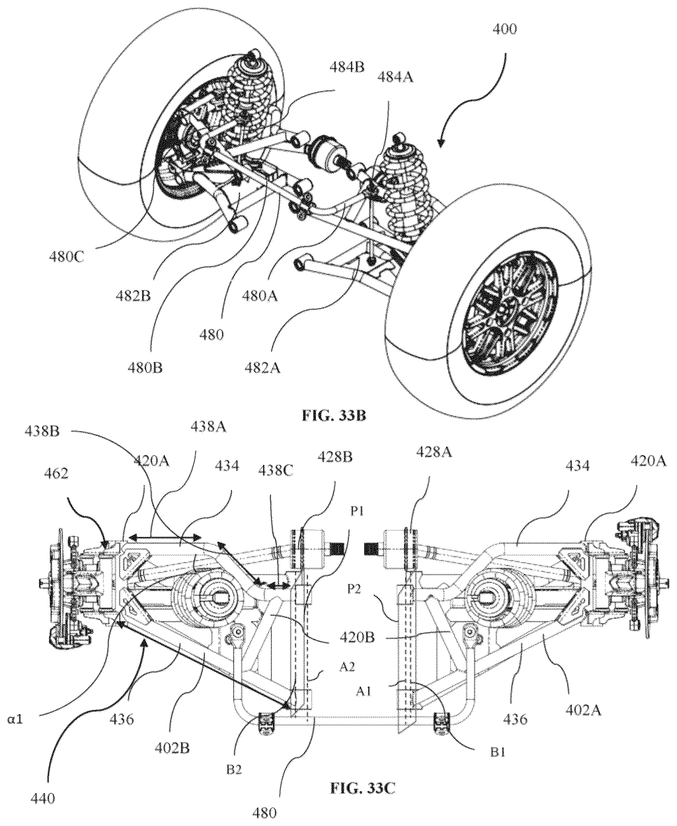

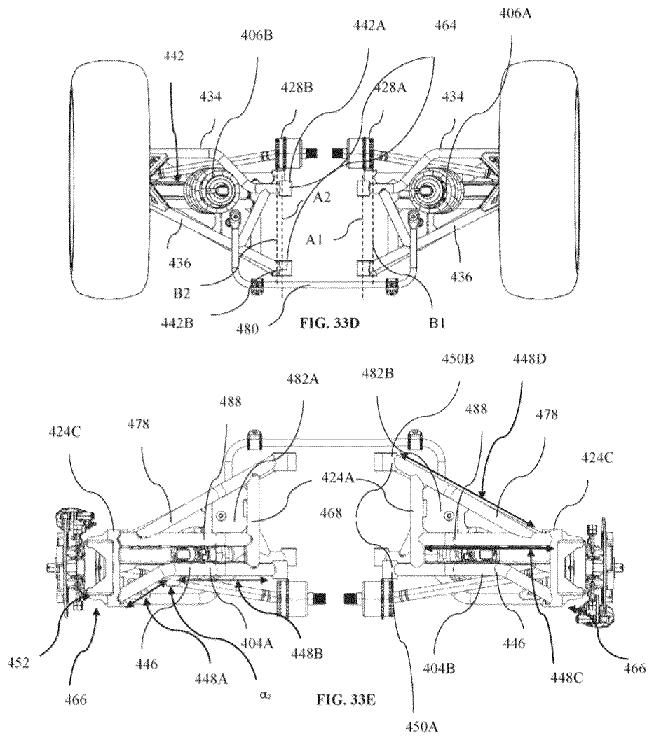

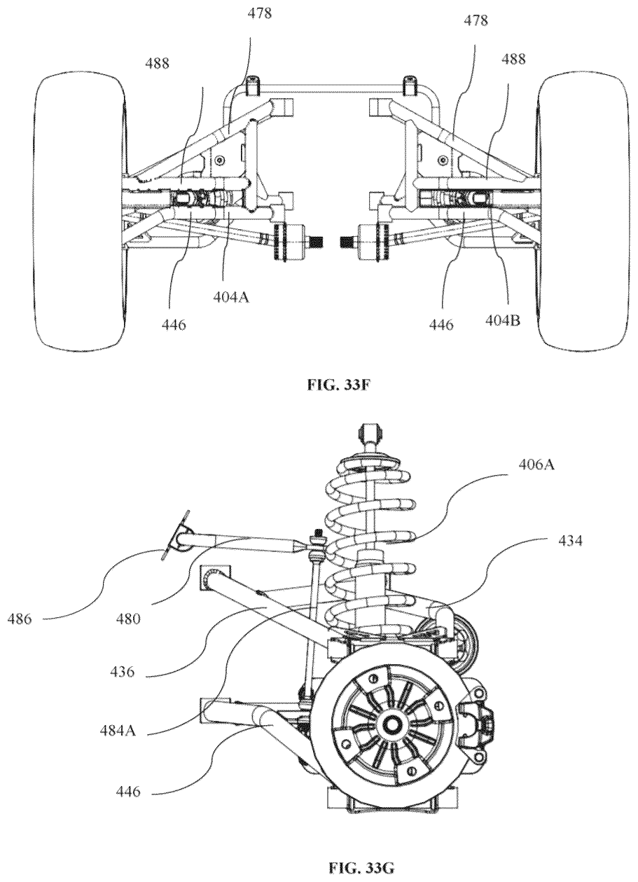

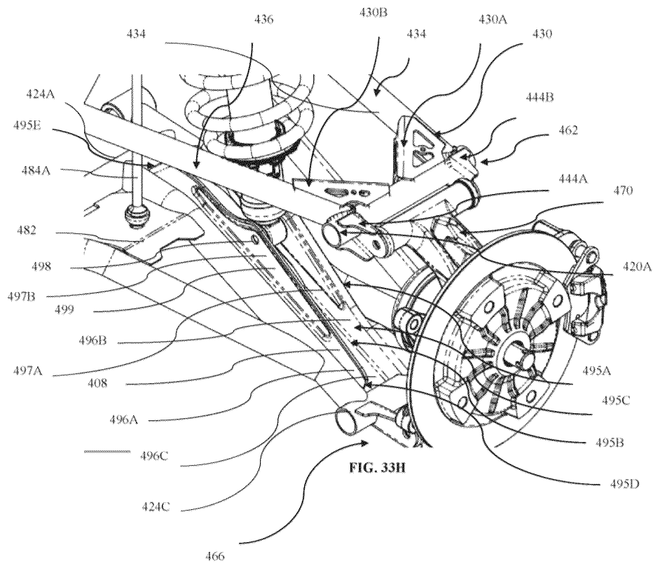

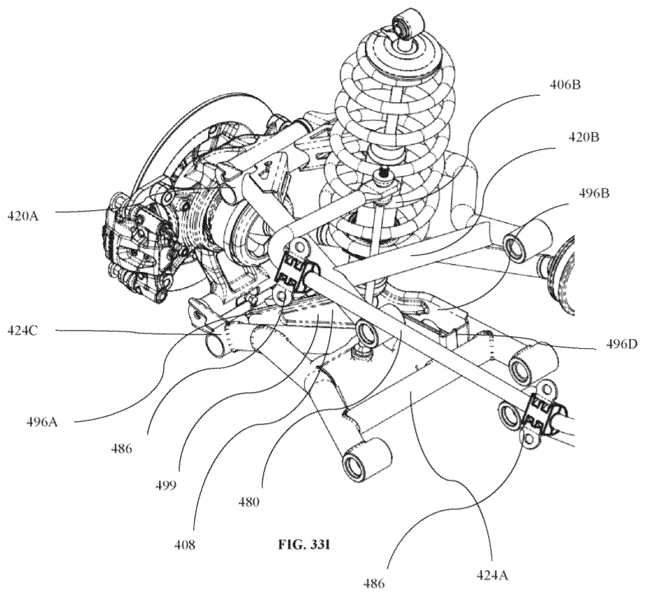

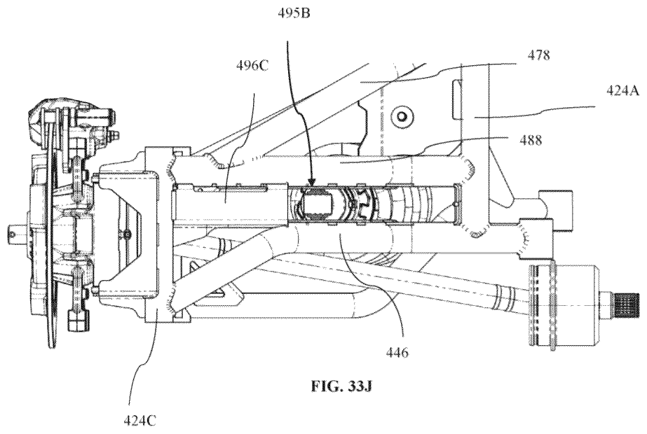

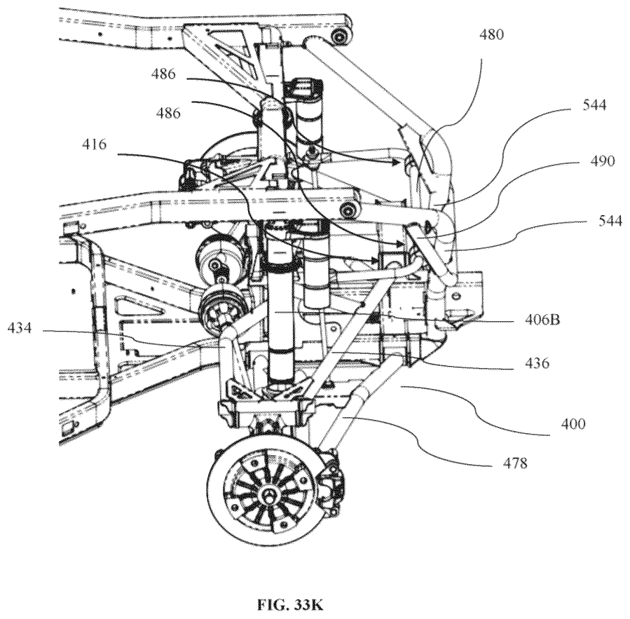

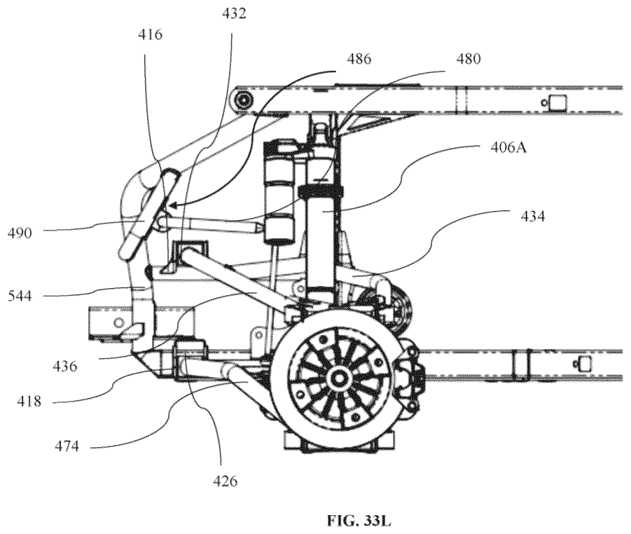

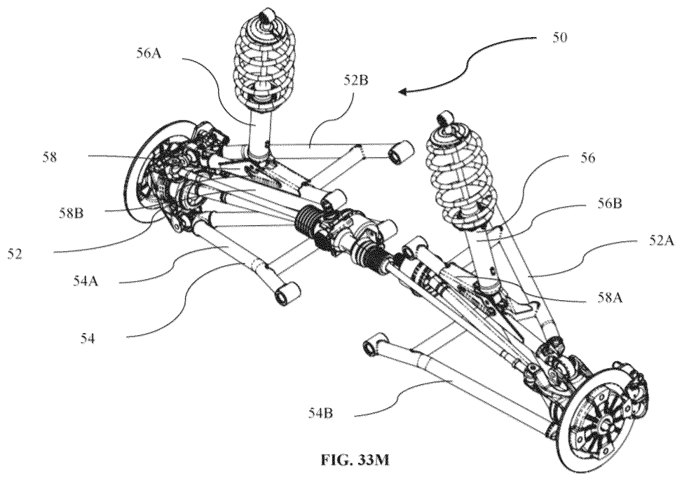

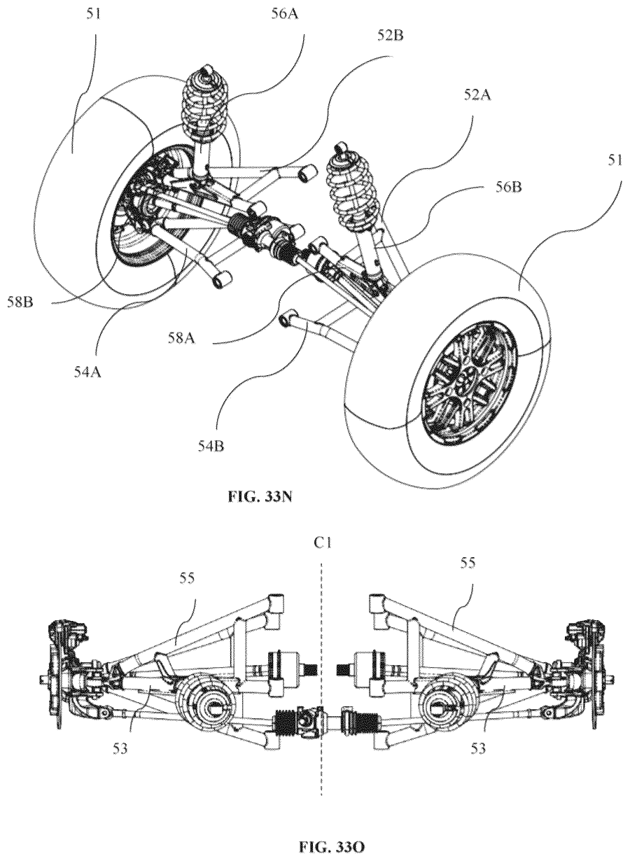

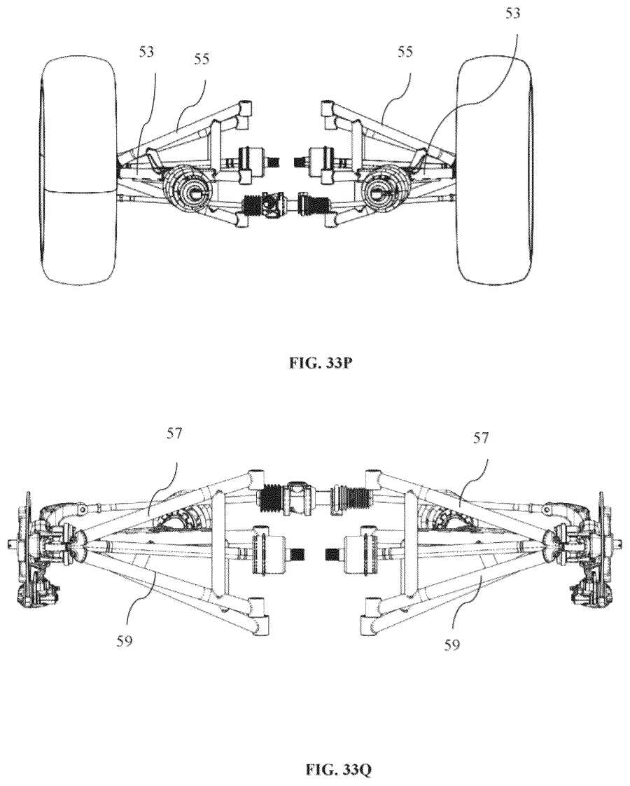

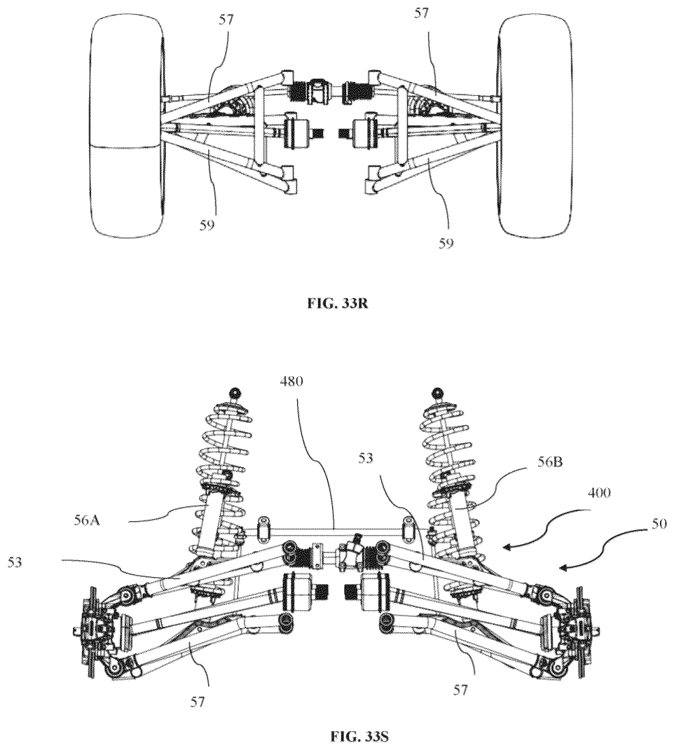

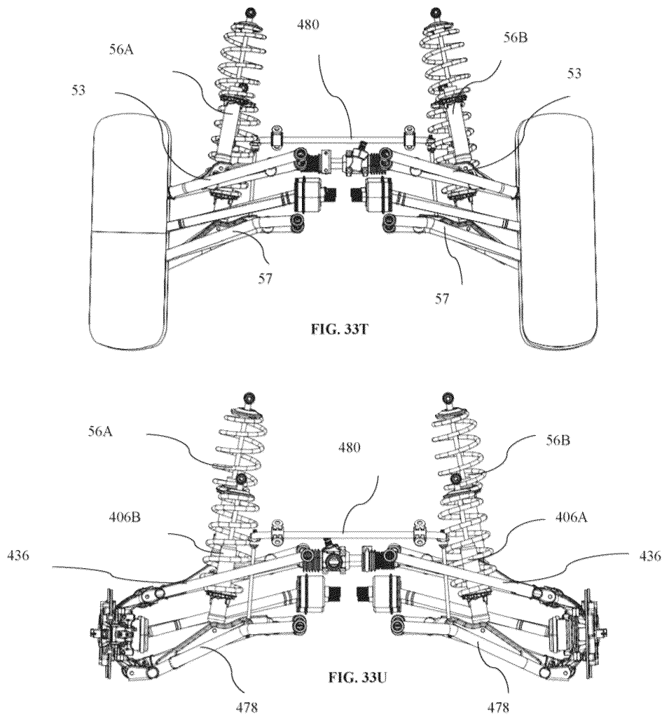

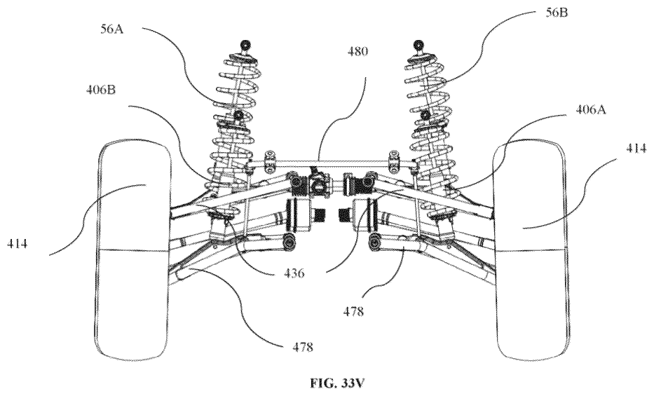

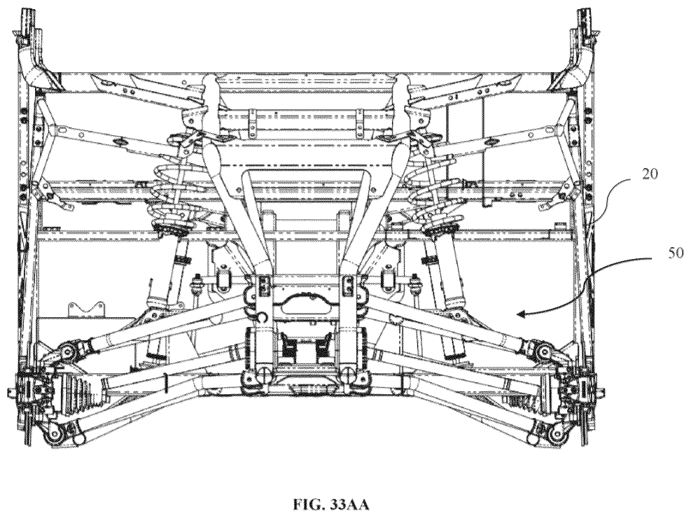

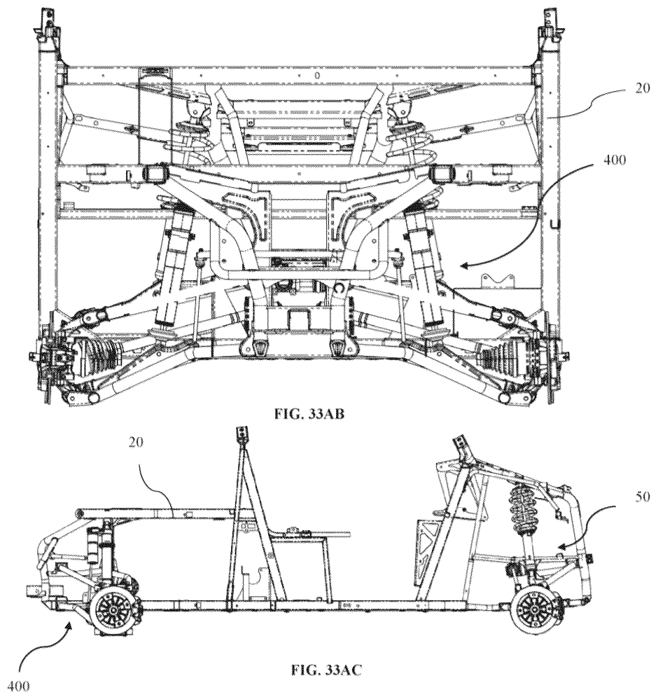

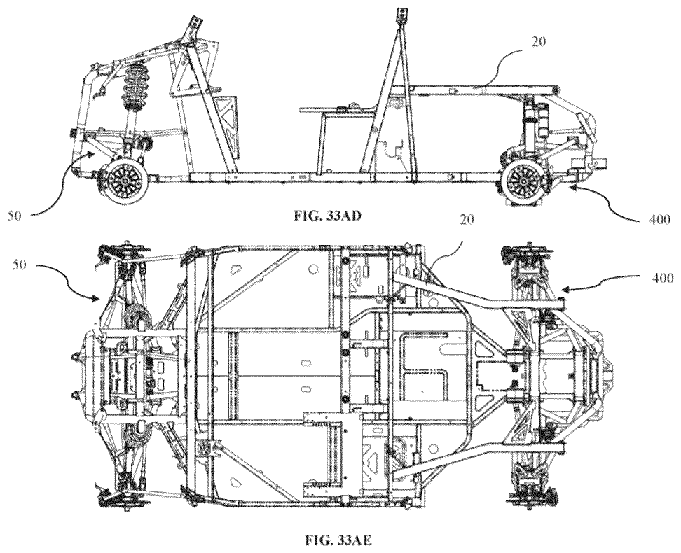

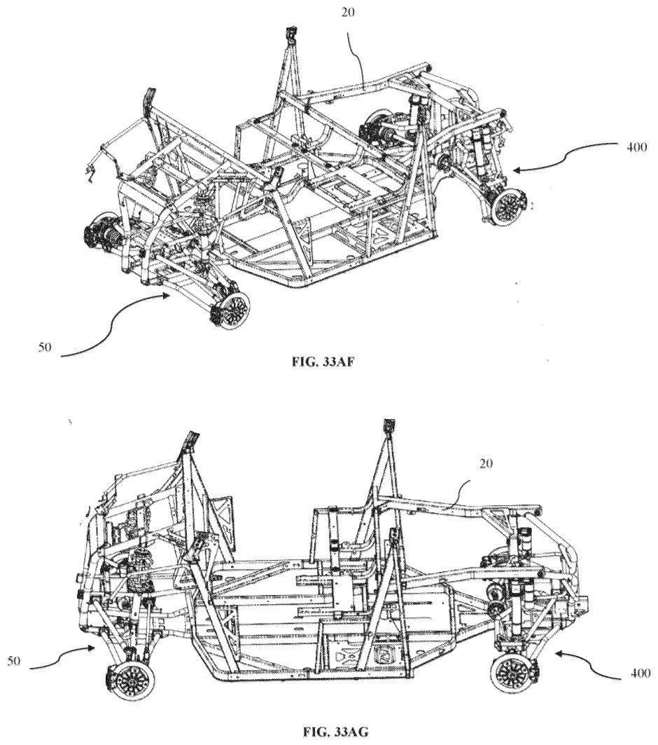

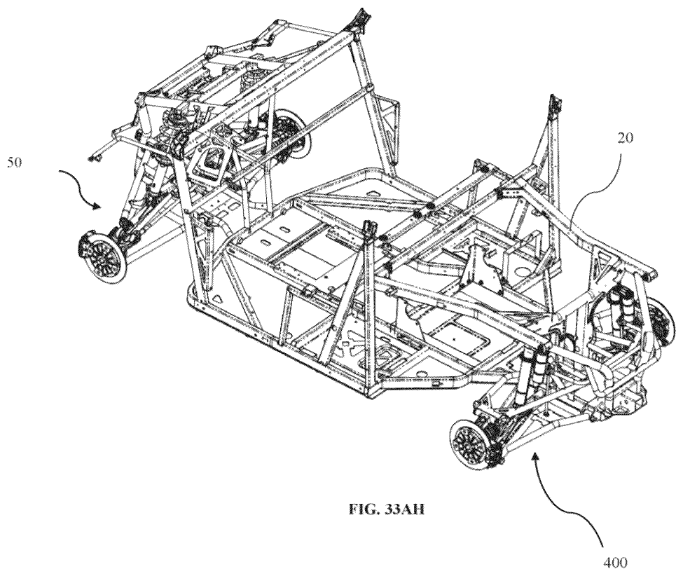

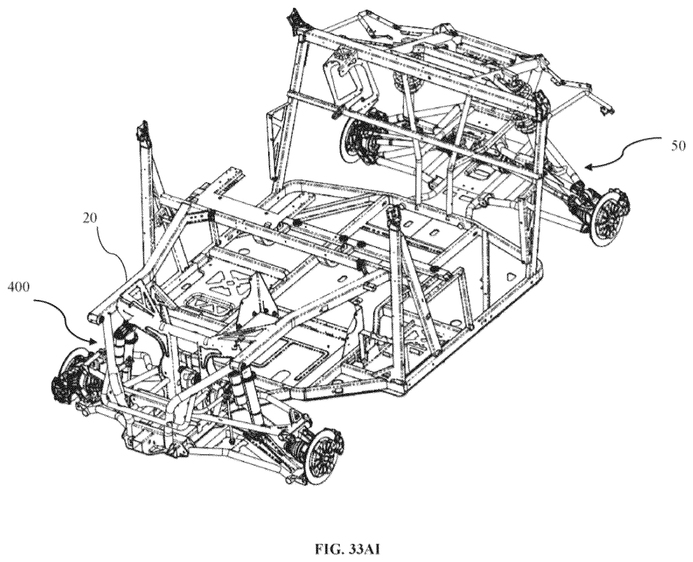

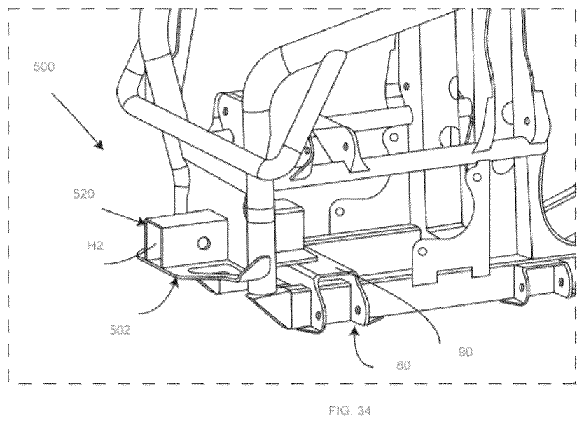

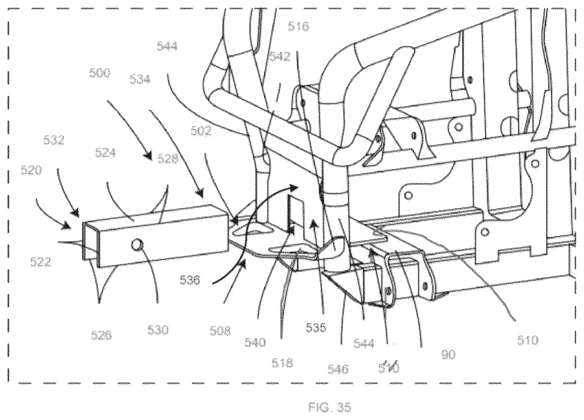

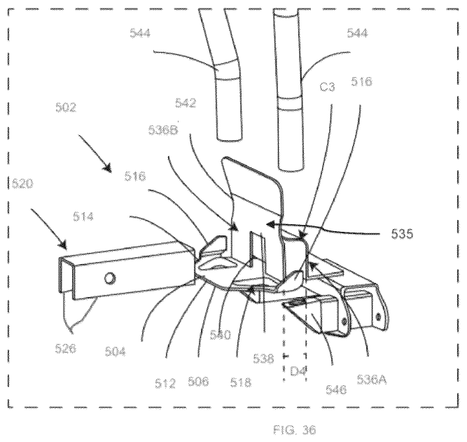

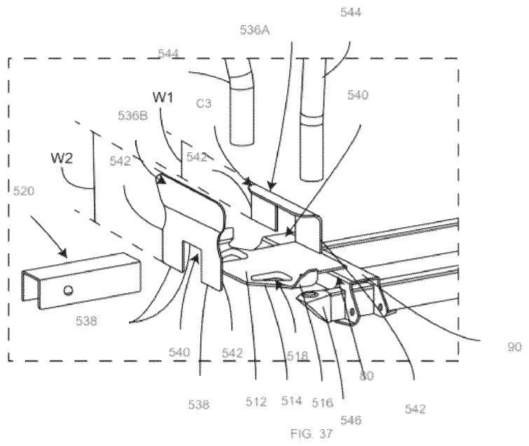

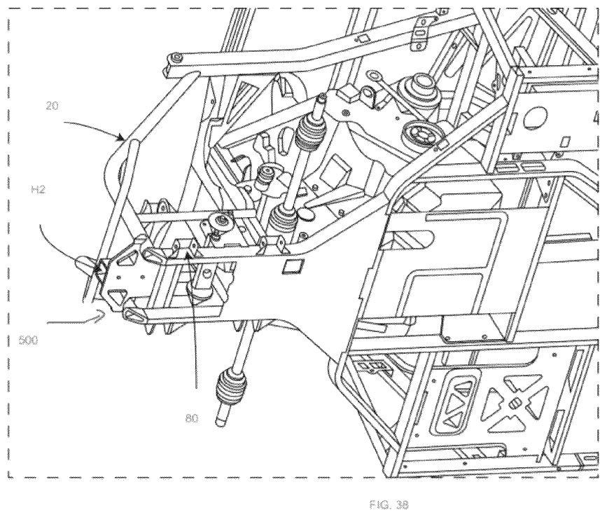

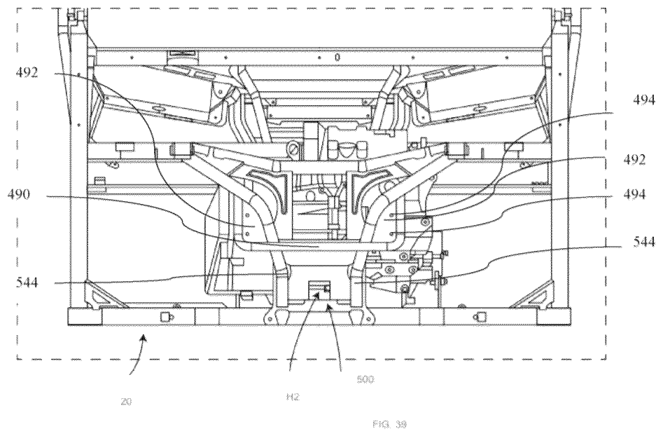

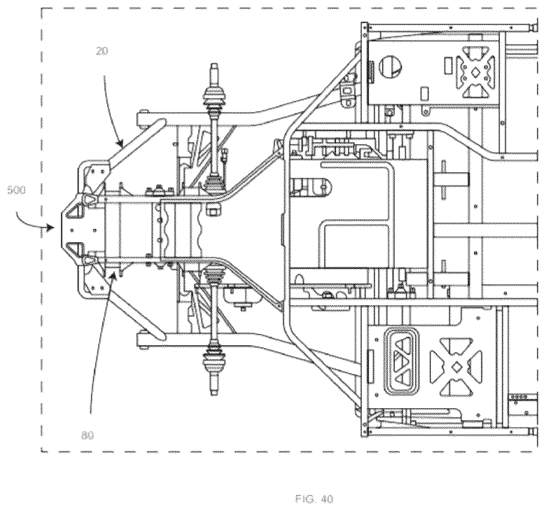

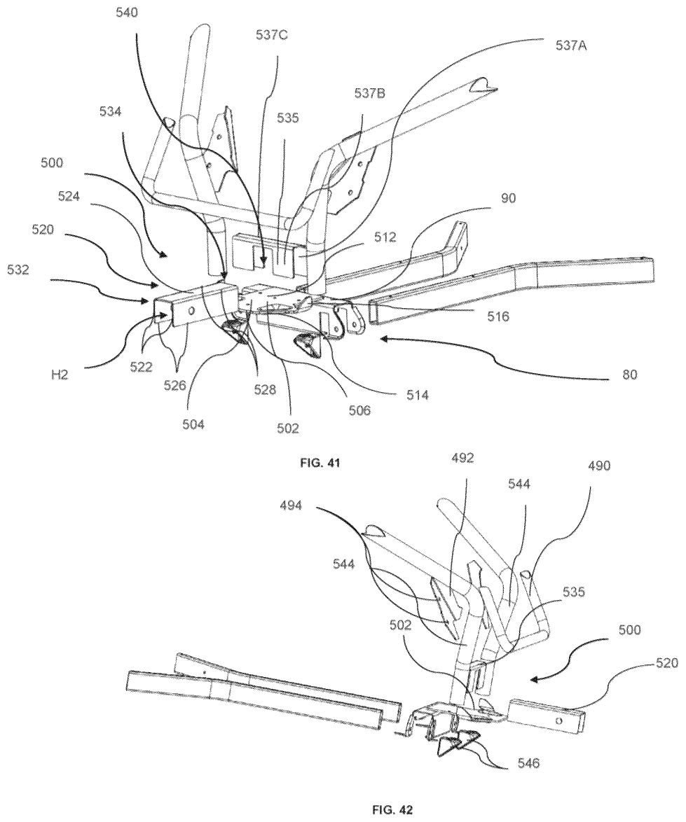

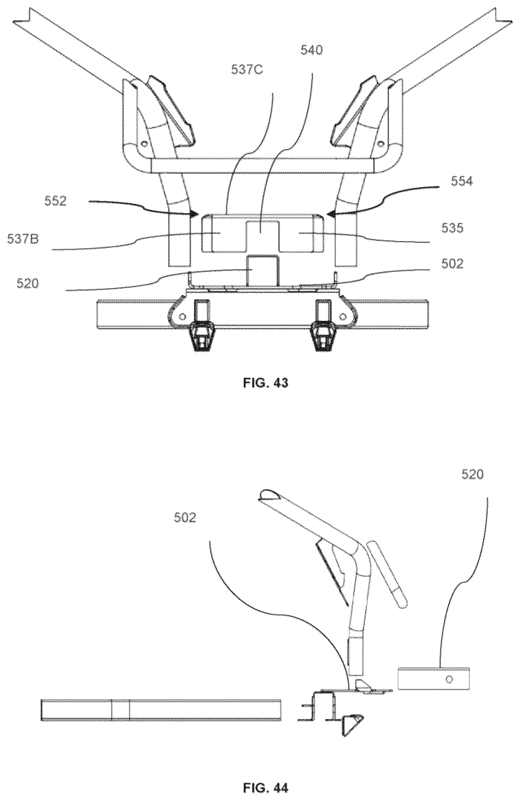

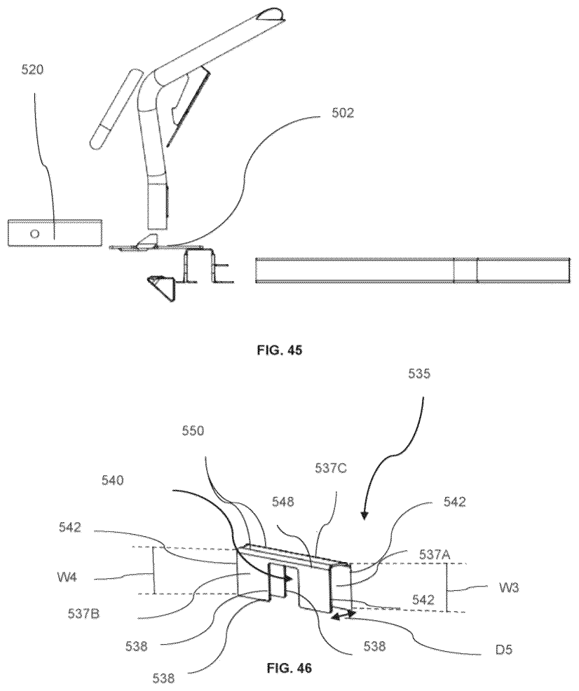

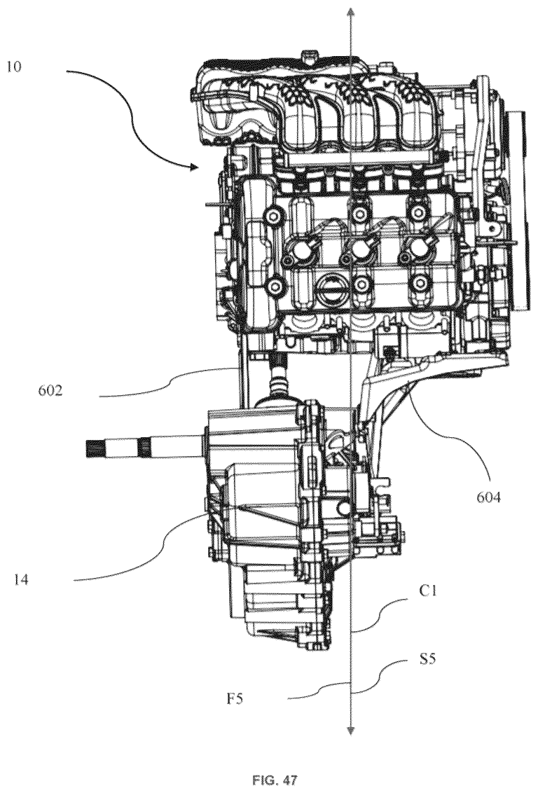

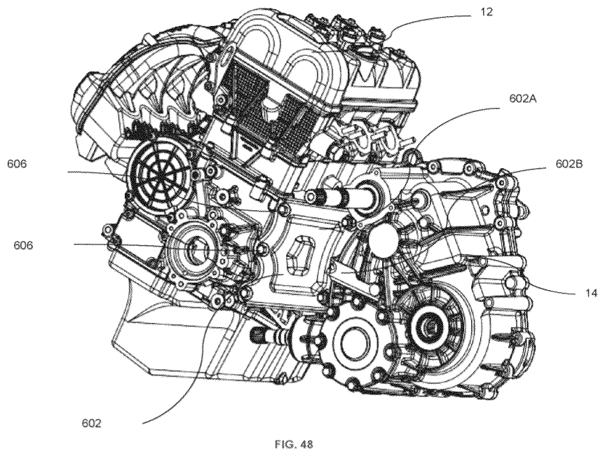

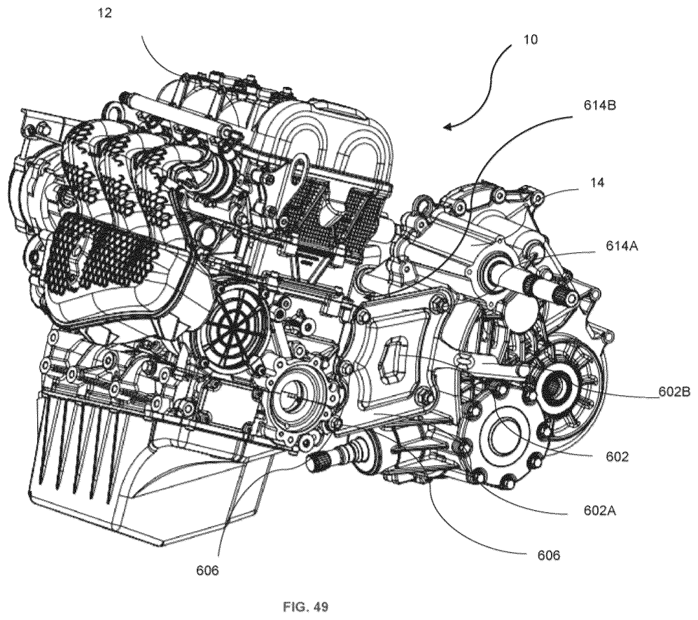

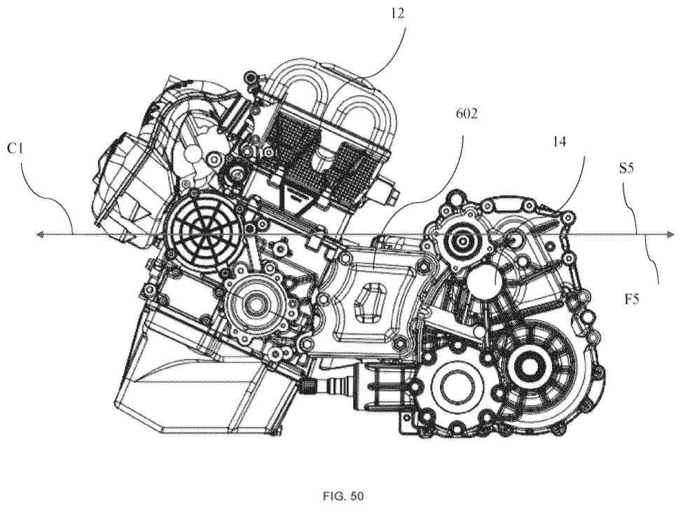

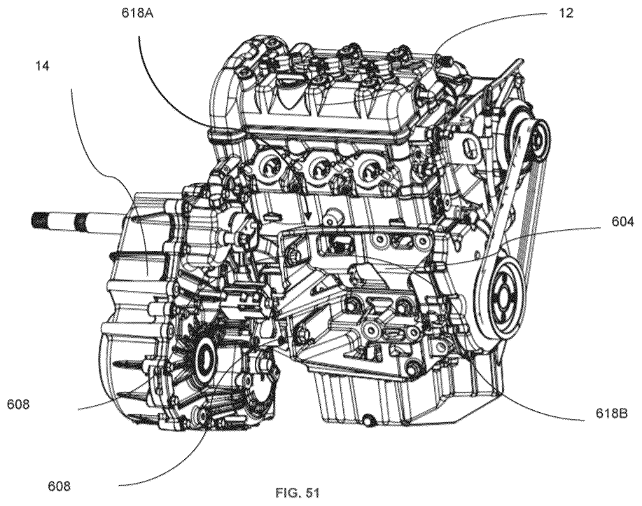

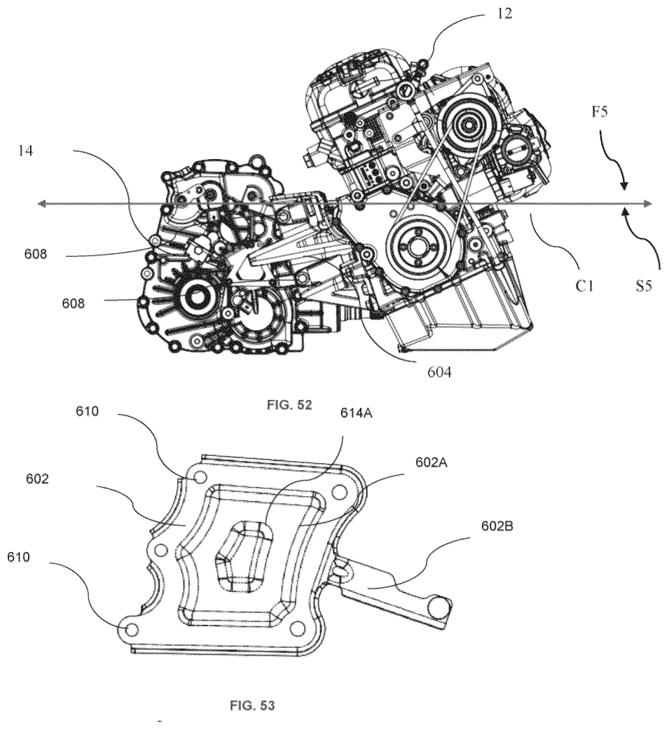

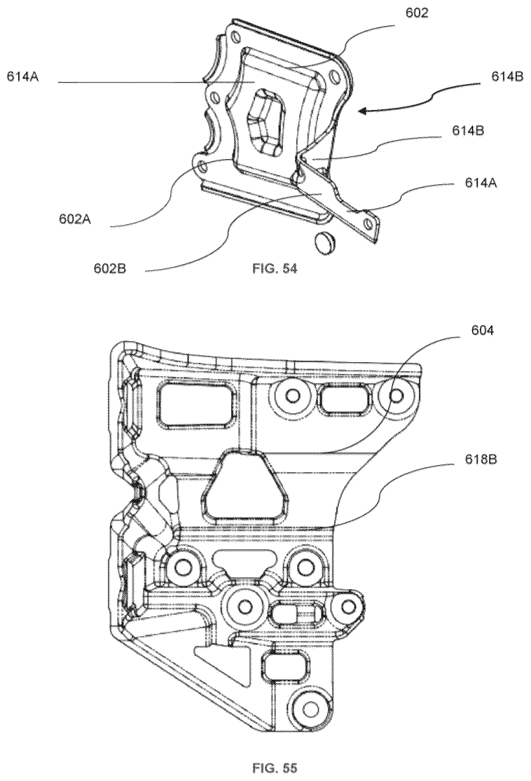

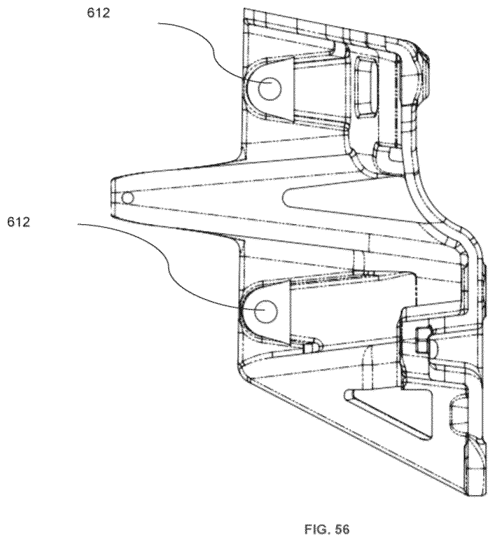

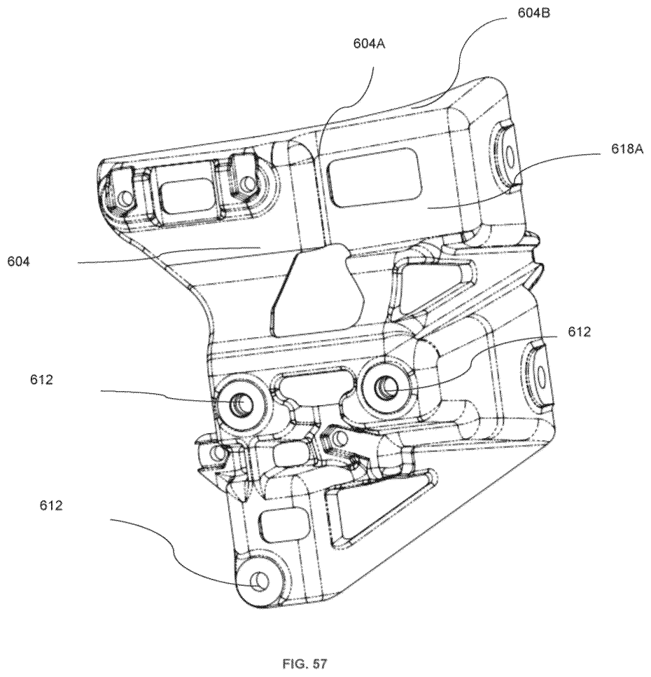

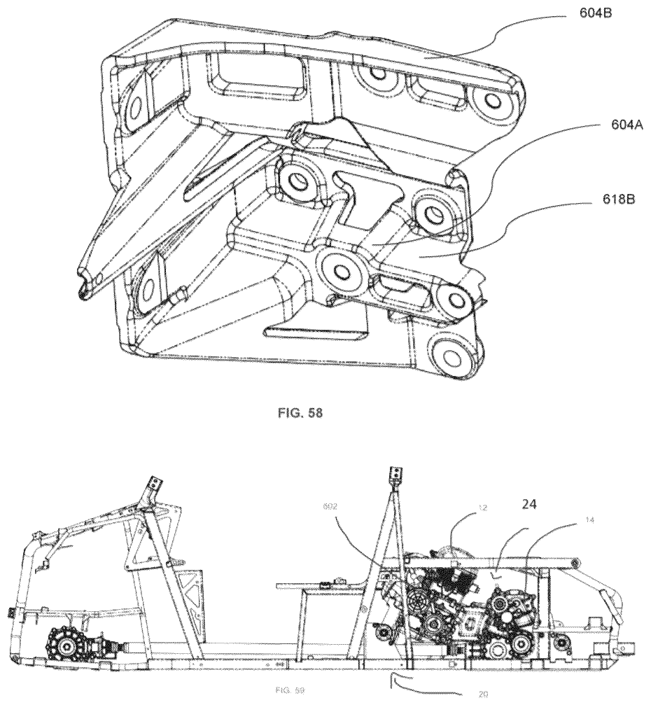

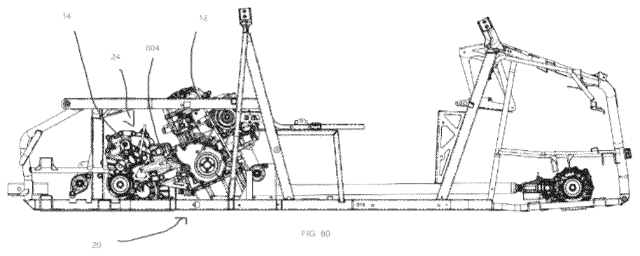

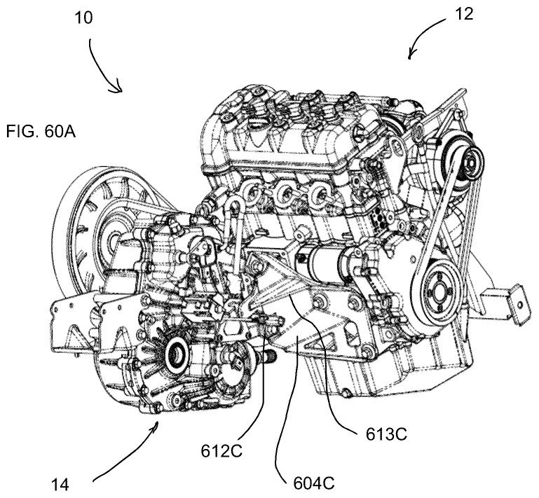

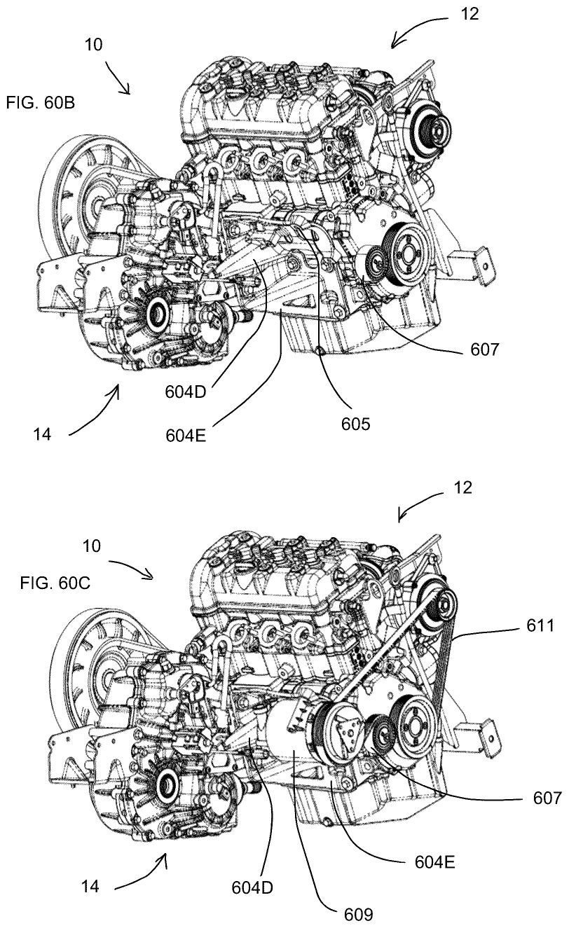

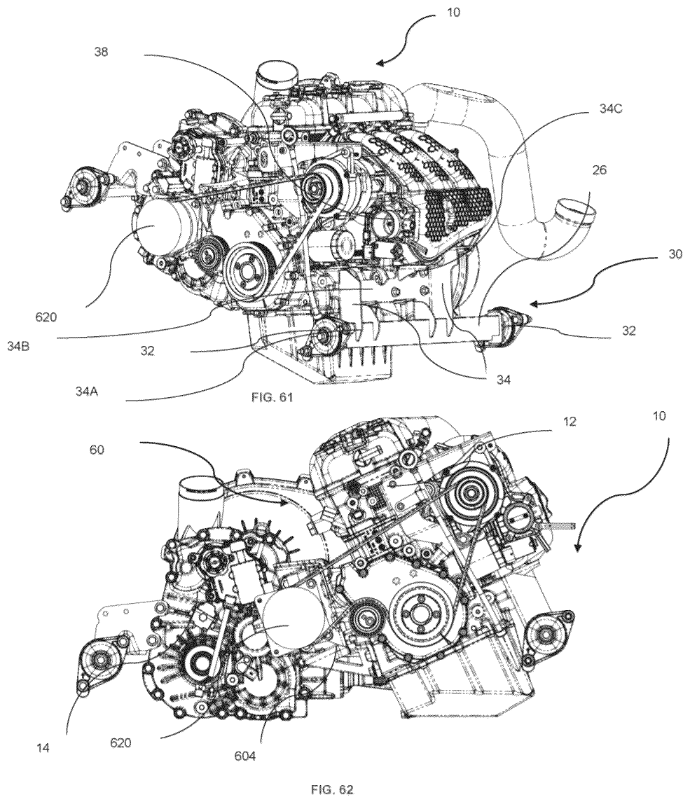

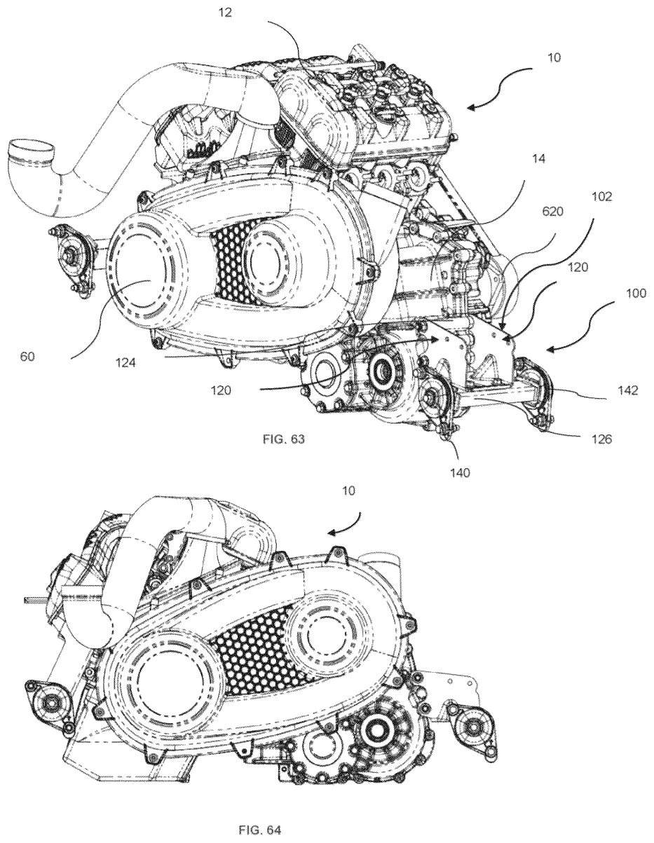

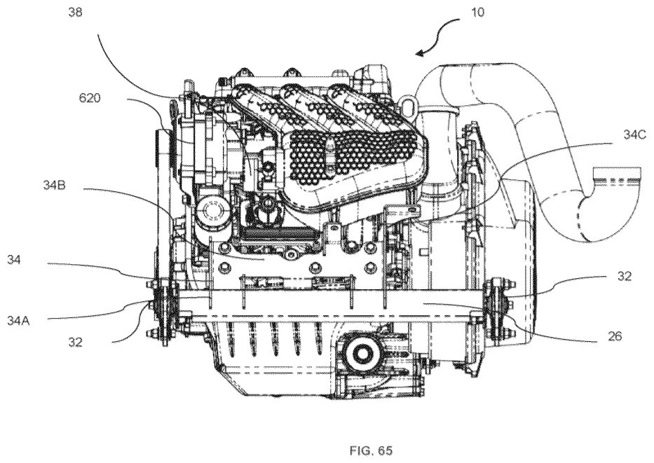

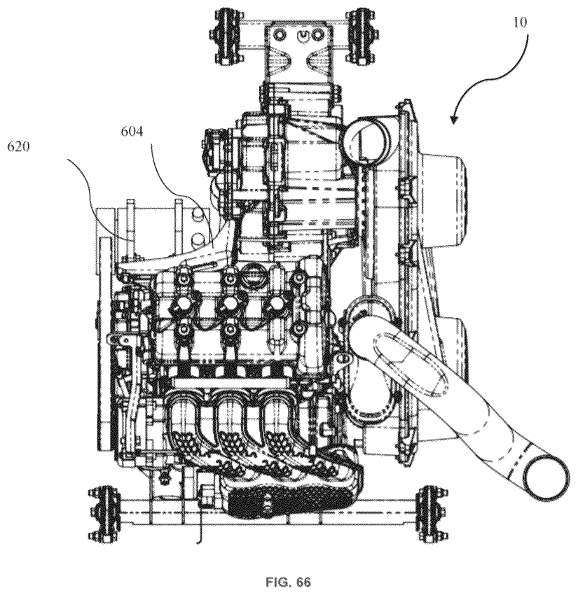

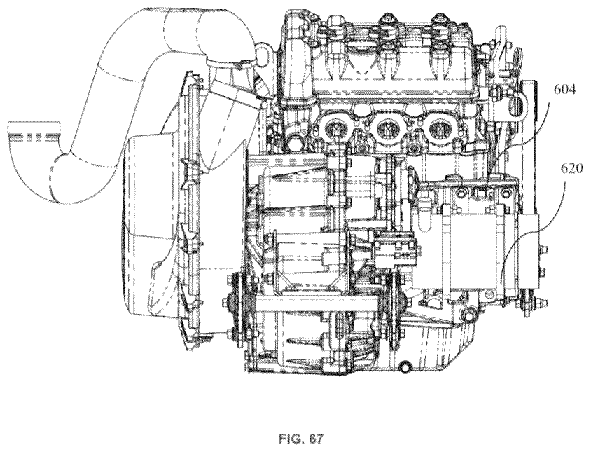

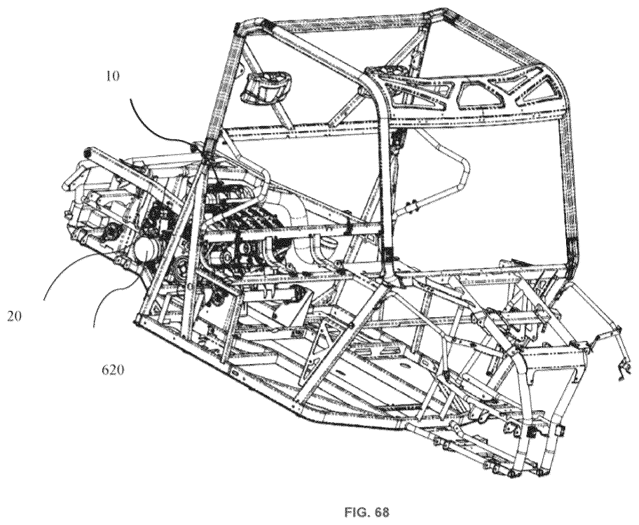

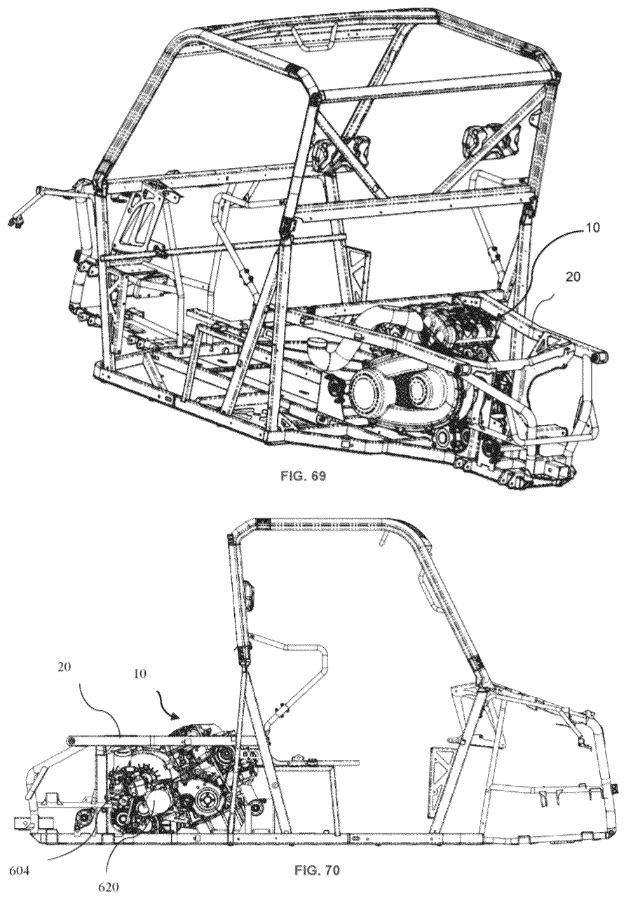

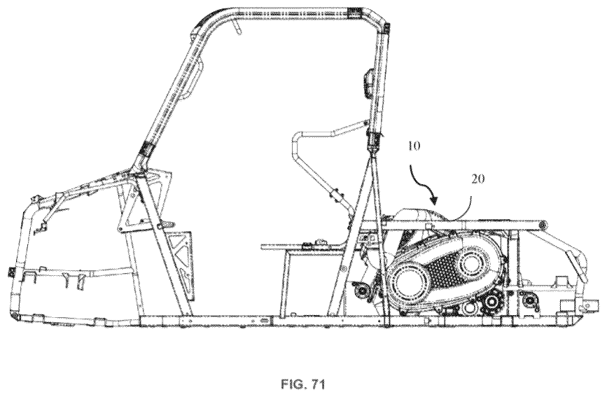

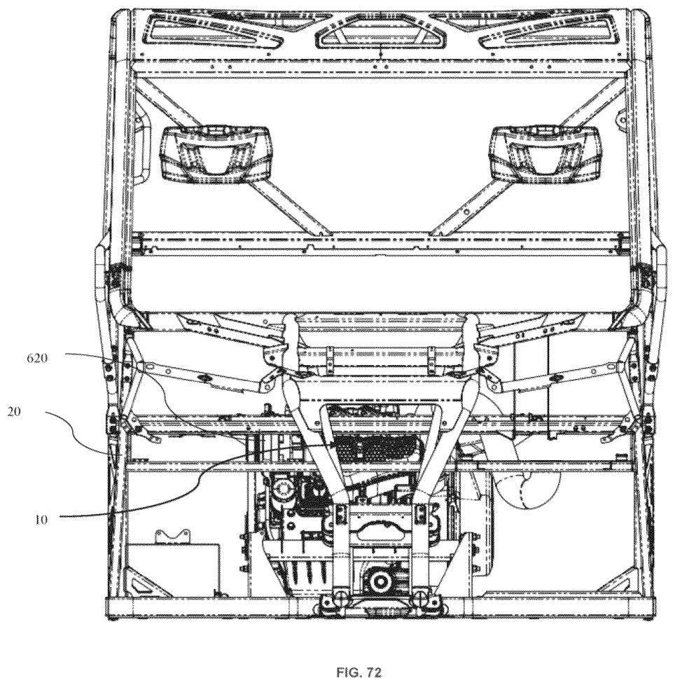

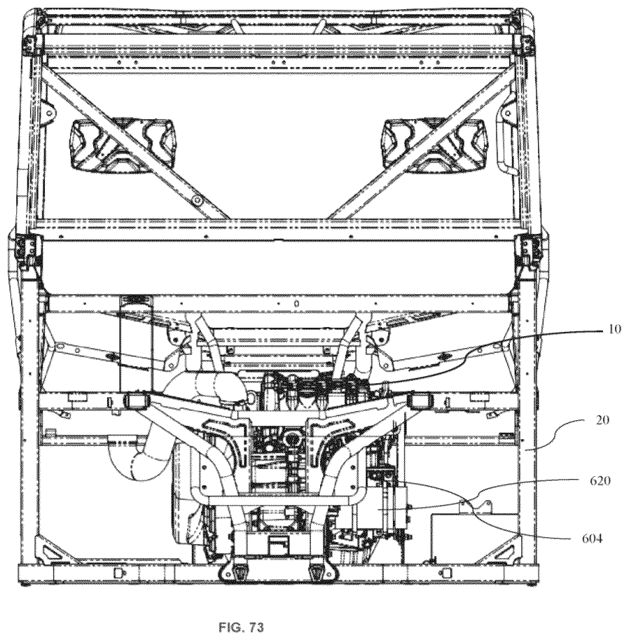

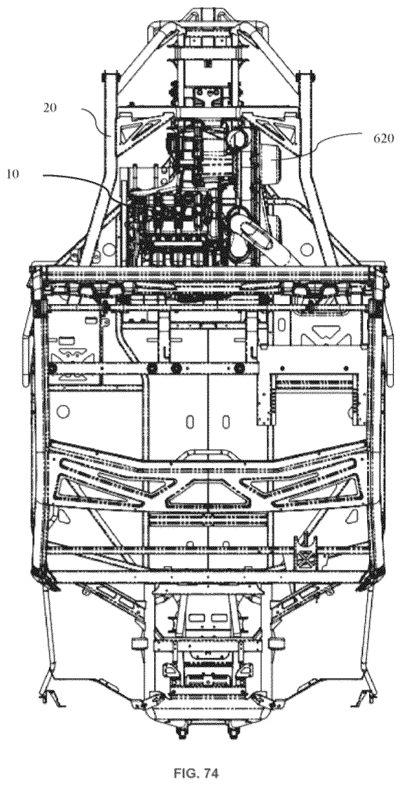

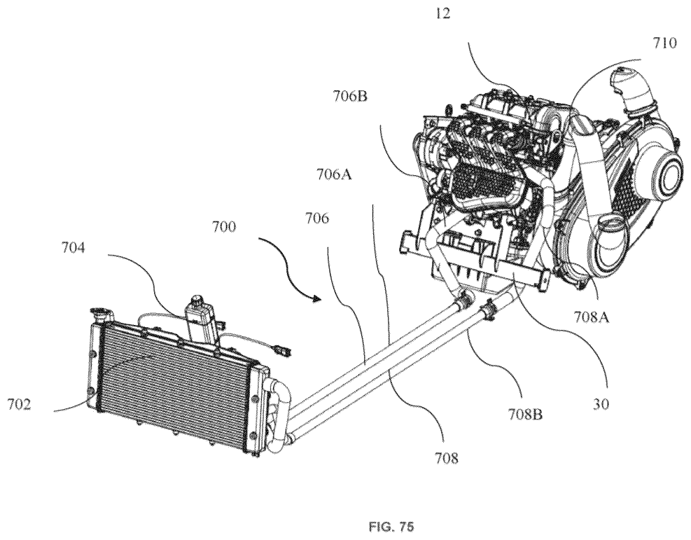

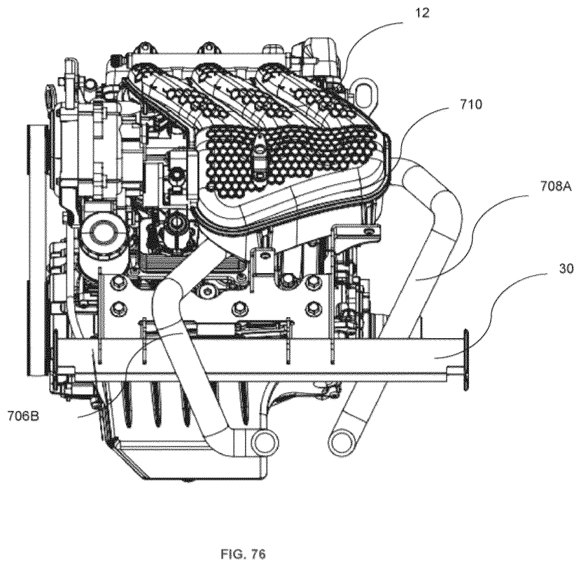

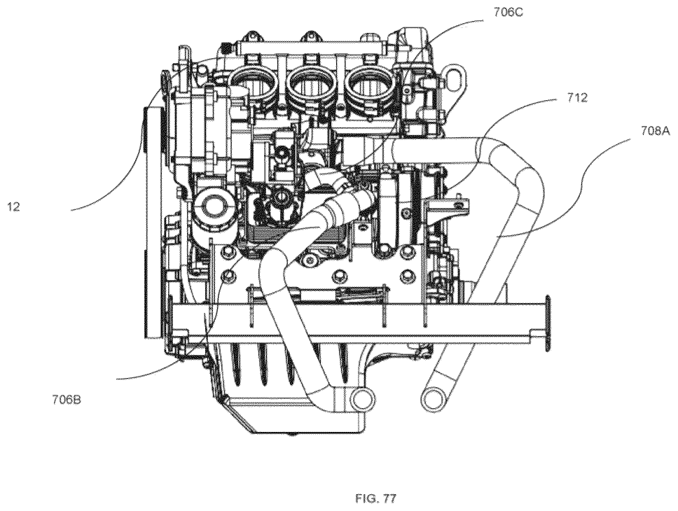

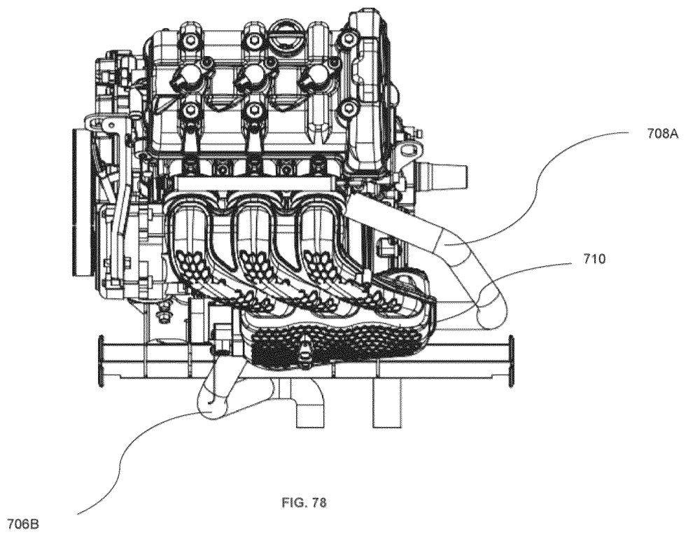

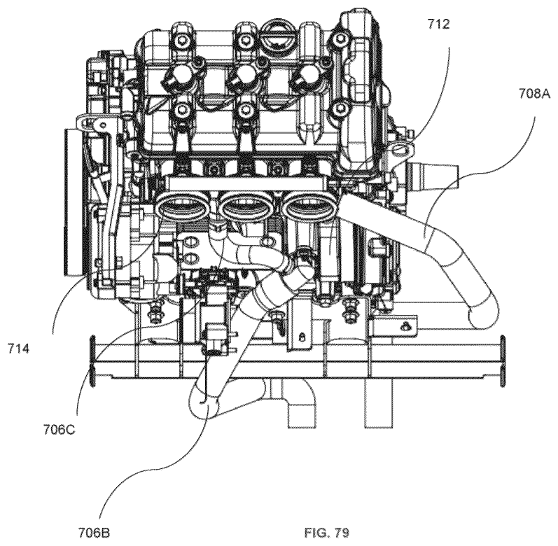

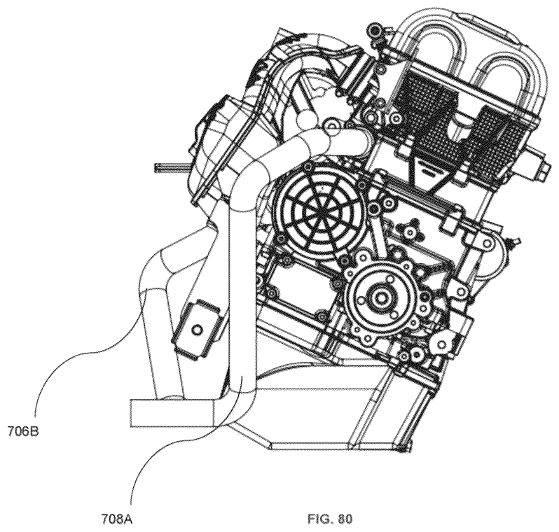

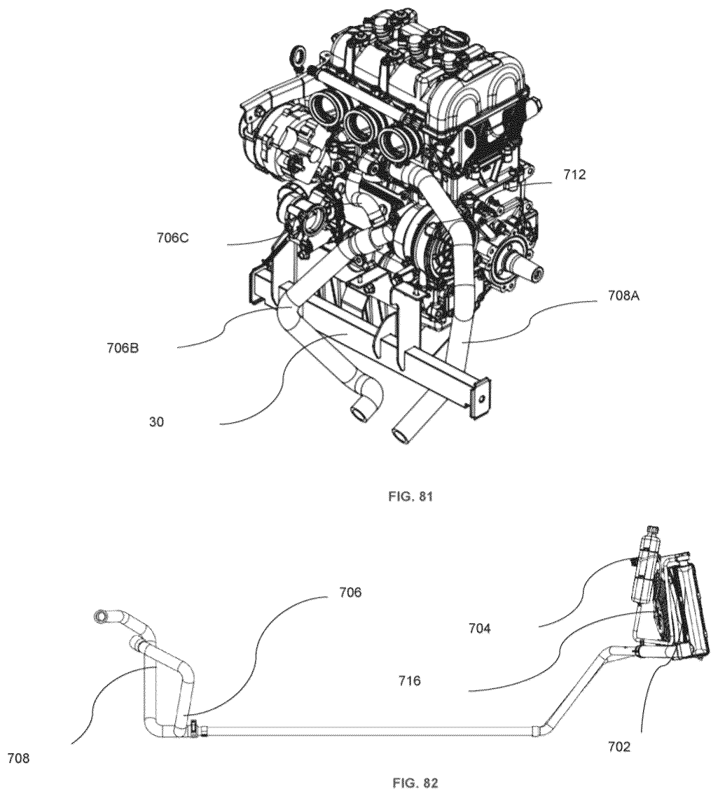

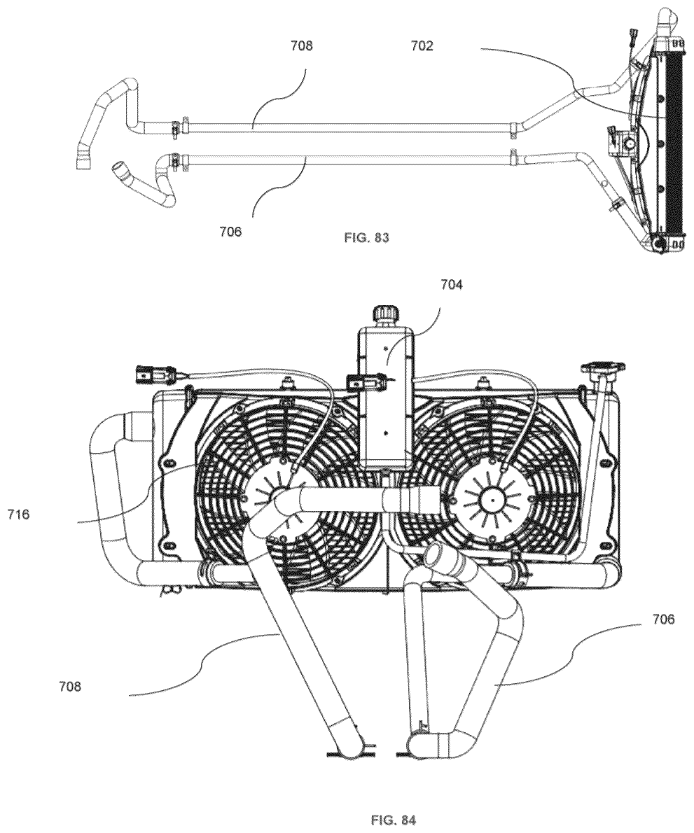

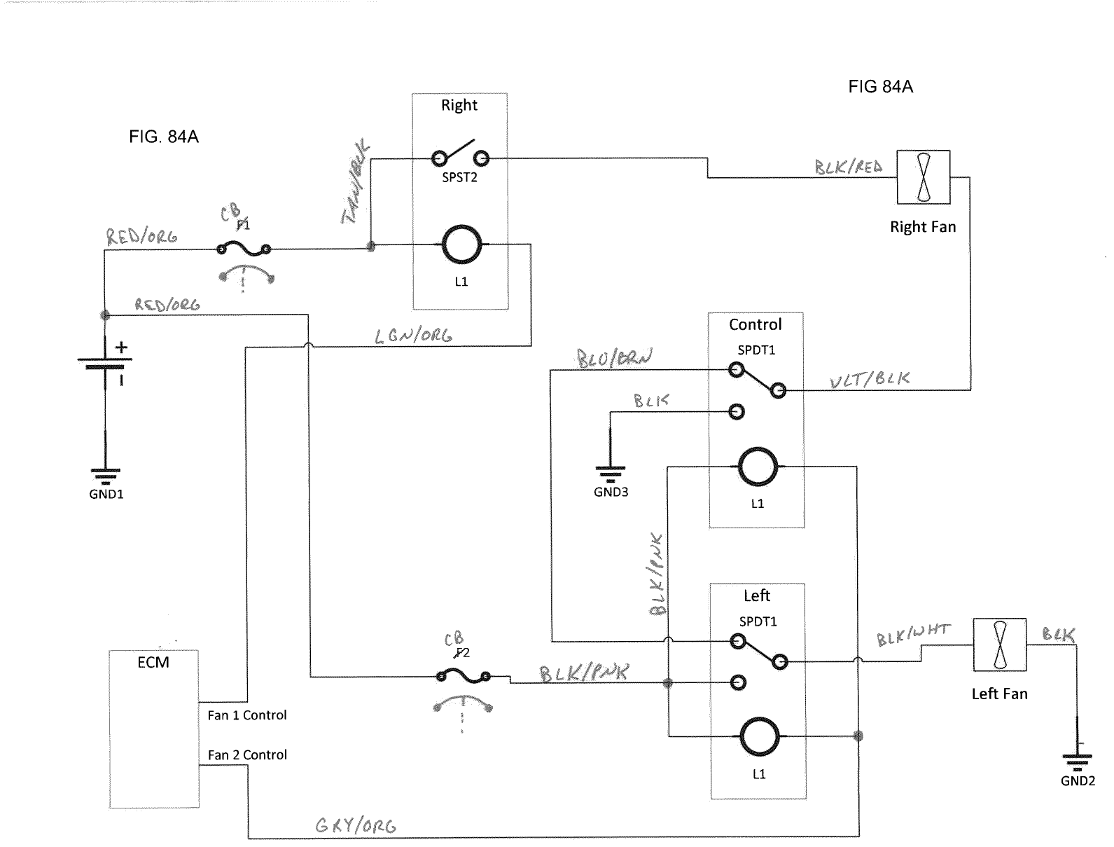

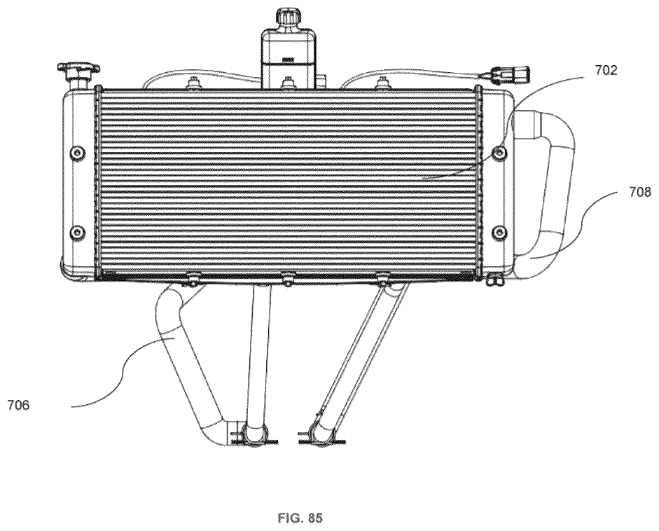

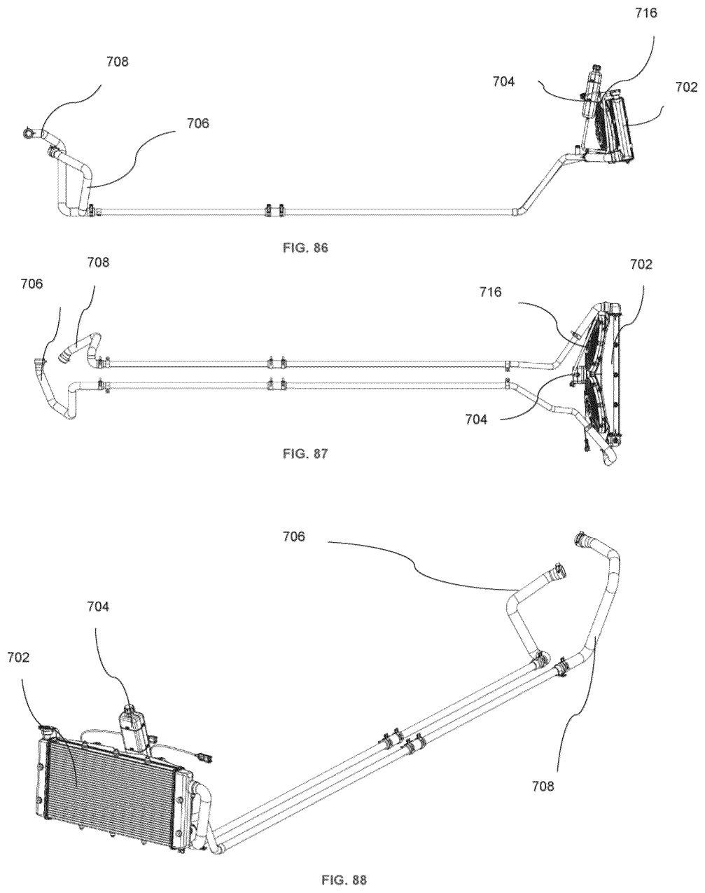

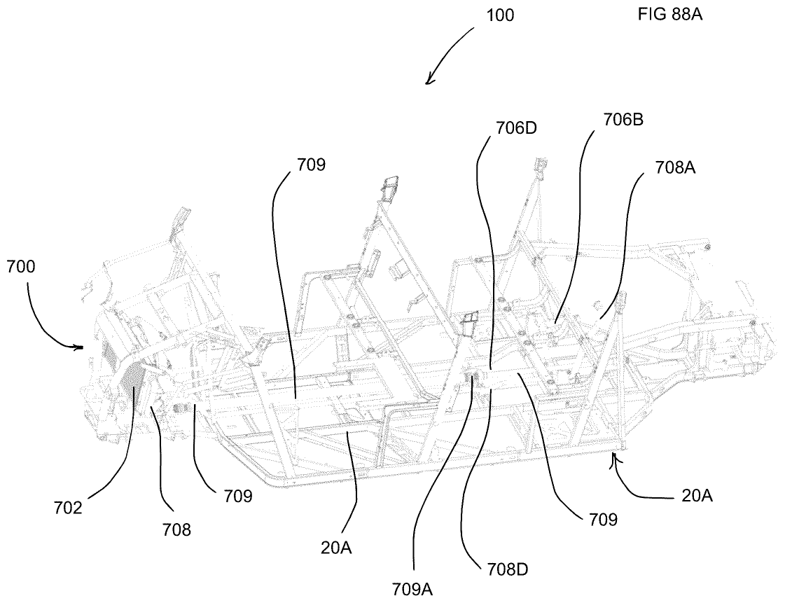

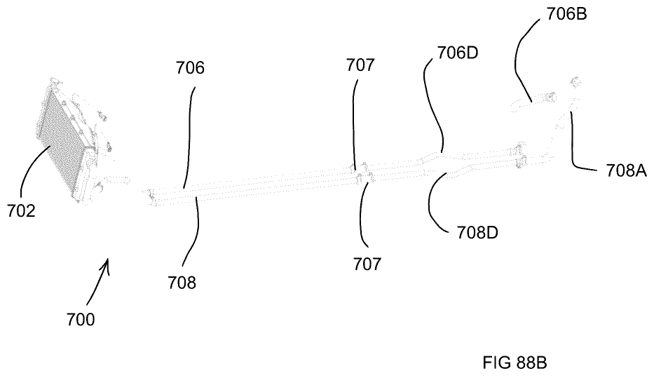

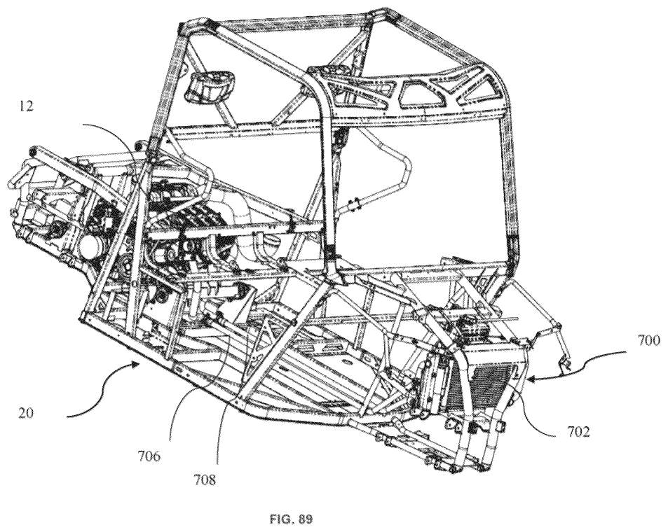

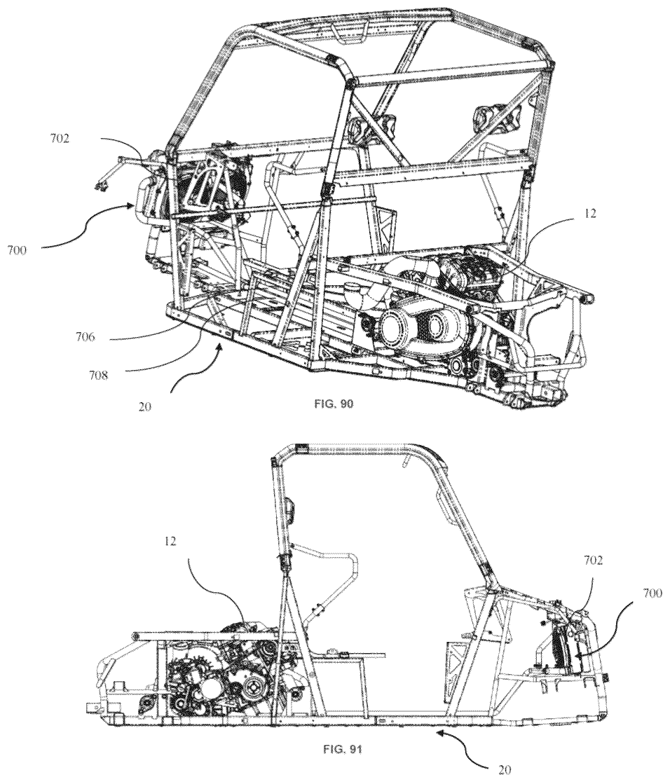

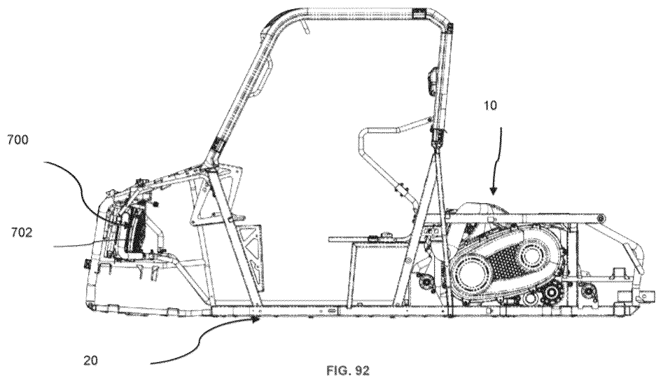

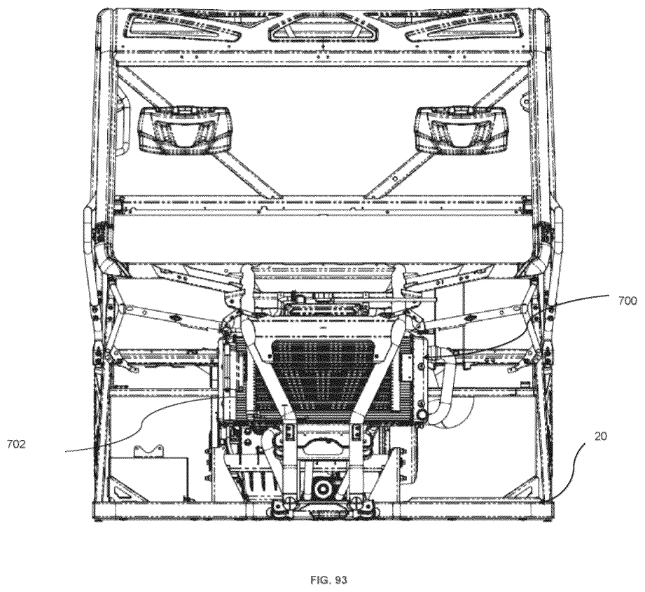

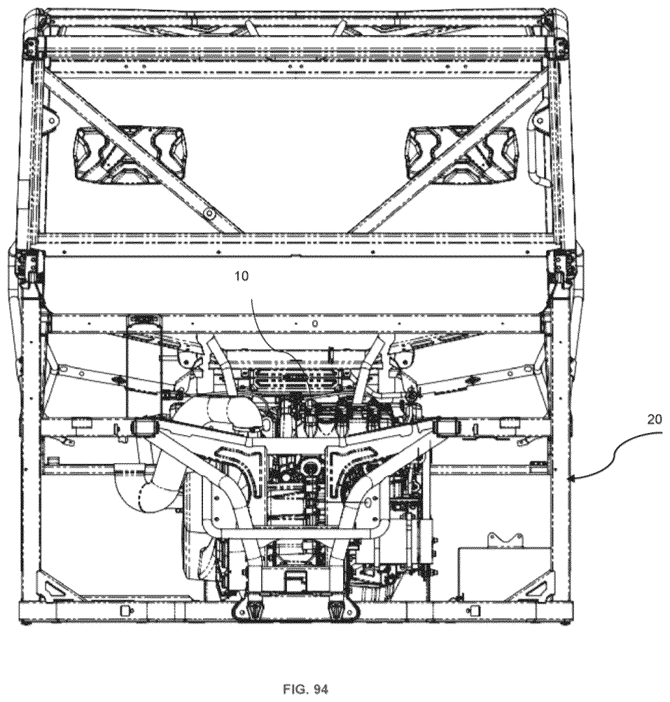

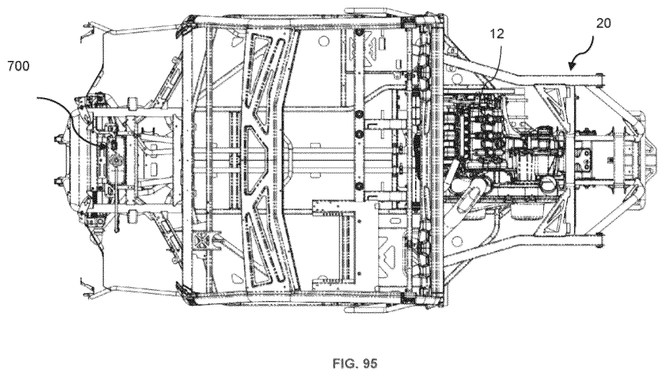

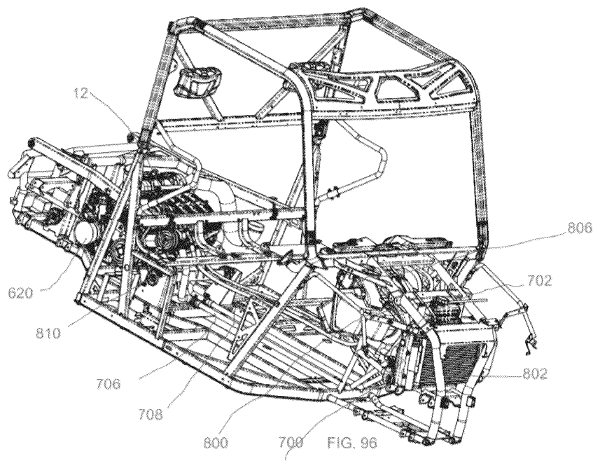

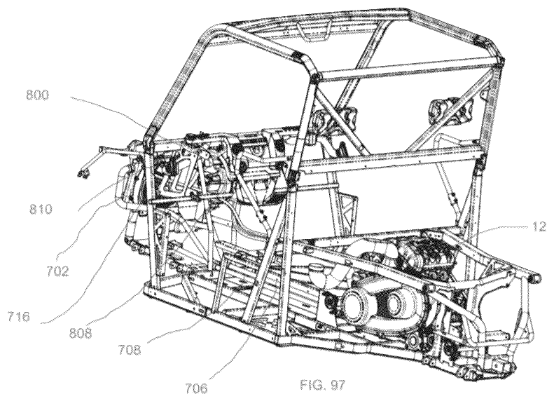

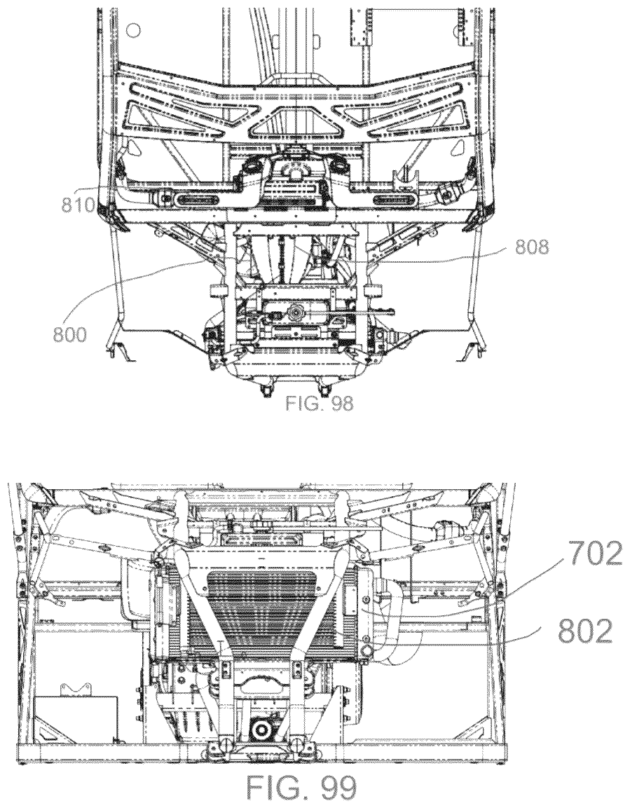

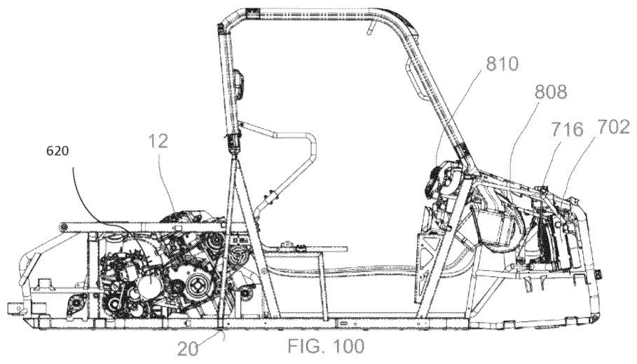

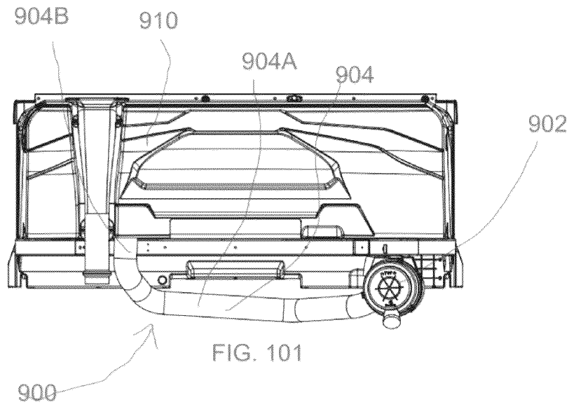

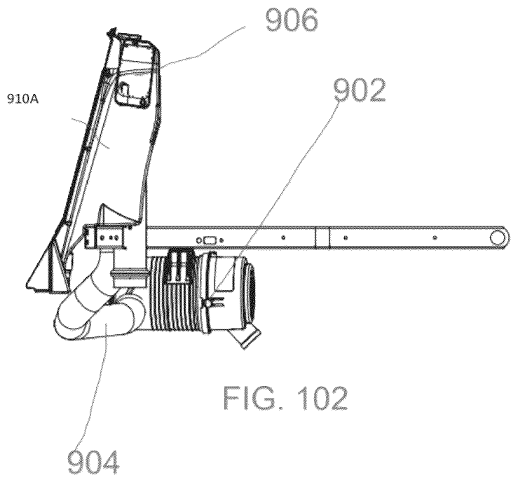

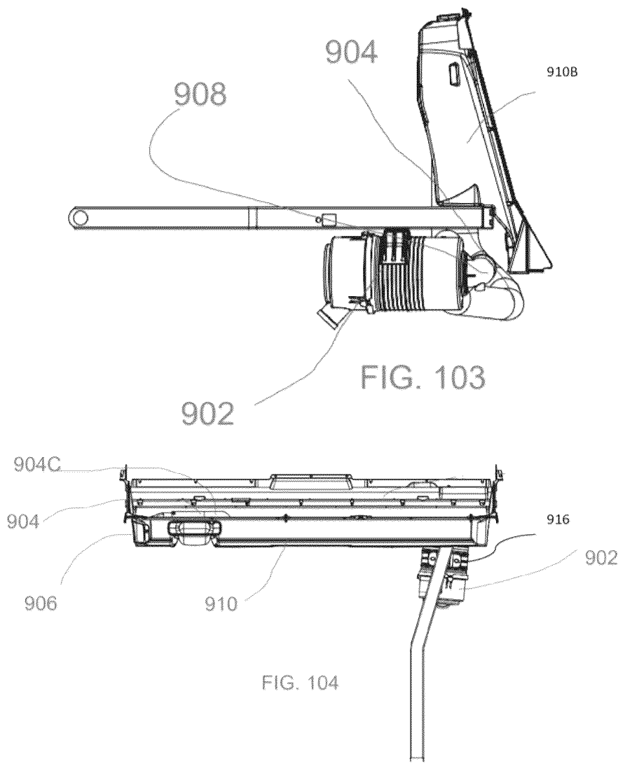

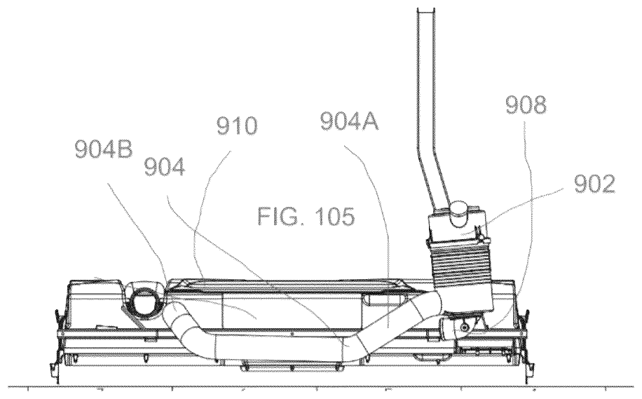

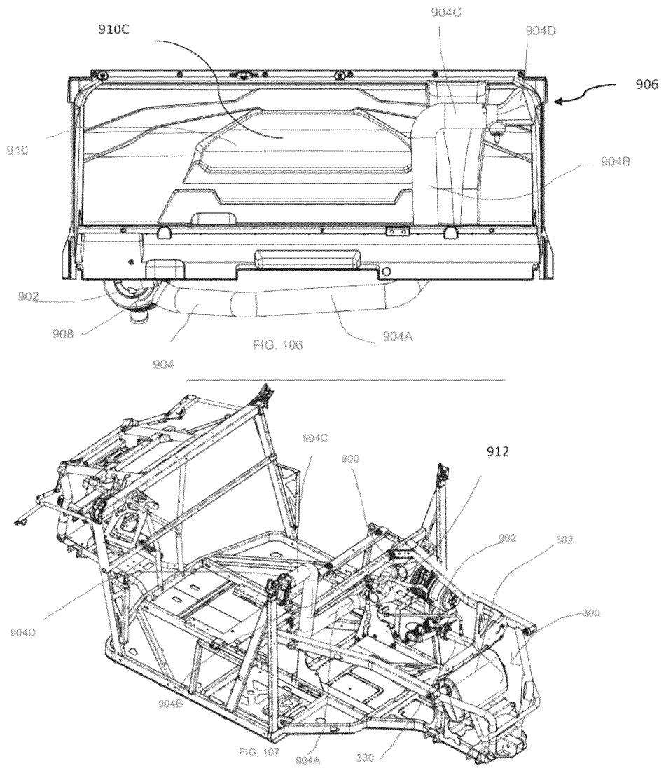

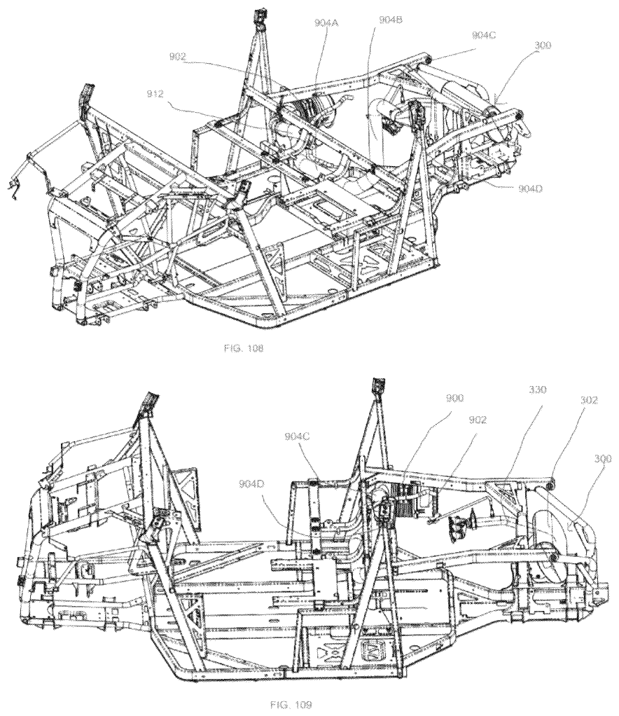

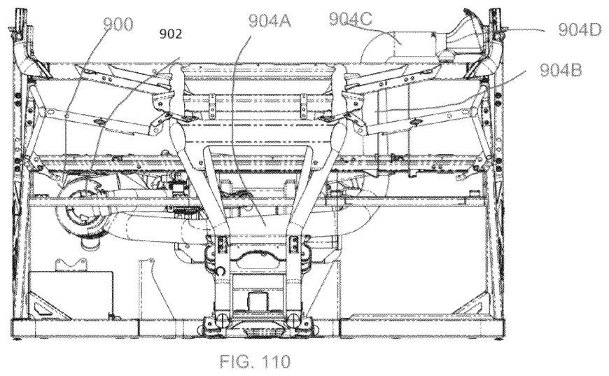

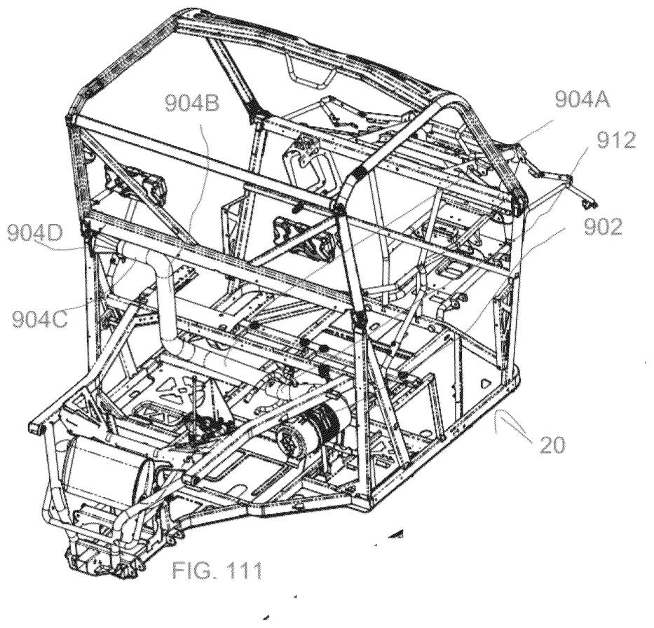

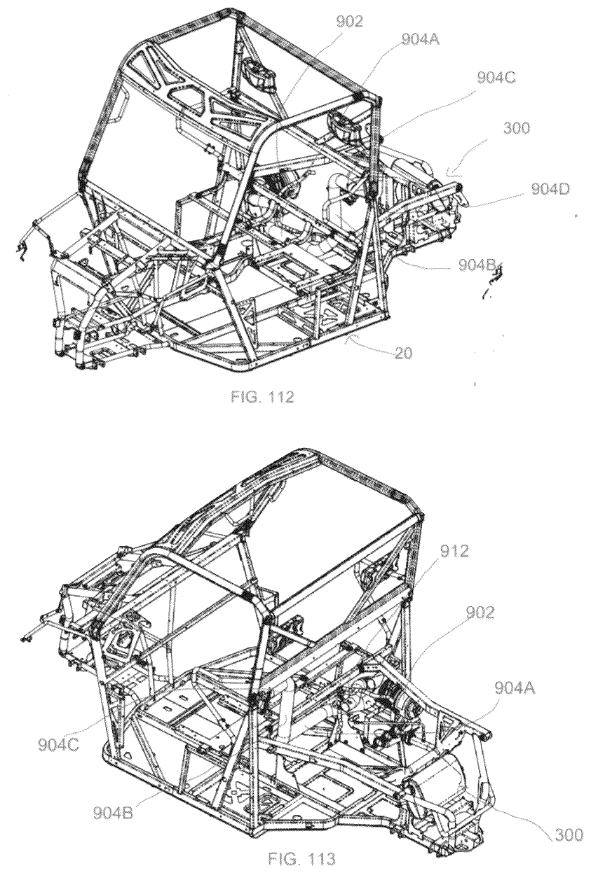

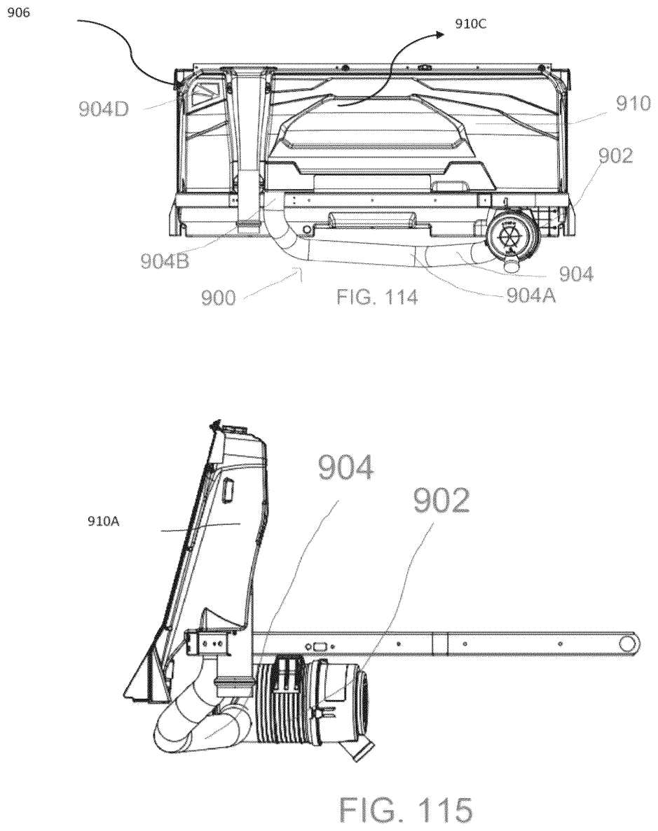

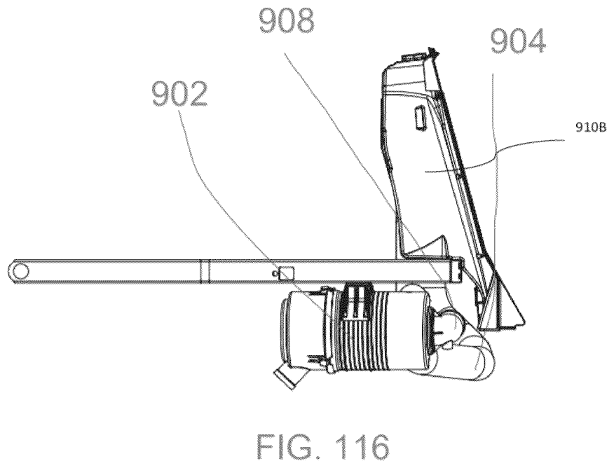

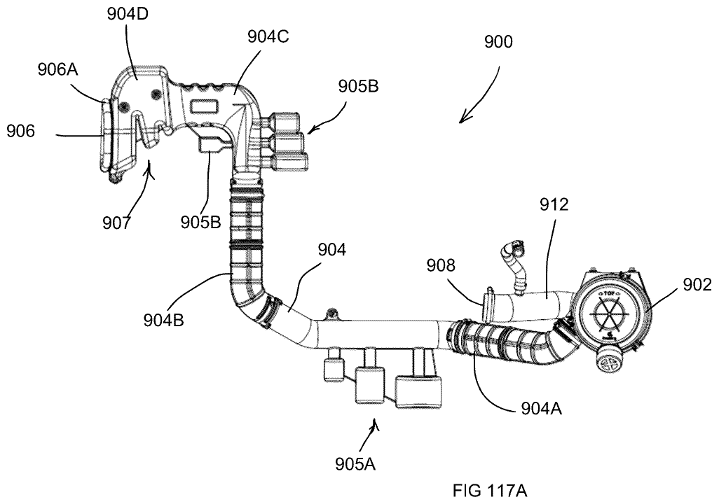

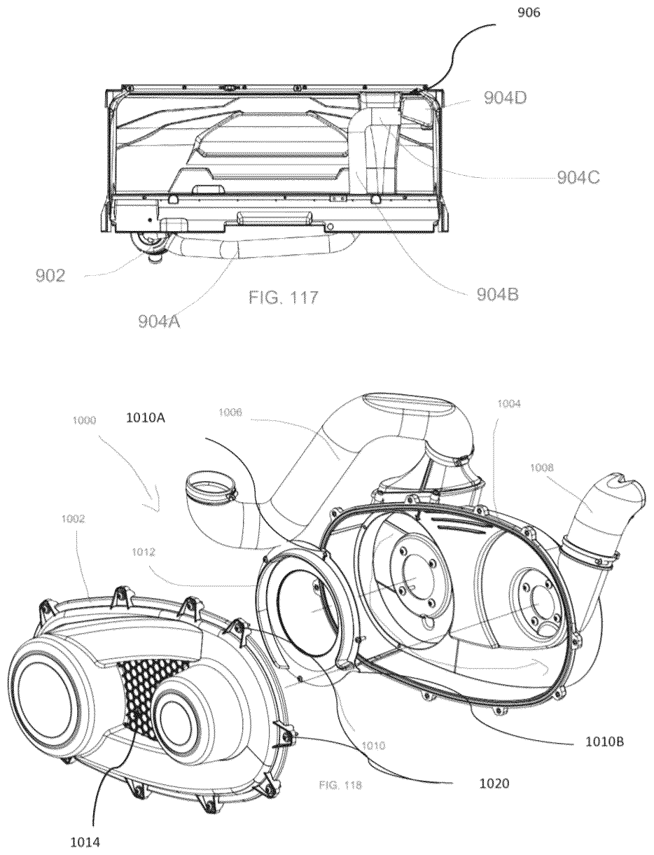

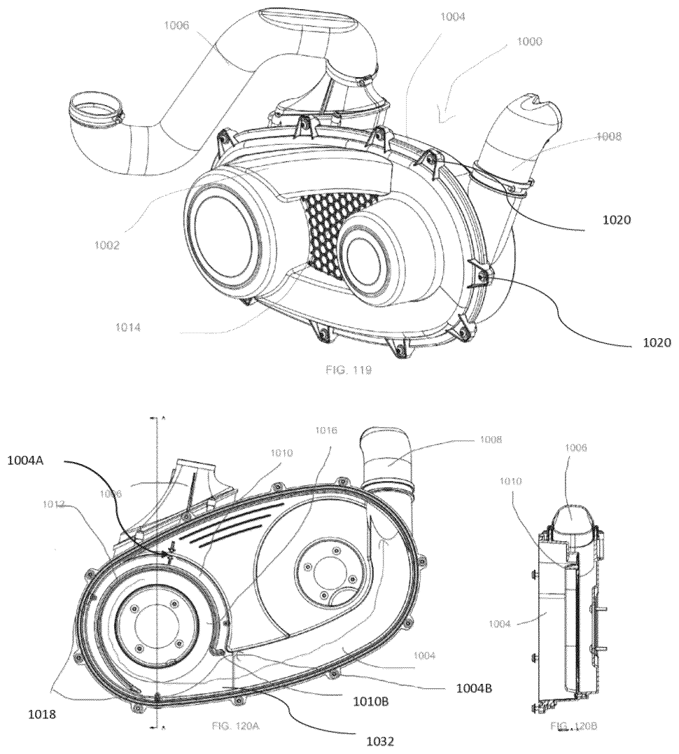

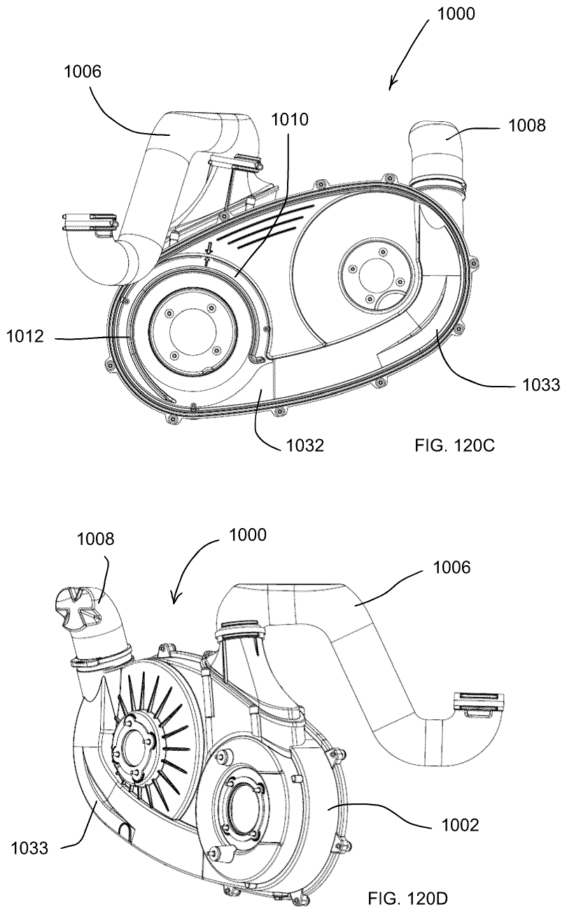

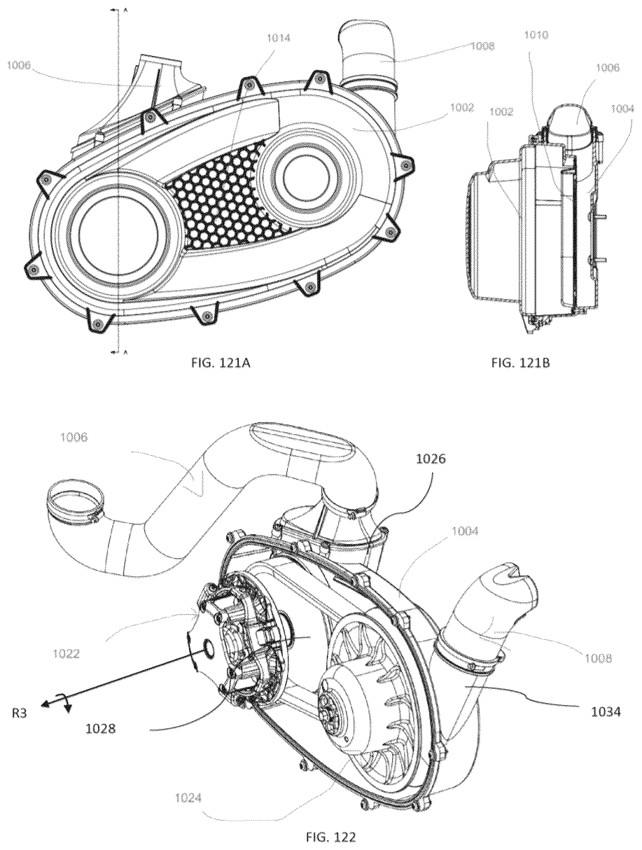

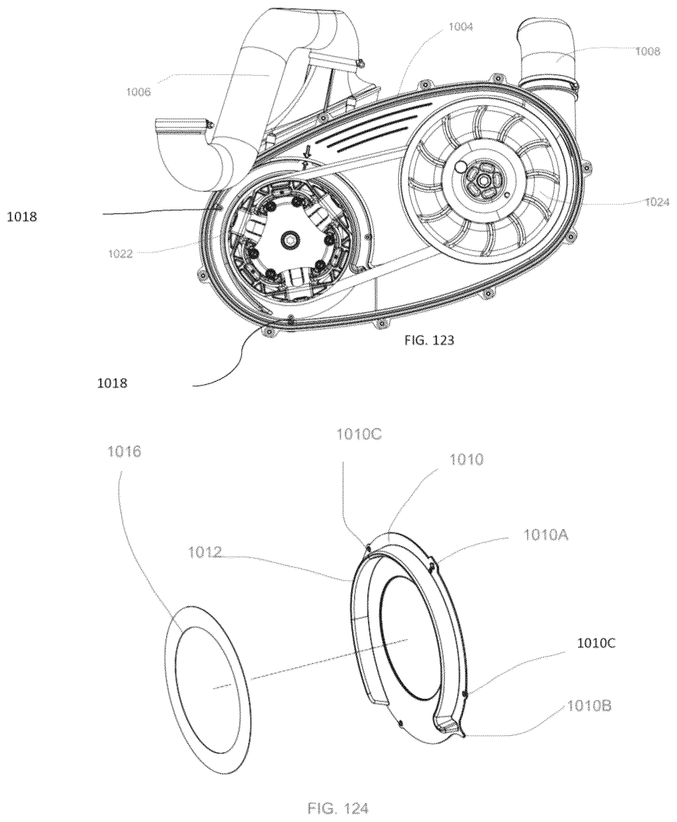

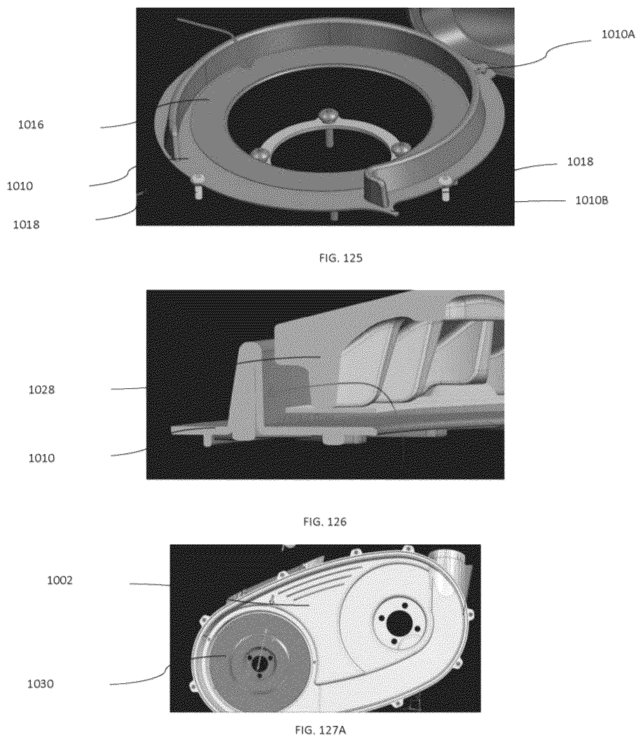

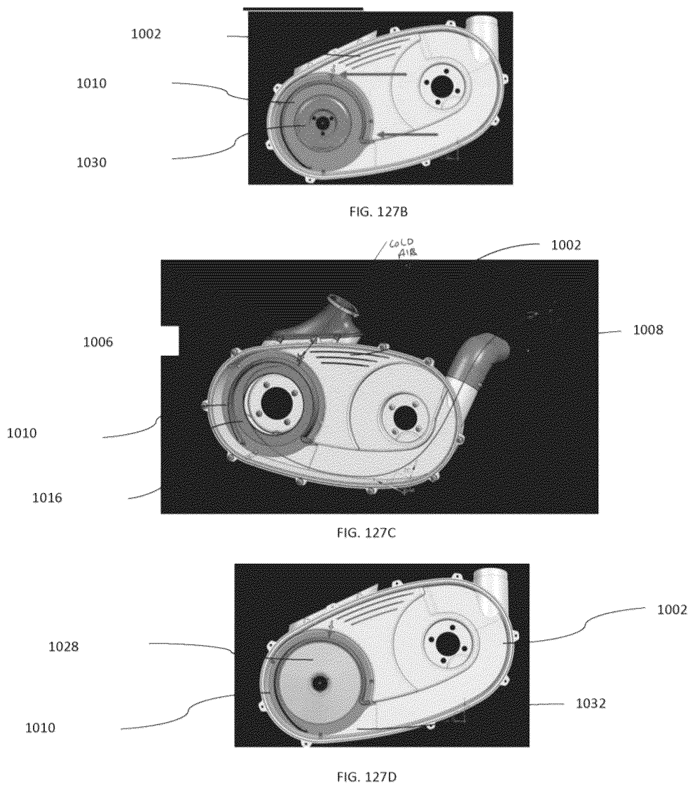

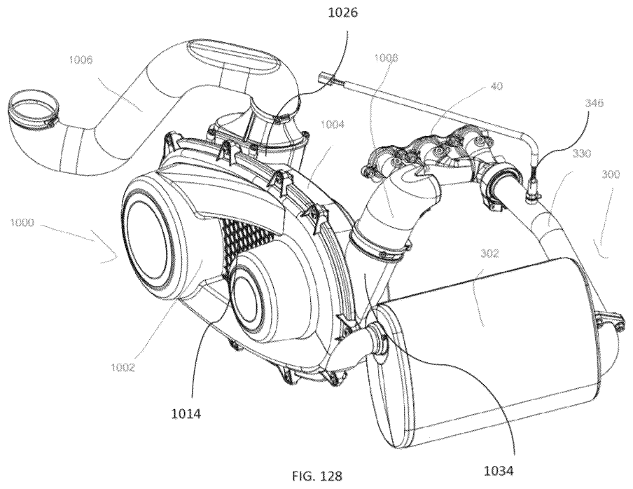

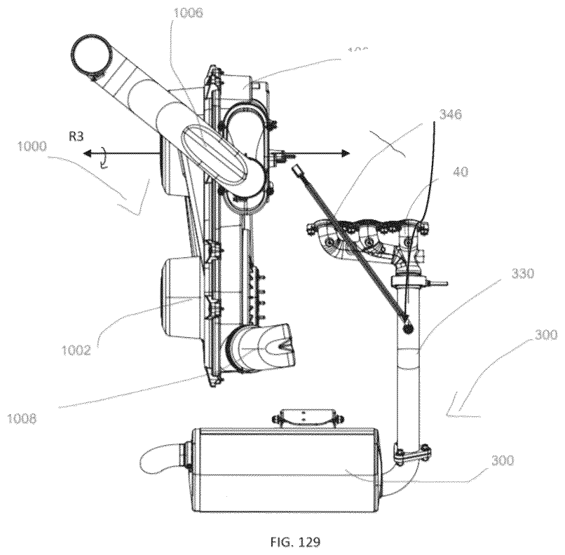

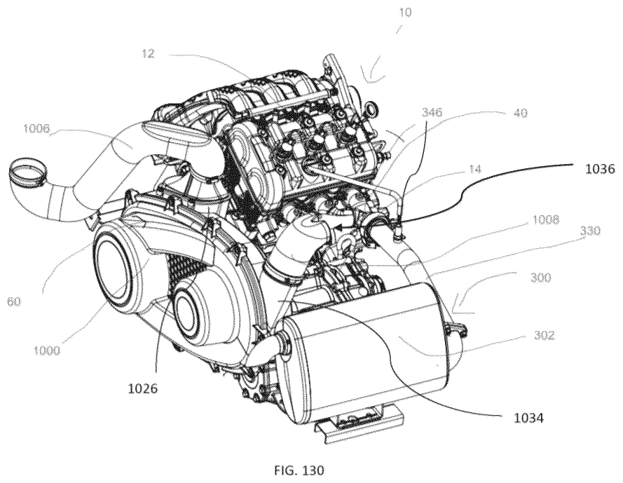

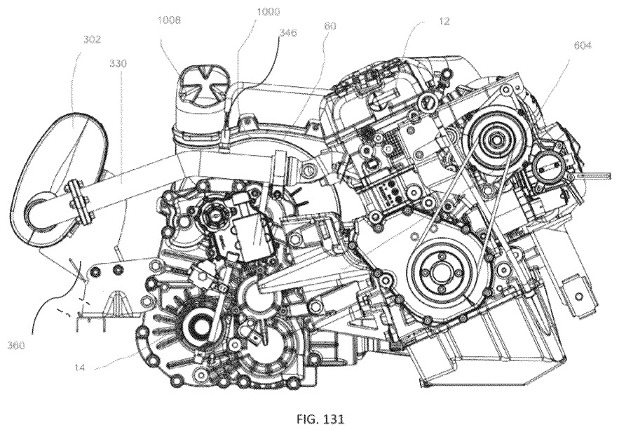

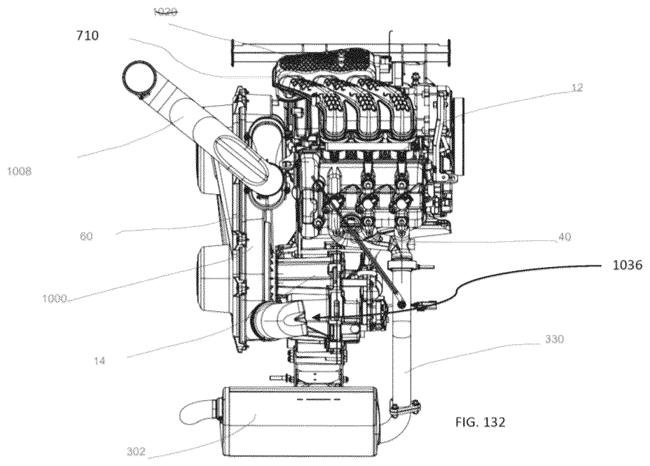

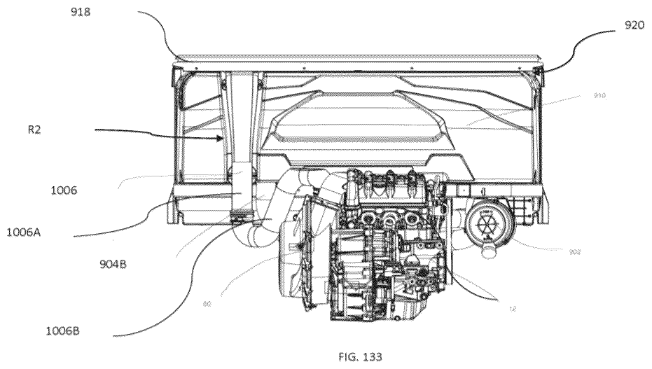

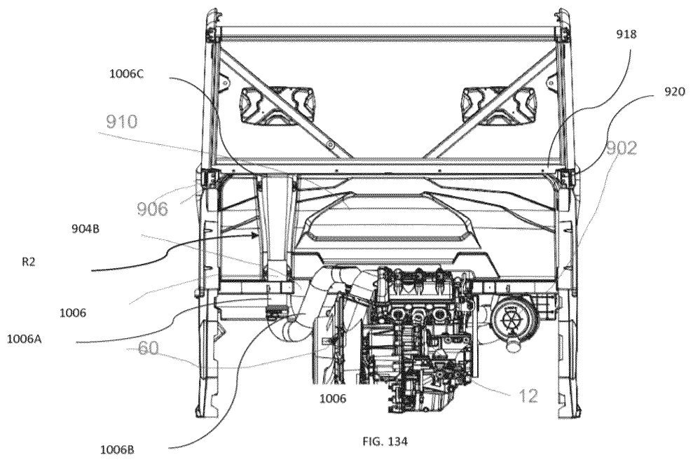

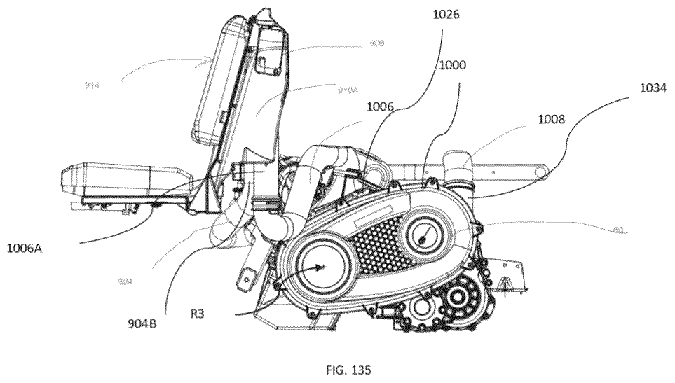

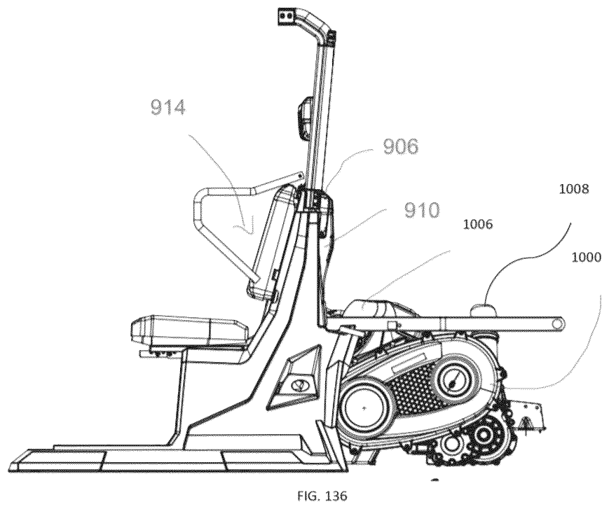

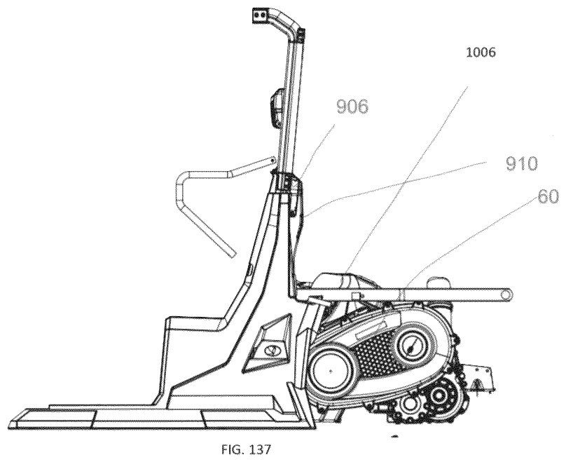

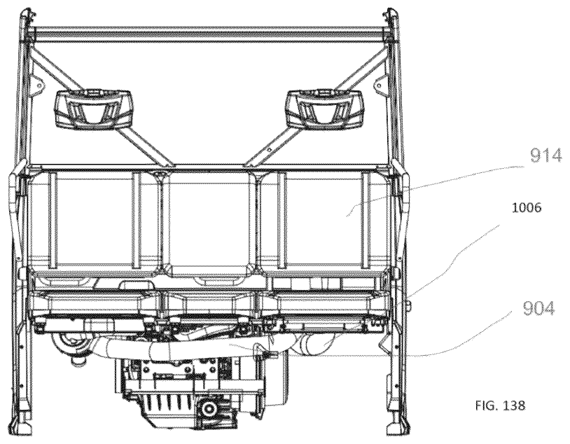

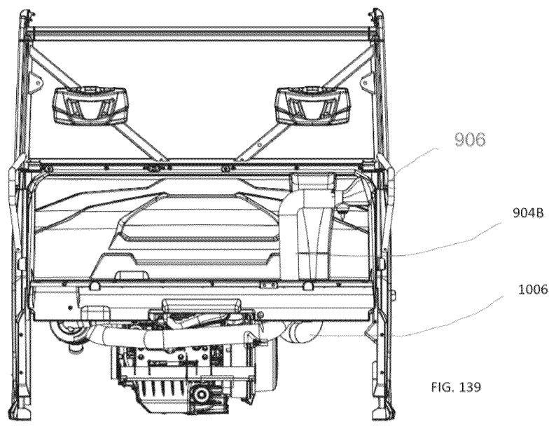

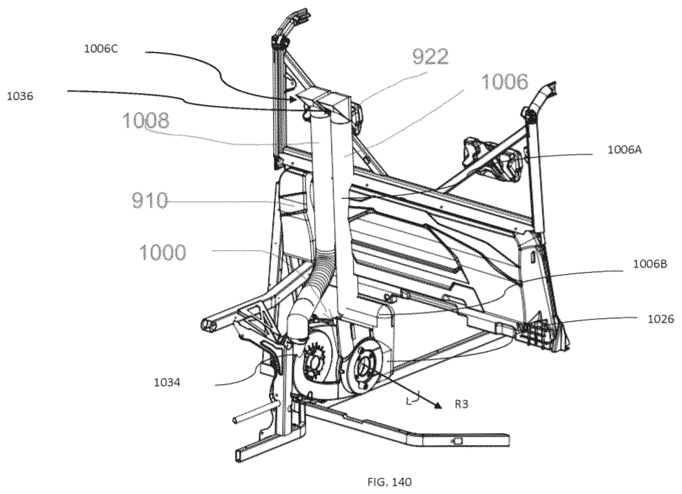

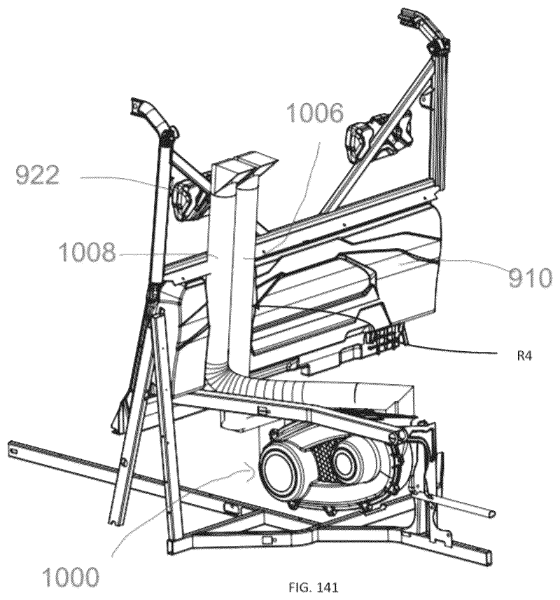

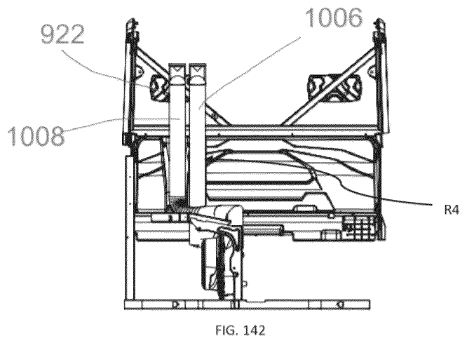

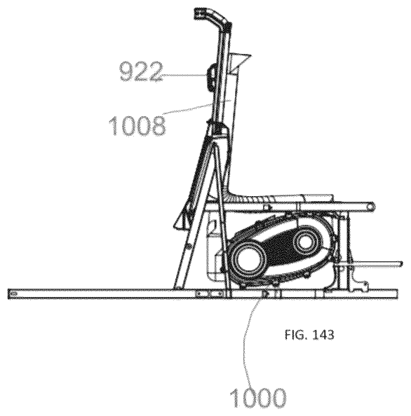

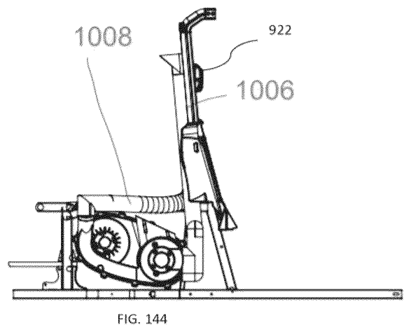

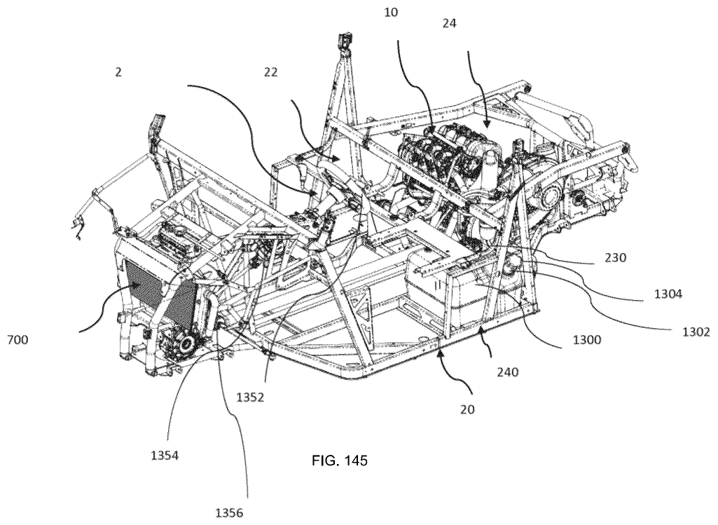

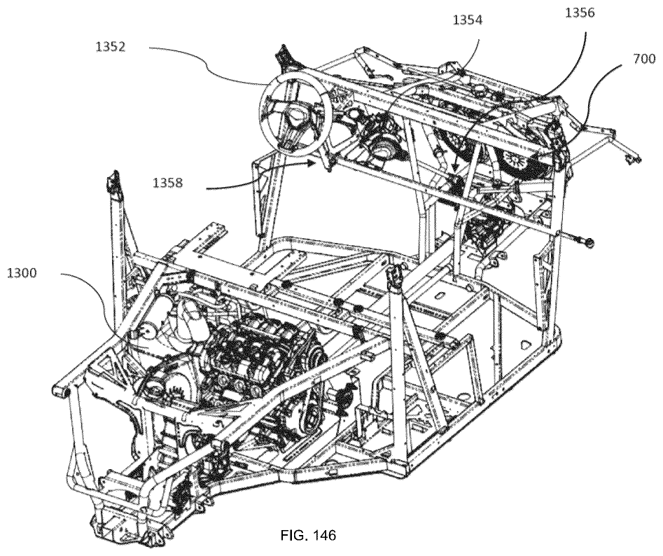

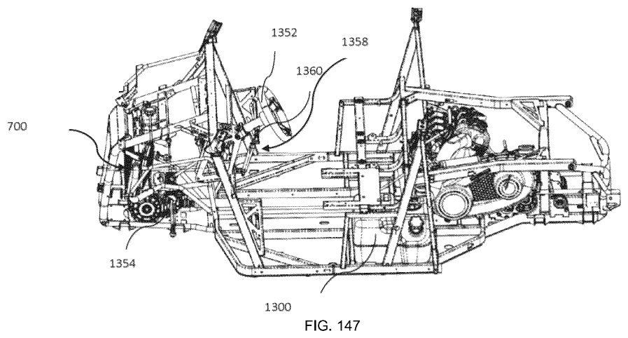

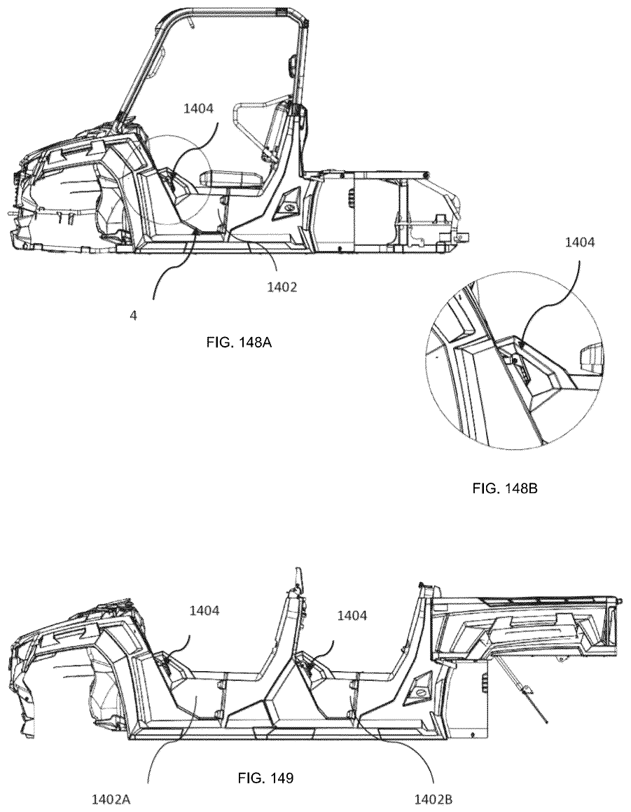

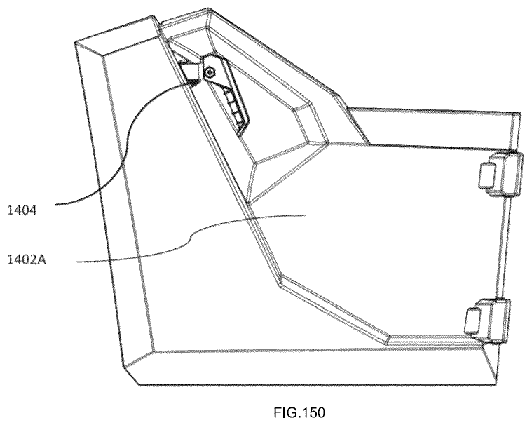

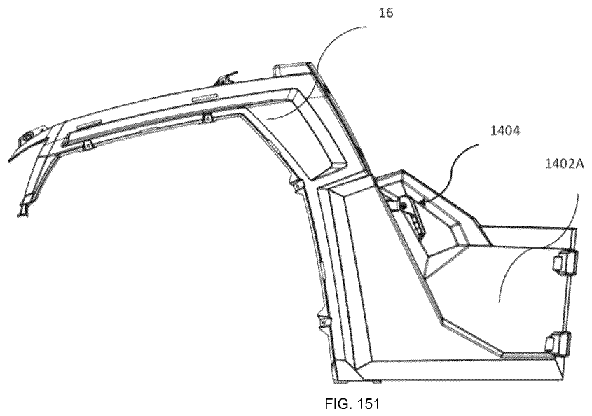

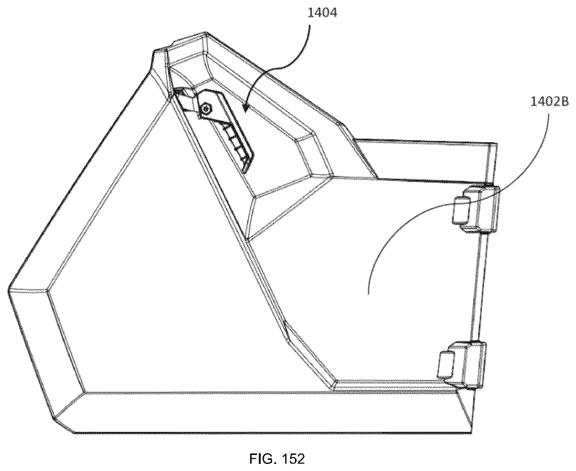

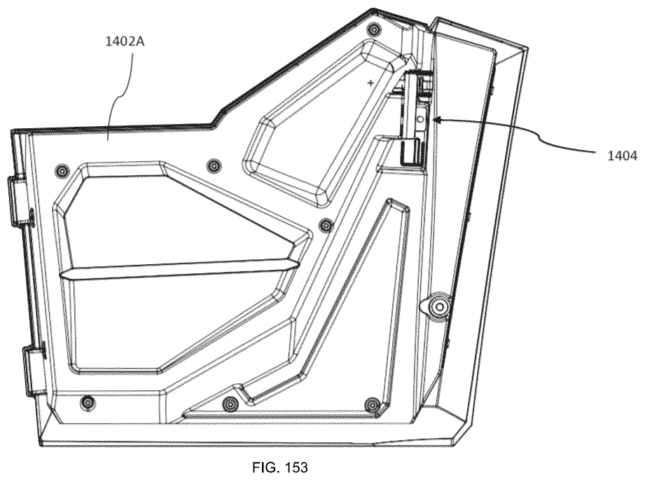

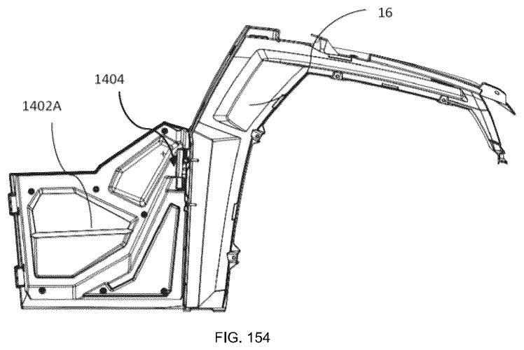

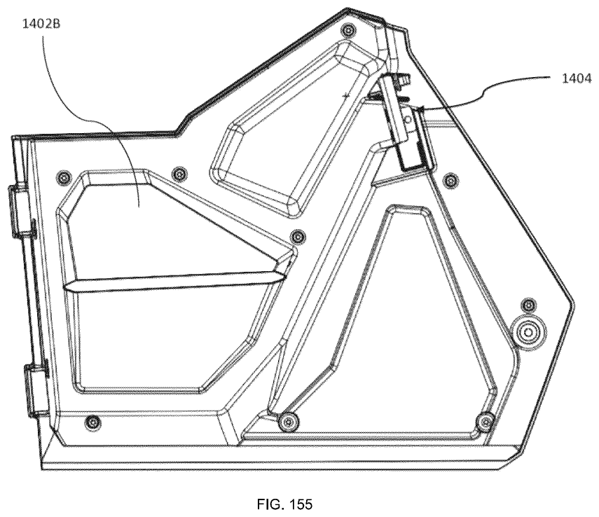

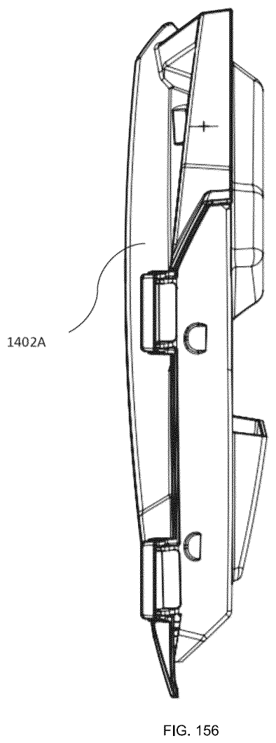

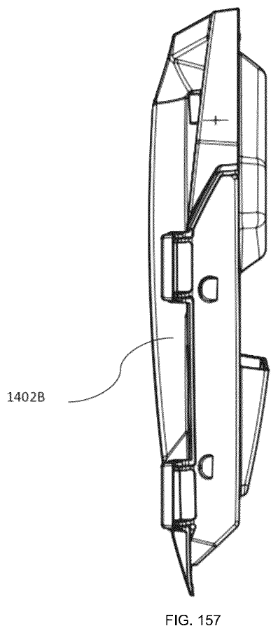

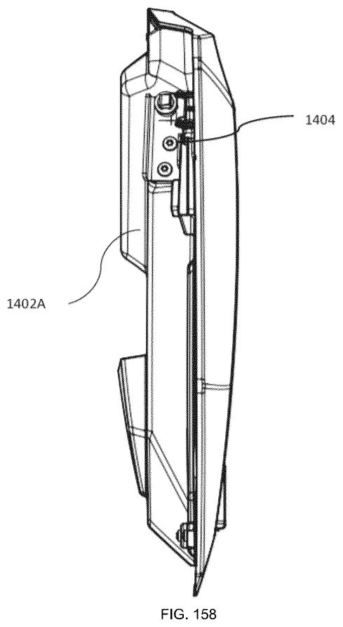

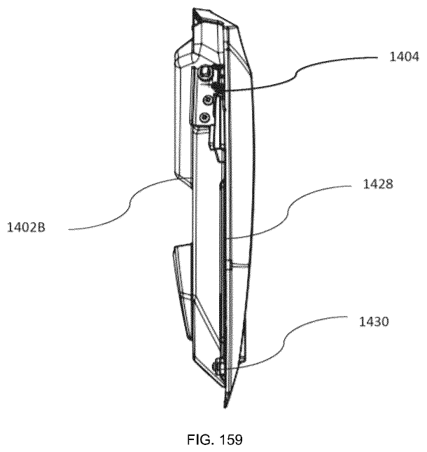

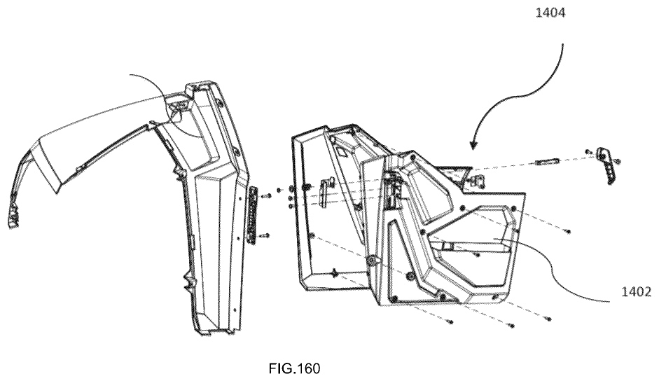

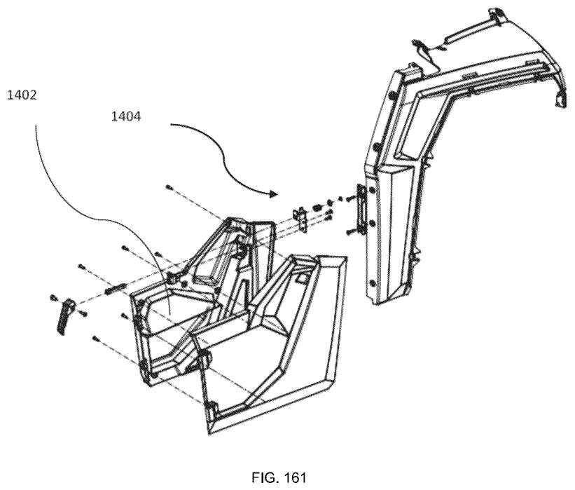

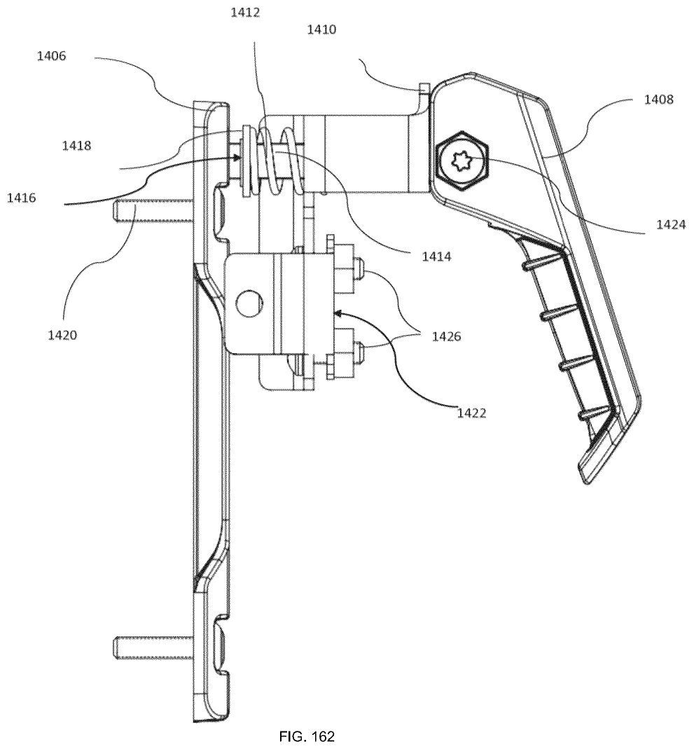

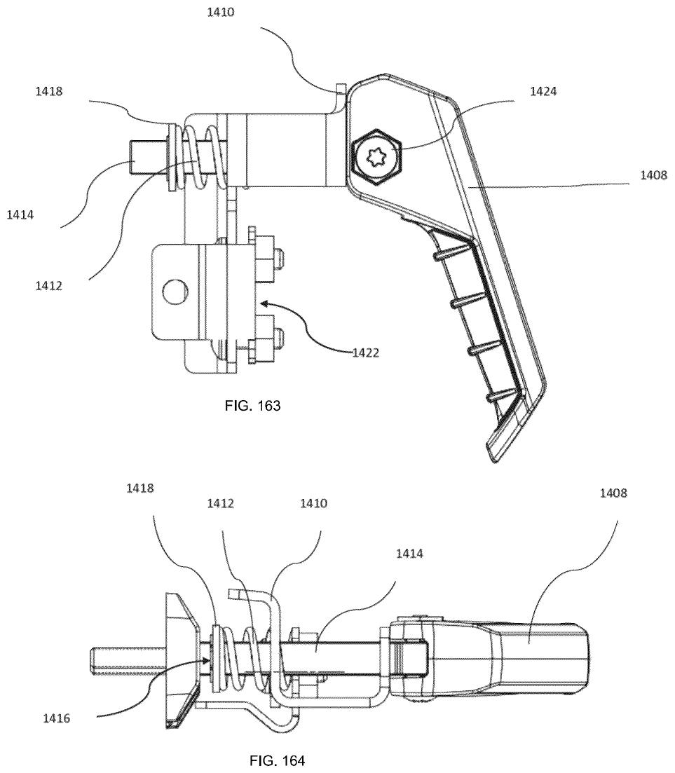

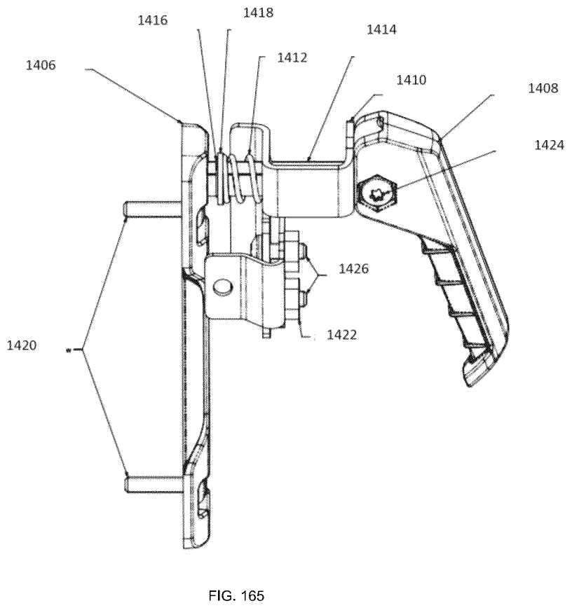

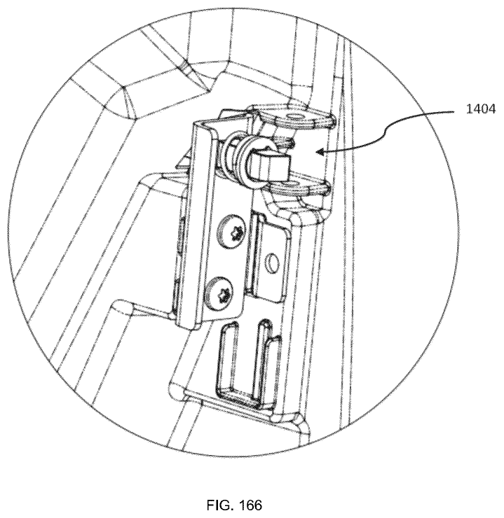

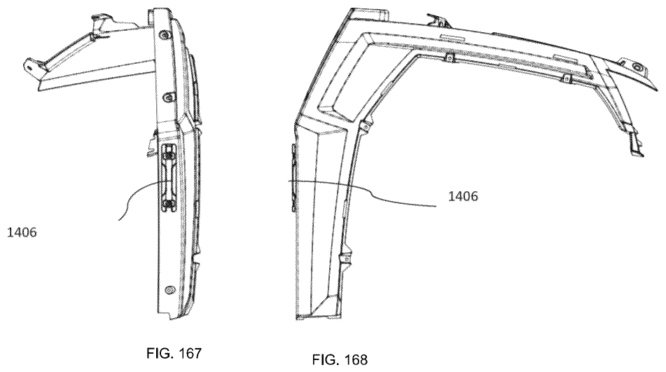

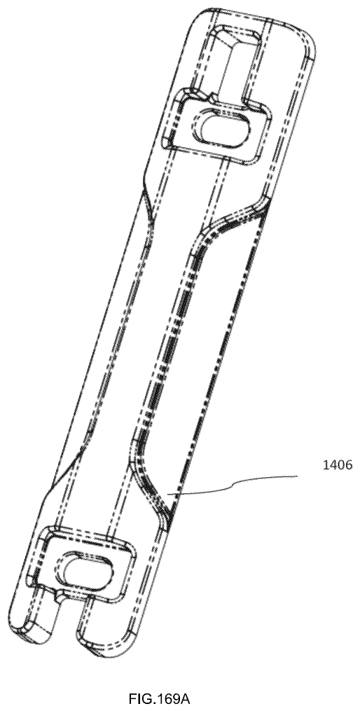

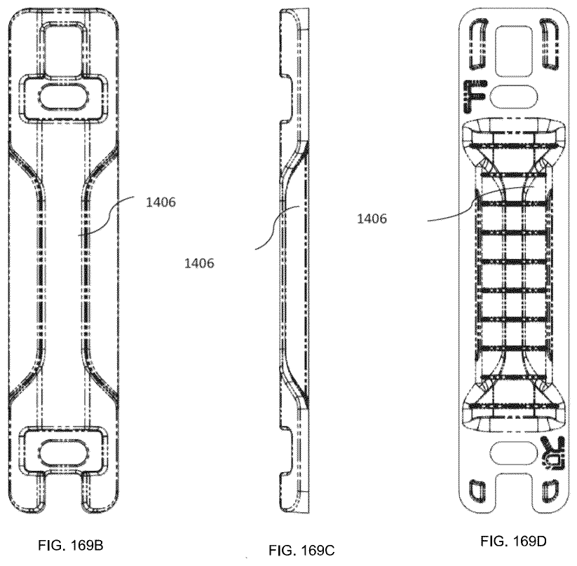

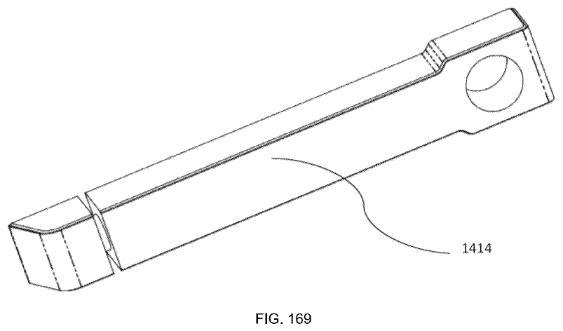

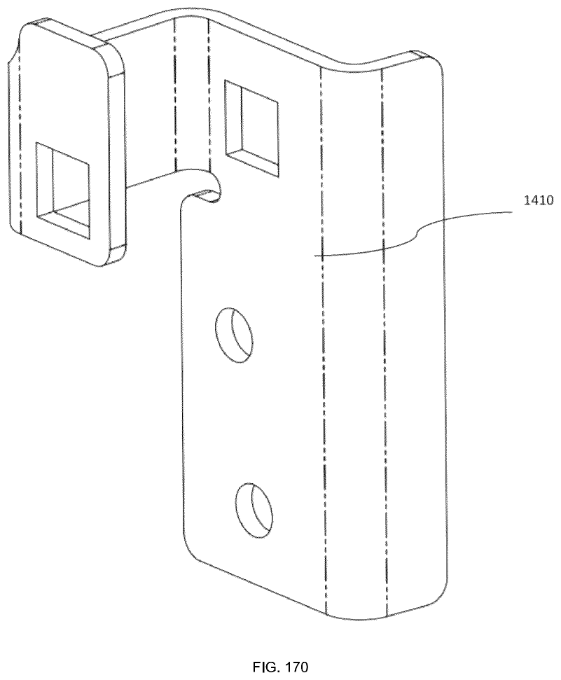

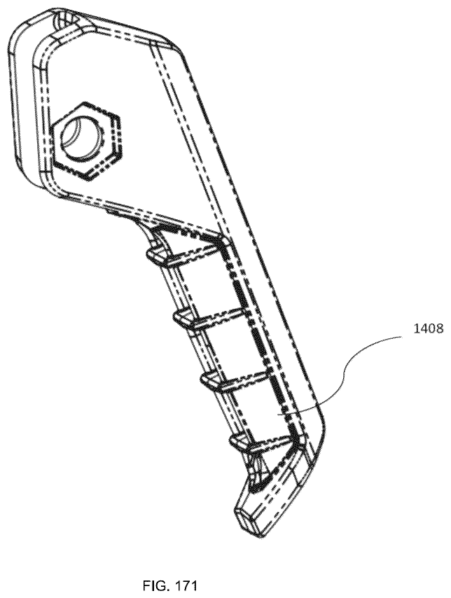

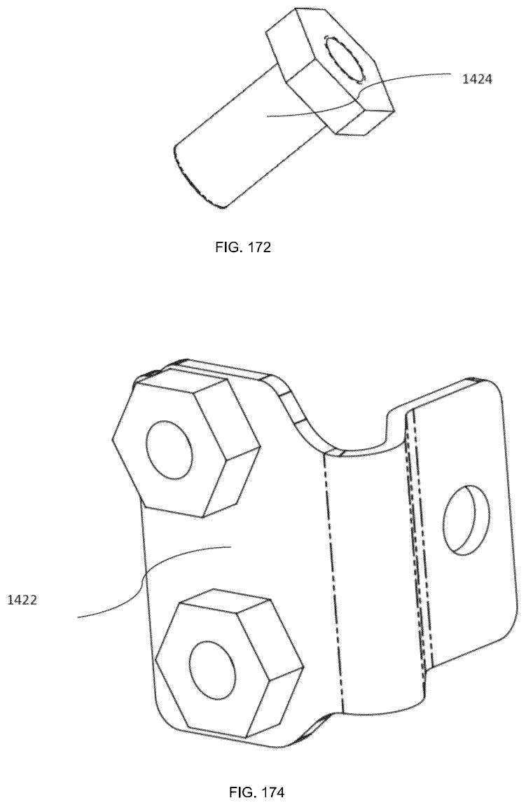

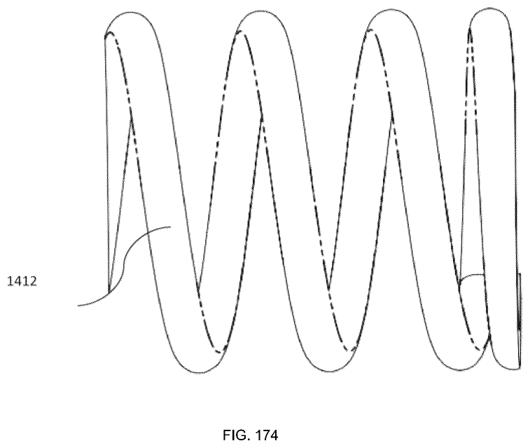

FIGS. 2Q-2R illustrate exemplary side views of a frame of an off-road vehicle in accordance with the present disclosure.

FIG. 2S illustrates an exemplary rear view of a frame of an off-road vehicle in accordance with the present disclosure.

FIG. 2T illustrates an exemplary isometric view of a rear portion of the frame of an off-road vehicle in accordance with the present disclosure.

FIG. 2U illustrates an exemplary side view of a rear portion of a frame of an off-road vehicle in accordance with the present disclosure.

FIG. 3 illustrates an exemplary top view of an engine assembly of an off-road vehicle in accordance with the present disclosure.

FIGS. 4-5 illustrate an exemplary rear mount assembly according to an embodiment of the present disclosure.

FIG. 5A illustrates an enlarged view of an exemplary rear mount assembly according to an embodiment of the present disclosure.

FIG. 5B illustrates a rear view of a straddling rear frame bracket of an off-road vehicle in accordance with the present disclosure.

FIG. 5C illustrates an isometric view of a straddling rear frame bracket of an off-road vehicle in accordance with the present disclosure.

FIG. 6 illustrates an exemplary engine assembly installed using a rear mount assembly according to an embodiment of the present disclosure.

FIG. 7 illustrates an exemplary isometric view of a removable frame member of an off-road vehicle according to an embodiment of the present disclosure.

FIG. 8 illustrates an exemplary frame structure of an off-road vehicle with a removable frame member removed according to an embodiment of the present disclosure.

FIGS. 9-10 illustrate an exemplary frame structure with a secured removable frame member therewith according to an embodiment of the present disclosure.

FIGS. 11A-11B illustrate exemplary methods of installing an engine assembly in an off-road vehicle according to embodiments of the present disclosure.

FIG. 11C illustrates an exemplary installed engine assembly of an off-road vehicle in accordance with the present disclosure.

FIGS. 12A-12D illustrate exemplary methods of removing an engine assembly from an off-road vehicle according to embodiments of the present disclosure.

FIGS. 13A-13B illustrate exemplary views from a first side of an installed engine assembly within a frame of an off-road vehicle in accordance with the present disclosure.

FIGS. 14A-14B illustrate exemplary views from a second side of an installed engine assembly within a frame of an off-road vehicle in accordance with the present disclosure.

FIGS. 15A-15B illustrate an exemplary top view and a bottom view, respectively, of an installed engine assembly within a frame of an off-road vehicle in accordance with the present disclosure.

FIGS. 16-17 illustrate exemplary side views of an exhaust assembly and an engine assembly of an off-road vehicle according to one embodiment of the present disclosure.

FIG. 18 illustrates an exemplary top view of an exhaust assembly and an engine assembly of an off-road vehicle in accordance with the present disclosure.

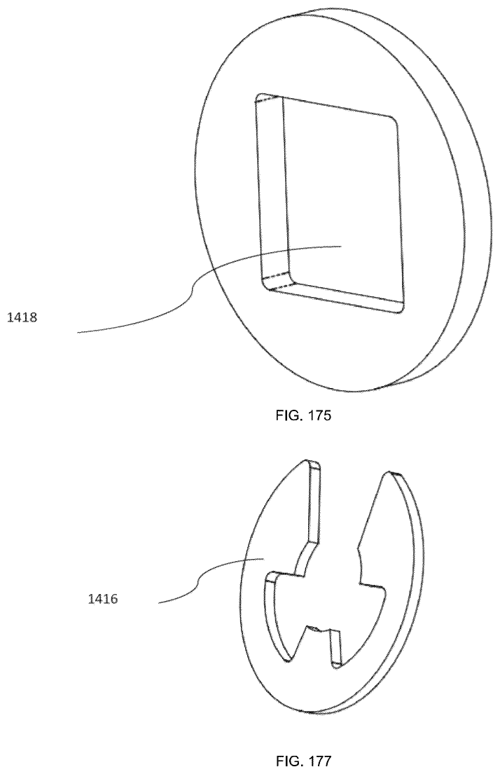

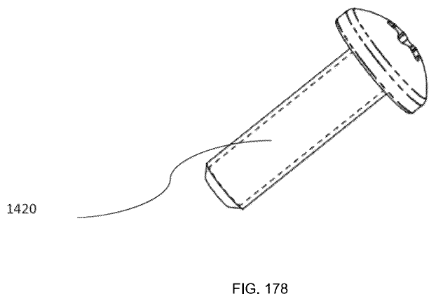

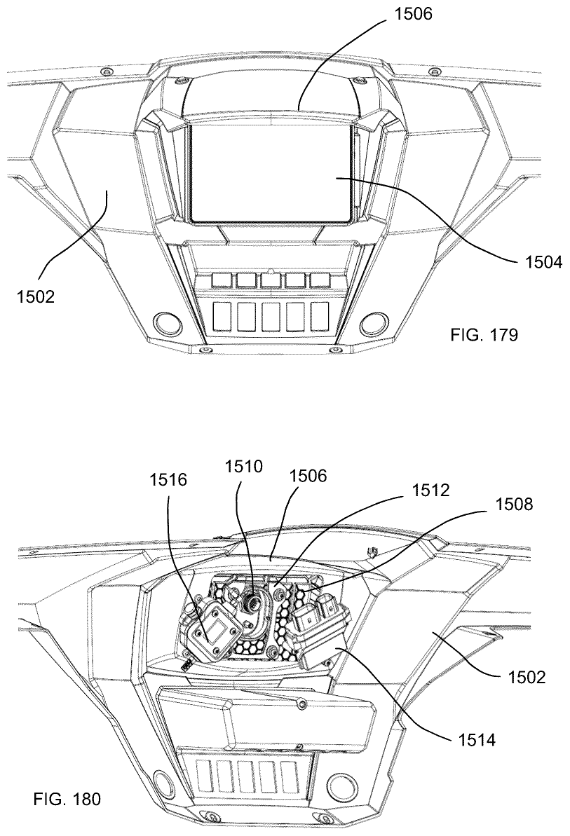

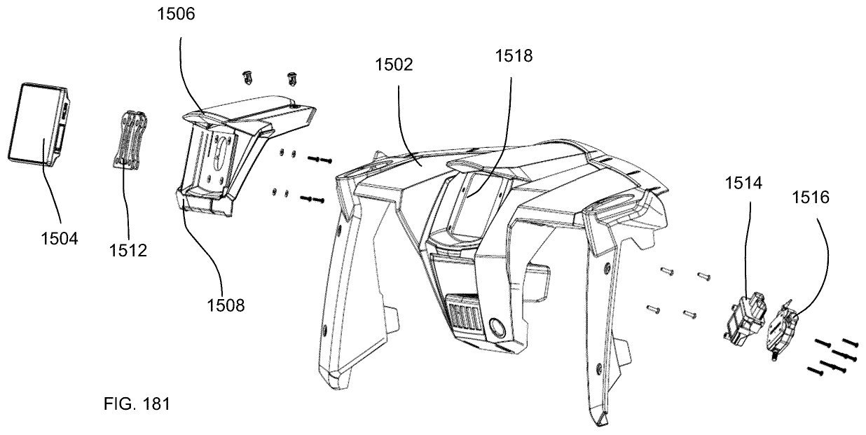

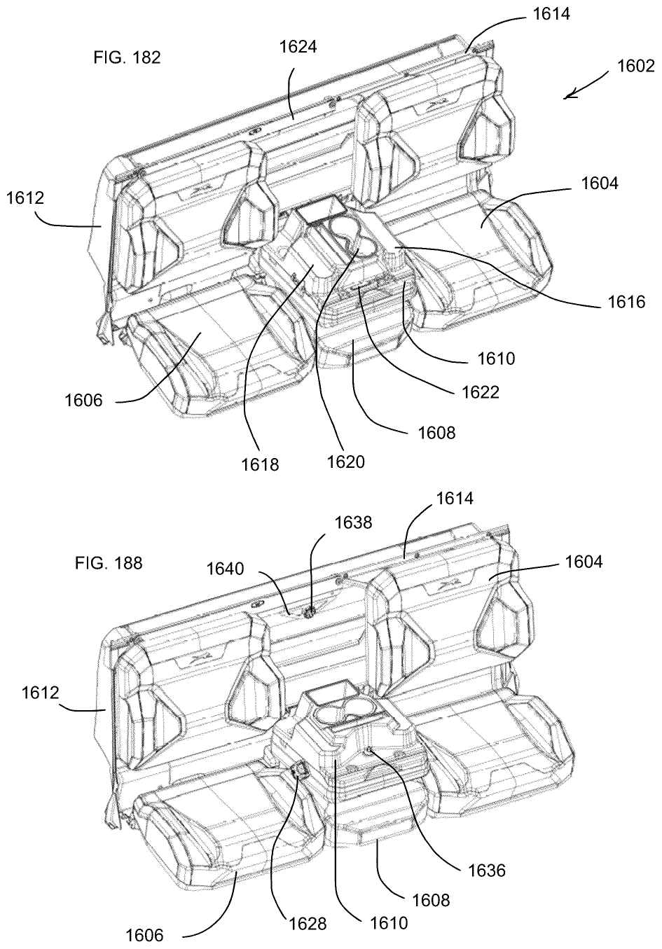

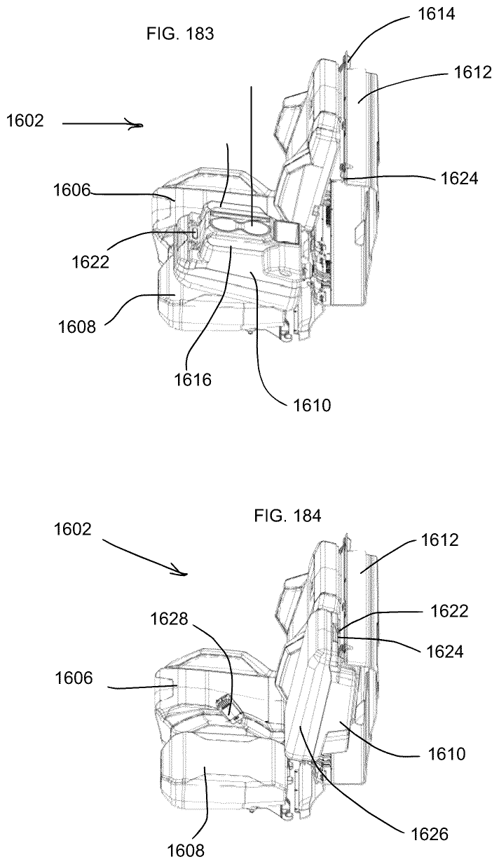

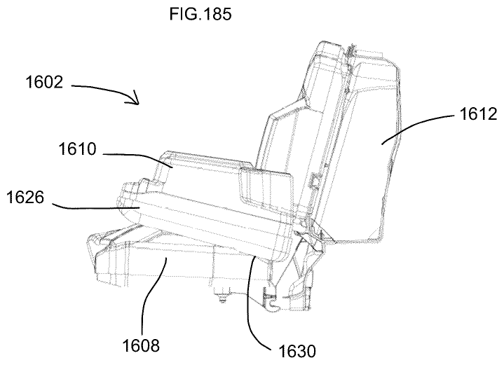

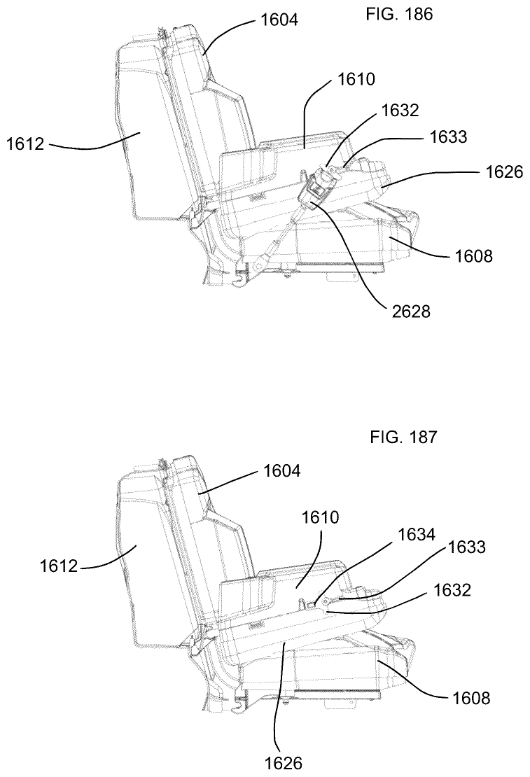

FIGS. 19-20 illustrate exemplary internal structures of an exhaust muffler of an off-road vehicle in accordance with the present disclosure.

FIG. 21 illustrates an exemplary side view of an exhaust assembly of an off-road vehicle according to another embodiment of the present disclosure.

FIG. 22 illustrates an exemplary top view of an exhaust assembly and an engine assembly of an off-road vehicle of FIG. 21 in accordance with the present disclosure.

FIG. 23 illustrates an exemplary side view of a pair of muffler mount brackets of an off-road vehicle in accordance with the present disclosure.

FIG. 24 illustrates an exemplary top isometric view of a pair of muffler mount brackets of an off-road vehicle in accordance with the present disclosure.

FIGS. 24A-24B illustrate exemplary exploded views of an exhaust assembly in accordance with the present disclosure.

FIG. 24C illustrates an exemplary isometric view of an exhaust assembly of FIG. 24A in accordance with the present disclosure.

FIGS. 24D-24E illustrate exemplary top views of an exhaust assembly of FIG. 24A in accordance with the present disclosure.

FIGS. 24F-24G illustrate exemplary rear views of an exhaust assembly of FIG. 24A in accordance with the present disclosure.

FIGS. 24H-24J illustrate exemplary side views of an exhaust assembly of FIG. 24A in accordance with the present disclosure.

FIG. 24K illustrates an isometric view of an alternative embodiment of the exhaust assembly with a flexible coupling.

FIGS. 25-26 illustrate exemplary rear views of a rear suspension assembly in accordance with the present disclosure.

FIG. 27 illustrates an exemplary side view of a rear suspension assembly of FIG. 25 in accordance with the present disclosure.

FIG. 28 illustrates an exemplary bottom view of a rear suspension assembly of FIG. 25 in accordance with the present disclosure.

FIG. 29 illustrates an exemplary top view of a rear suspension assembly of FIG. 25 in accordance with the present disclosure.

FIG. 30 illustrates exemplary rear upper and lower A-arms of a rear suspension assembly of FIG. 25 in accordance with the present disclosure.

FIG. 31 illustrates an exemplary top view of rear upper and lower A-arms of a rear suspension assembly of FIG. 25 having rear damping members connected therewith in accordance with the present disclosure.

FIG. 32 illustrates an exemplary bottom view of rear upper and lower A-arms of a rear suspension assembly of FIG. 25 having rear damping members connected therewith in accordance with the present disclosure.

FIG. 33 illustrates an exemplary rear view of rear upper and lower A-arms of a rear suspension assembly of FIG. 25 having rear damping members connected therewith in accordance with the present disclosure.

FIGS. 33A-33B illustrate exemplary isometric views of a rear suspension assembly in accordance with the present disclosure.

FIGS. 33C-33D illustrate exemplary top views of a rear suspension assembly of FIG. 33A in accordance with the present disclosure.

FIGS. 33E-33F illustrate exemplary bottom views of a rear suspension assembly of FIG. 33A in accordance with the present disclosure.

FIG. 33G illustrates exemplary isometric view of rear right A-arms of a rear suspension assembly of FIG. 33A in rear and side of a vehicle in accordance with the present disclosure.

FIG. 33H illustrates an exemplary enlarged view of a mounting interface of a rear suspension assembly of FIG. 33A in accordance with the present disclosure.

FIG. 33I illustrates an exemplary isometric view of rear left A-arms of a rear suspension assembly of FIG. 33A in rear and side of a vehicle in accordance with the present disclosure.

FIG. 33J illustrates an exemplary bottom view of a mounting interface of a rear suspension assembly of FIG. 33A in accordance with the present disclosure.

FIG. 33K illustrates exemplary isometric view of a frame mounted with a rear suspension assembly of FIG. 33A therein in accordance with the present disclosure.

FIG. 33L illustrates exemplary side view of a frame mounted with a rear suspension assembly of FIG. 33A therein in accordance with the present disclosure.

FIGS. 33M-33R illustrate a front suspension assembly in accordance with the present disclosure.

FIGS. 33S-33T illustrate a front view of a front suspension assembly and a rear suspension assembly having damping members connected therewith in accordance with the present disclosure.

FIGS. 33U-33V illustrate a rear view of a front suspension assembly and a rear suspension assembly having damping members connected therewith in accordance with the present disclosure.

FIGS. 33AA-33AI illustrate a frame with a rear suspension assembly and a front suspension assembly in accordance with the present disclosure.

FIG. 34 illustrates an exemplary hitch assembly of an off-road vehicle in accordance with the present disclosure.

FIG. 35 illustrates an exemplary partially exploded view of a hitch assembly of an off-road vehicle in accordance with the present disclosure.

FIGS. 36-37 illustrate exemplary exploded views of a hitch assembly of an off-road vehicle in accordance with the present disclosure.

FIG. 38 illustrates a bottom isometric view of a hitch assembly coupled to a frame of an off-road vehicle according to an embodiment of the present disclosure.

FIG. 39 illustrates an exemplary rear view of a hitch assembly coupled to a frame of an off-road vehicle according to an embodiment of the present disclosure.

FIG. 40 illustrates an exemplary bottom view of a hitch assembly coupled to a frame of an off-road vehicle according to an embodiment of the present disclosure.

FIGS. 41-45 illustrate exemplary exploded views of a hitch assembly having an inverted U-shaped supporting member according to an embodiment of the present disclosure.

FIG. 46 illustrates an exemplary inverted U-shaped supporting member of a hitch assembly according to an embodiment of the present disclosure.

FIG. 47 illustrates an exemplary top view of an engine assembly according to an embodiment of the present disclosure.

FIG. 48 illustrates an exemplary isometric view of an engine assembly from rear and left side of an off-road vehicle in accordance with the present disclosure.

FIG. 49 illustrates an exemplary isometric view of an engine assembly from front and left side of an off-road vehicle in accordance with the present disclosure.

FIG. 50 illustrates an exemplary left side-elevational view of an engine assembly in accordance with the present disclosure.

FIG. 51 illustrates an exemplary isometric view of an engine assembly from rear and right side of an off-road vehicle in accordance with the present disclosure.

FIG. 52 illustrates an exemplary right side-elevational view of an engine assembly in accordance with the present disclosure.

FIGS. 53-54 illustrate a first coupling plate in accordance with the present disclosure.

FIGS. 55-58 illustrate a second coupling plate in accordance with the present disclosure.

FIGS. 59-60 illustrate exemplary side views of a frame and an engine assembly having coupling plate connecting engine components together in accordance with the present disclosure.

FIG. 60A illustrates an alternative coupling plate.

FIGS. 60B-C illustrate a multi-part plate that secures an engine accessory component.

FIG. 61 illustrates an exemplary isometric view, from front and right side of an off-road vehicle, of an engine assembly having a compressor mounted therewith in accordance with the present disclosure.

FIG. 62 illustrates an exemplary right-side view of an engine assembly having a compressor mounted therewith in accordance with the present disclosure.

FIG. 63 illustrates an exemplary isometric view, from rear and left side of an off-road vehicle, of an engine assembly having a compressor mounted therewith in accordance with the present disclosure.

FIG. 64 illustrates an exemplary left-side view of an engine assembly having a compressor mounted therewith in accordance with the present disclosure.

FIG. 65 illustrates an exemplary front view of an engine assembly having a compressor mounted therewith in accordance with the present disclosure.

FIG. 66 illustrates an exemplary top view of an engine assembly having a compressor mounted therewith in accordance with the present disclosure.

FIG. 67 illustrates an exemplary rear view of an engine assembly having a compressor mounted therewith in accordance with the present disclosure.

FIGS. 68-69 illustrate exemplary isometric views of a frame and an engine assembly having a compressor mounted therewith in accordance with the present disclosure.

FIGS. 70-71 illustrate exemplary side views of a frame and an engine assembly having a compressor mounted therewith in accordance with the present disclosure.

FIG. 72 illustrates an exemplary front view of a frame and an engine assembly having a compressor mounted therewith in accordance with the present disclosure.

FIG. 73 illustrates an exemplary rear view of a frame and an engine assembly having a compressor mounted therewith in accordance with the present disclosure.

FIG. 74 illustrates an exemplary top view of a frame and an engine assembly having a compressor mounted therewith in accordance with the present disclosure.

FIG. 75 illustrates an exemplary isometric view of an engine cooling assembly connected with an engine assembly in accordance with the present disclosure.

FIGS. 76-77 illustrate exemplary front views of an engine assembly connected with coolant pipes therewith in accordance with the present disclosure.

FIGS. 78-79 illustrate exemplary top views of an engine assembly connected with coolant pipes therein in accordance with the present disclosure.

FIG. 80 illustrates an exemplary side view of an engine assembly connected with coolant pipes therein in accordance with the present disclosure.

FIG. 81 illustrates an exemplary isometric view of an engine assembly connected with coolant pipes therein in accordance with the present disclosure.

FIG. 82 illustrates an exemplary side view of an engine cooling assembly in accordance with the present disclosure.

FIG. 83 illustrates an exemplary top view of an engine cooling assembly in accordance with the present disclosure.

FIG. 84 illustrates an exemplary rear view of an engine cooling assembly in accordance with the present disclosure.

FIG. 84A provides a circuit diagram for a cooling fan controller.

FIG. 85 illustrates an exemplary front view of an engine cooling assembly in accordance with the present disclosure.

FIG. 86 illustrates an exemplary side view of an engine cooling assembly with extended cooling pipes in accordance with the present disclosure.

FIG. 87 illustrates an exemplary top view of an engine cooling assembly with extended cooling pipes in accordance with the present disclosure.

FIG. 88 illustrates an exemplary isometric view of an engine cooling assembly with extended cooling pipes in accordance with the present disclosure.

FIG. 88A-B illustrate a slightly modified cooling system adapted for an extended wheelbase vehicle.

FIGS. 89-90 illustrate exemplary isometric views of a frame and an engine cooling assembly in accordance with the present disclosure.

FIGS. 91-92 illustrate exemplary side views of a frame and an engine cooling assembly in accordance with the present disclosure.

FIG. 93 illustrates an exemplary front view of a frame and an engine cooling assembly in accordance with the present disclosure.

FIG. 94 illustrates an exemplary rear view of a frame and an engine cooling assembly in accordance with the present disclosure.

FIG. 95 illustrates an exemplary top view of a frame and an engine cooling assembly in accordance with the present disclosure.

FIGS. 96-97 illustrate exemplary isometric views of a frame and a heating, ventilation, and air conditioning (HVAC) assembly in accordance with the present disclosure.

FIG. 98 illustrates an exemplary top view of a frame and a HVAC assembly in accordance with the present disclosure.

FIG. 99 illustrates an exemplary front view of a frame and a HVAC assembly in accordance with the present disclosure.

FIG. 100 illustrates an exemplary side view of a frame and a HVAC assembly in accordance with the present disclosure.

FIG. 101 illustrates an exemplary rear view of an engine air intake assembly in accordance with the present disclosure.

FIGS. 102-103 illustrate exemplary side views of an engine air intake assembly of FIG. 101 in accordance with the present disclosure.

FIG. 104 illustrates an exemplary top view of an engine air intake assembly of FIG. 101 in accordance with the present disclosure.

FIG. 105 illustrates an exemplary bottom view of an engine air intake assembly of FIG. 101 in accordance with the present disclosure.

FIG. 106 illustrates an exemplary front view of an engine air intake assembly of FIG. 101 in accordance with the present disclosure.

FIGS. 107-109 illustrate exemplary isometric views of a frame without a rollover protection structure, an engine air intake assembly, and an exhaust assembly in accordance with the present disclosure.

FIG. 110 illustrates an exemplary front view of a frame without a rollover protection structure, an engine air intake assembly, and an exhaust assembly in accordance with the present disclosure.

FIGS. 111-113 illustrate exemplary isometric views of a frame, an engine air intake assembly, and an exhaust assembly in accordance with the present disclosure.

FIG. 114 illustrates an exemplary rear view of an engine air intake assembly in accordance with the present disclosure.

FIGS. 115-116 illustrate exemplary side views of an engine air intake assembly of FIG. 114 in accordance with the present disclosure.

FIG. 117 illustrates an exemplary front view of an engine air intake assembly of FIG. 114 in accordance with the present disclosure.

FIG. 117A illustrates an alternative air intake duct.

FIG. 118 illustrates an exemplary exploded view of a continuous variable transmission (CVT) housing in accordance with the present disclosure.

FIG. 119 illustrates an exemplary isometric view of a CVT housing in accordance with the present disclosure.

FIG. 120A illustrates an exemplary first side view of an inner CVT cover in accordance with the present disclosure.

FIG. 120B illustrates an exemplary cross-sectional view of an inner CVT cover along line A-A in accordance with the present disclosure.

FIGS. 120C-D illustrate a CVT housing with an exit recess.

FIG. 121A illustrates an exemplary first side view of a CVT housing in accordance with the present disclosure.

FIG. 121B illustrates an exemplary cross-sectional view of a CVT housing along line A-A in accordance with the present disclosure.

FIG. 122 illustrates an exemplary isometric view of an inner CVT cover or housing with clutches in accordance with the present disclosure.

FIG. 123 illustrates an exemplary side elevational view of a CVT with an outer CVT cover or housing member removed in accordance with the present disclosure.

FIG. 124 illustrates an exemplary removable wall member and a flat plate in accordance with the present disclosure.

FIG. 125 illustrates an exemplary isometric view of a removable wall member and a flat plate in accordance with the present disclosure.

FIG. 126 illustrates an exemplary cross-sectional view of a removable wall member with a flat plate in accordance with the present disclosure.

FIGS. 127A-127D illustrate an exemplary method of installing a continuous variable transmission (CVT) housing in an off-road vehicle in accordance with the present disclosure.

FIG. 128 illustrates an exemplary isometric view of a continuous variable transmission (CVT) housing and an exhaust assembly in an off-road vehicle in accordance with the present disclosure.

FIG. 129 illustrates an exemplary top view of a continuous variable transmission (CVT) housing and an exhaust assembly in an off-road vehicle in accordance with the present disclosure.

FIG. 130 illustrates an exemplary isometric view of an engine assembly coupled with an exhaust assembly in an off-road vehicle in accordance with the present disclosure.

FIG. 131 illustrates an exemplary side view of an engine assembly coupled with an exhaust assembly in an off-road vehicle in accordance with the present disclosure.

FIG. 132 illustrates an exemplary top view of an engine assembly coupled with an exhaust assembly in an off-road vehicle in accordance with the present disclosure.

FIGS. 133-134 illustrate exemplary rear views of a continuous variable transmission (CVT) cooling assembly and an engine air intake assembly in accordance with the present disclosure.

FIGS. 135-137 illustrate exemplary side views of a continuous variable transmission (CVT) cooling assembly and an engine air intake assembly in accordance with the present disclosure.

FIGS. 138-139 illustrate exemplary front views of a continuous variable transmission (CVT) cooling assembly and an engine air intake assembly in accordance with the present disclosure.

FIGS. 140-141 illustrate exemplary isometric views of a continuous variable transmission (CVT) intake and exhaust duct member in accordance with the present disclosure.

FIG. 142 illustrates an exemplary rear view of a continuous variable transmission (CVT) intake and exhaust duct member in accordance with the present disclosure.

FIGS. 143-144 illustrate exemplary side views of a continuous variable transmission (CVT) intake and exhaust duct member in accordance with the present disclosure.

FIGS. 145-147 illustrate exemplary isometric views of a frame, a steering assembly, an engine cooling assembly, and a fuel tank of an off-road vehicle in accordance with the present disclosure.

FIG. 148A illustrates an exemplary side view of an off-road vehicle with a door assembly in accordance with the present disclosure.

FIG. 148B illustrates a cut-out view of a door latch assembly in accordance with the present disclosure.

FIG. 149 illustrates an exemplary side view of a door assembly of an off-road vehicle in accordance with the present disclosure.

FIGS. 150-151 illustrate exemplary first side views of a first door in accordance with the present disclosure.

FIG. 152 illustrates an exemplary first side view of a second door in accordance with the present disclosure.

FIGS. 153-154 illustrate exemplary second side views of a first door in accordance with the present disclosure.

FIG. 155 illustrates an exemplary second side view of a second door in accordance with the present disclosure.

FIG. 156 illustrates an exemplary rear view of a first door in accordance with the present disclosure.

FIG. 157 illustrates an exemplary rear view of a second door in accordance with the present disclosure.

FIG. 158 illustrates an exemplary front view of a first door in accordance with the present disclosure.

FIG. 159 illustrates an exemplary front view of a second door in accordance with the present disclosure.

FIGS. 160-161 illustrate an exploded view of a door assembly in accordance with the present disclosure.

FIGS. 162-166 illustrate a door latch assembly in accordance with the present disclosure.

FIGS. 167-168 illustrate a door panel with a striker plate in accordance with the present disclosure.

FIGS. 169A-178 illustrate one or more components of a door latch assembly in accordance with the present disclosure.

FIGS. 179-181 illustrate a dashboard assembly with a display interface mounted therein.

FIGS. 182-188 illustrate a center seat and center console assembly for an occupant compartment of a vehicle.

### DETAILED DESCRIPTION

The following description is of exemplary embodiments of the invention only, and is not intended to limit the scope, applicability, or configuration of the invention. Rather, the following description is intended to provide a convenient illustration for implementing various embodiments of the invention. As will become apparent, various changes may be made in the function and arrangement of the elements described in these embodiments without departing from the scope of the invention as set forth herein. It should be appreciated that the description herein may be adapted to be employed with alternatively configured devices having different shapes, components, attachment mechanisms, and the like and still fall within the scope of the present invention. Thus, the detailed description herein is presented for purposes of illustration only and not of limitation.

Reference in the specification to “one embodiment” or “an embodiment” is intended to indicate that a particular feature, structure, or characteristic described in connection with the embodiment is included in at least an embodiment of the invention. The appearances of the phrase “in one embodiment” or “an embodiment” in various places in the specification are not necessarily all referring to the same embodiment.

Embodiments of the present disclosure describe an off-road vehicle having different components such as a frame having a frame structure, an engine assembly, an exhaust assembly, an engine mount assembly for facilitating easy installation of the engine assembly, a suspension assembly, a plurality of wheels, a hitch assembly, and other associated components such as cooling assemblies, an engine air intake assembly, a continuous variable transmission (CVT) housing, a door assembly, a steering assembly, a fuel tank, body panels, etc. Embodiments of the present disclosure further describe a method of installing and removing the engine assembly. The term ‘engine assembly’ used throughout the disclosure relates to an engine and a transaxle assembly and/or transmission assembly of the off-road vehicle. In particular, the engine assembly, in accordance with the present disclosure, comprises an engine/a rear engine, a transaxle assembly and/or a continuous variable transmission (CVT) assembly, and associated parts known to a person skilled in the art. The engine assembly is configured to be coupled to the frame using the engine mount assembly. The exhaust assembly may comprise an exhaust muffler, an exhaust pipe, and a mounting arrangement. The suspension assembly may comprise a front suspension assembly and a rear suspension assembly. The hitch assembly may comprise a receiver hitch, and a corresponding supporting assembly The cooling assemblies may include an engine cooling assembly, a CVT cooling assembly, a vehicle cabin cooling assembly, and associated parts. Components described herein are not limited to off-road vehicles and may be utilized for different vehicles. For example, the frame structure and the engine mount assembly may be used in different models of on-road or off-road vehicles for quick and easy installation of the engine assembly. In addition, the frame structure and the engine mount assembly provide better distribution of load on the frame so as to provide better control of the vehicle while riding. Similarly, the exhaust assembly of the present disclosure may be used for better performance of the vehicle. In addition, placement of the exhaust assembly may provide less heat transfer to a passenger cabin thereby providing better experience while riding. The rear suspension assembly may be utilized in different vehicles to provide additional space to situate and easy install the engine assembly, exhaust assembly, and other components in a rear side of the vehicle. Also, the rear suspension assembly provides additional ground clearance for obstacles in an off-road environment, and stability to the vehicle. Further, the hitch assembly of the present disclosure provides better and secure attachment of an external load or a payload with the vehicle, thereby providing better control over movement of an extension carrying the external load.

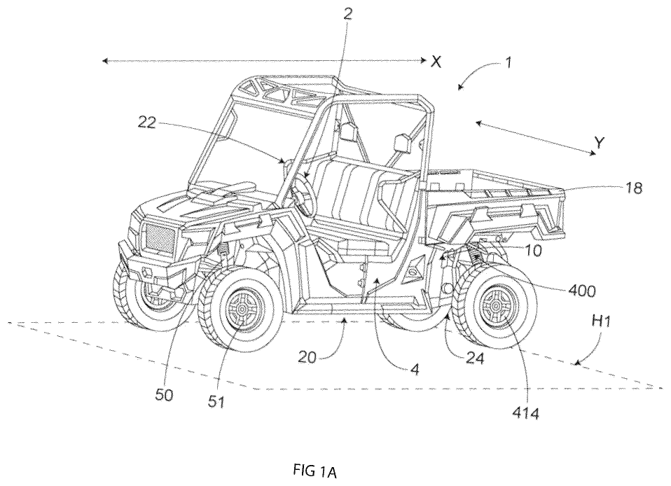

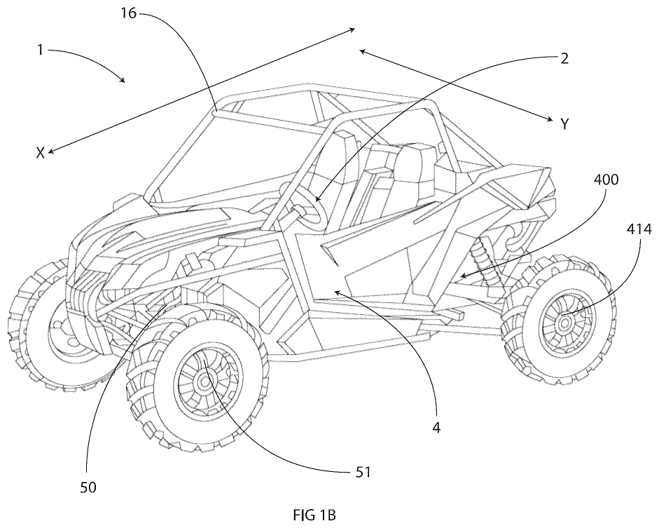

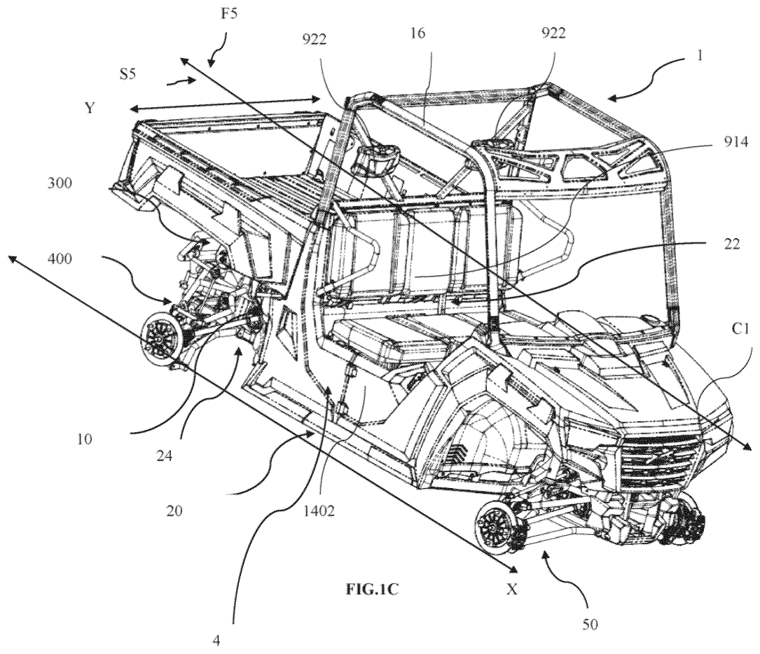

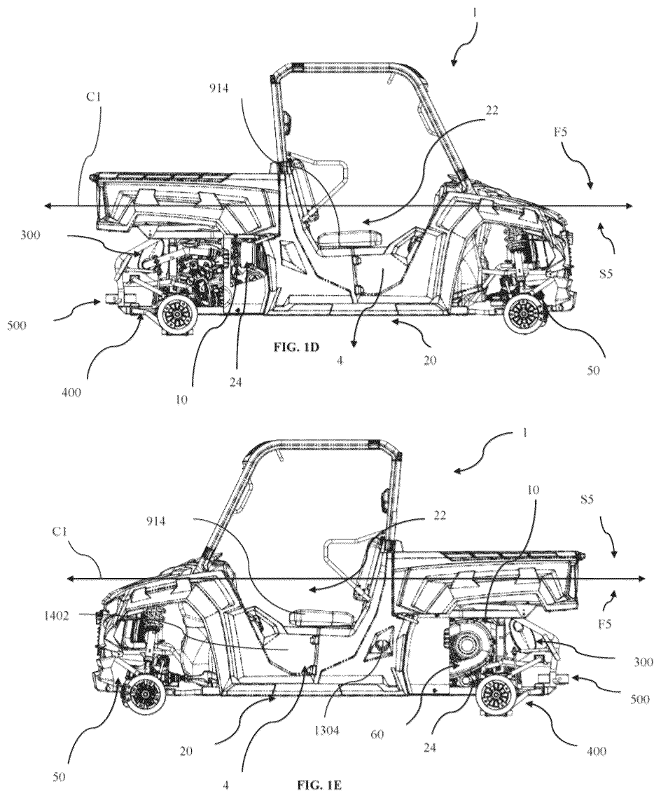

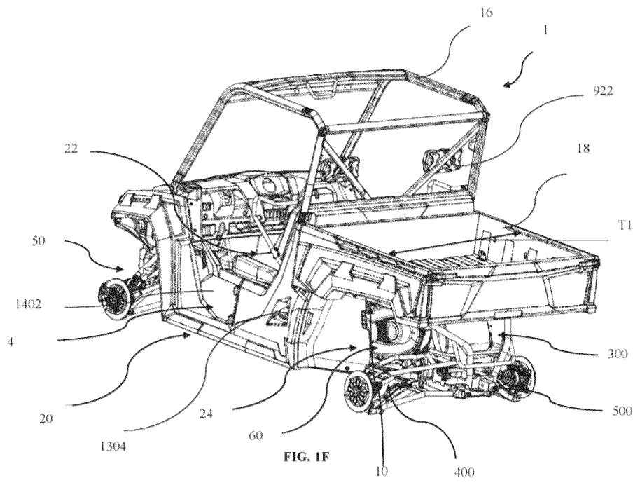

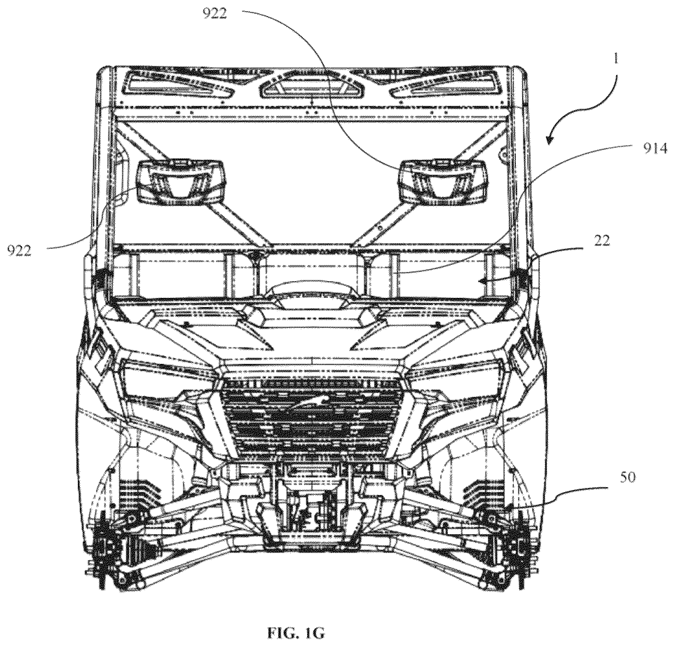

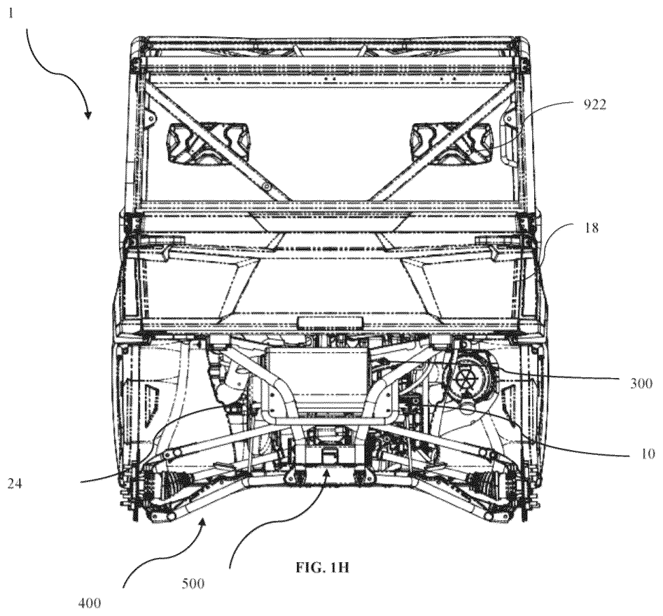

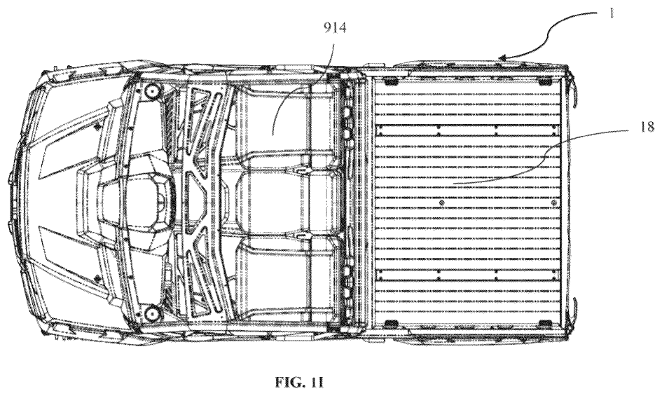

Reference is now made to FIGS. 1A-1I, which represent an off-road vehicle 1 according to some embodiments of the present disclosure. The vehicle 1 generally comprises a frame 20, an engine assembly 10, an exhaust assembly 300, a hitch assembly 500, and a suspension assembly. The frame 20 is configured to provide support to the engine assembly 10, the exhaust assembly 300, the hitch assembly 500, the suspension assembly (including a front suspension assembly 50 and a rear suspension assembly 400), and other components of the vehicle 1. The frame 20 is configured to be divided into two parts namely a front portion and a rear portion. The front portion of the frame 20 defines a seating area 22 (in the driver/passenger cabin). The seating area 22 of the vehicle 1 comprises a steering assembly 2 of the vehicle 1, corresponding components, and one or more seats 914 for providing seating to one or more riders. In some embodiments, the front portion of the frame 20 may secure front wheels 51 that are connected to the frame 20 by the front suspension assembly 50. The rear portion of the frame 20 defines an engine area 24. The engine area 24 is configured to receive the engine assembly 10 of the vehicle 1. In some variations, the vehicle 1 may comprise a passenger cabin at least partially above the engine area 24 for accommodating more riders therein. In some embodiments, the vehicle 1 may comprise a cargo box 18 above the engine area 24 to carry objects such as luggage. In some embodiments, the rear portion of the frame 20 may secure rear wheels 414 that are connected to the frame 20 by the rear suspension assembly 400. The

In some embodiments, the vehicle 1 extends in a longitudinal direction and a lateral direction. The longitudinal direction of the vehicle 1 is defined by a direction extending between a front of the seating area 22 to a back of the engine area 24 and is indicated by X in FIGS. 1A-1C. A lateral direction of the vehicle 1 is defined by a direction generally transverse to the longitudinal direction X and is indicated by Y. In other words, the vehicle 1 generally extends parallel to a horizontal plane H. The horizontal plane H extends substantially parallel to the ground and extends parallel to the longitudinal direction X and the lateral direction Y of the vehicle 1. Further, the vehicle 1 has a central axis C1 extending in the longitudinal direction X and passing through a center of the vehicle 1 (seen e.g., in FIGS. 1C-1E).

Referring to FIGS. 2A-2U, which illustrates the frame 20 that secures the engine assembly 10 in the rear portion of the frame 20, specifically in the engine area 24. The engine assembly 10 may preferably include an engine 12, a transaxle assembly 14, and a continuous variable transmission (CVT) assembly 60 (seen e.g., in FIGS. 2A-2D). The engine 12 is configured to extend from a first side (F5) to a second side (S5) of the central axis C1 of the vehicle 1. It is to be noted that the first side (F5) corresponds to a left side of the vehicle 1 when viewed from the rear portion of the vehicle 1. The second side (S5) corresponds to a right side of the vehicle 1 when viewed from the rear portion of the vehicle 1 (seen e.g., in FIGS. 2A-2B). FIG. 2E illustrates a rear view of the frame 20 securing the engine assembly 10 within the engine area 24. FIG. 2F illustrates a top view of the frame 20 securing the engine assembly 10 within the engine area 24. FIG. 2G illustrates a bottom view of the frame 20 securing the engine assembly 10 within the engine area 24. Further, FIGS. 2H-2N illustrate the frame 20, without a rollover protection structure (ROPS) 16 and a skid plate 6, securing the engine assembly 10 within the engine area 24. FIGS. 20-2U illustrate the frame 20 without other vehicle components in accordance with the present disclosure.

The engine assembly 10, preferably including the engine 12, the transaxle assembly 14, and the continuous variable transmission (CVT) assembly 60, may comprise a front part E1 and a rear part E2 (seen e.g., in FIG. 3). The engine assembly 10 is coupled with the frame 20 using an engine mount assembly. The engine mount assembly includes a front mount assembly 30 and a rear mount assembly 100. In particular, the front part E1 of the engine assembly 10, i.e., a front part of the engine 12, may be configured to be attached to the frame 20 using the front mount assembly 30. The rear part E2 of the engine assembly 10, i.e., a rear part of the transaxle assembly 14, may be configured to be attached to the frame 20 using the rear mount assembly 100.

With reference to FIG. 3, the front mount assembly 30 may comprise a front horizontal bar 26, a pair of front isolators 32, and one or more front brackets 34 (seen also in FIGS. 61, 65). The front horizontal bar 26 may be configured to be attached to the front part E1 of the engine assembly 10 using the one or more front brackets 34. The pair of front isolators 32 may be configured to be attached to sides of the front horizontal bar 26 for attachment of the front part E1 of the engine assembly 10 with the frame 20. Such attachment of the front part E1 of the engine assembly 10 provides secure attachment of the engine assembly 10 to the frame 20 such that a movement of the front part E1 of the engine assembly 10 in the longitudinal direction X and the lateral direction Y is completely restricted, other than by some flex of the frame members and slight movement within the isolators. In some embodiments, the one or more front brackets 34 includes a lower bracket portion 34A, a central bracket portion 34B, an upper bracket portion 34C. The lower bracket portion 34A is configured to be attached to the front horizontal bar 26. The central bracket portion 34B is configured to be attached to the front part E1 of the engine assembly 10. The upper bracket portion 34C is configured to provide support to an air intake manifold 38. In some embodiments, the front mount assembly 30 is attached to the frame 20 using a pair of front isolator supports 146 (seen e.g., in FIGS. 12A-12B).

The rear mount assembly 100 may comprise a rear mount bracket 102 (seen e.g., in FIGS. 4, 5, 5A, 63). The rear mount bracket 102 may be configured to be connected to the rear part E2 of the engine assembly 10. In an embodiment, a shape of the rear mount bracket 102 is designed so as to secure the rear part E2 of the engine assembly 10. The rear mount bracket 102 may be defined by a rear central portion 104 having a first side edge 116, a second side edge 118, and a supporting flange 120 extending upwardly from each of the first side edge 116 and the second side edge 118. Accordingly, the rear mount bracket 102 may comprise a first supporting flange at the first side edge 116 and a second supporting flange at the second side edge 118, and the rear central portion 104 collectively comprises a pair of supporting flanges. In some embodiments, an angle of the supporting flange 120 with respect to the rear central portion 104 may be a right angle. In other embodiments, the angle of the supporting flange 120 may be an acute angle or an obtuse angle with respect to the rear central portion 104. In other words, the supporting flanges 120 may be angled corresponding to a shape of the rear part E2 of the engine assembly 10. In an embodiment, the rear central portion 104 may have a rectangular shape. In another embodiment, the rear central portion 104 may be of a square shape.

For accommodating/receiving the rear part E2 of the engine assembly 10, the supporting flange 120 may comprise at least one first hole (not seen) to receive at least one first fastener 124 (seen e.g., in FIGS. 4, 63). In some embodiments, the rear part E2 of the engine assembly 10 may comprise one or more holes to receive the respective one or more first fasteners 124 for attachment with the rear mount bracket 102. Accordingly, the first fastener 124 may be configured to attach the rear mount bracket 102 with the engine assembly 10 by inserting the first fastener 124 through the first holes of the first supporting flange 120 to the second supporting flange 120. In a preferred embodiment, each supporting flange 120 comprises two first holes to receive two first fasteners 124. The one or more first fasteners 124 may be positioned in the lateral direction Y of the vehicle 1 when the rear mount bracket 102 is attached to the engine assembly 10.

The rear central portion 104 may further include an upper surface 106 and a lower surface 108 (seen e.g., in FIG. 4). The upper surface 106 may be gusseted with an elevated triangular section 114 extending therefrom towards each supporting flange 120. In other words, the upper surface 106 may comprise two elevated triangular sections 114 extending therefrom, one extending towards the first supporting flange 120 and another extending towards the second supporting flange 120. The elevated triangular sections 114 may be configured to provide a lateral strength to the rear bracket mount 102 to receive the rear part E2 of the engine assembly 10 therewithin. In some embodiments, the elevated triangular sections 114 may be stamped on the rear bracket mount 102 at the time of manufacturing. In such embodiments, a corresponding portion of the lower surface 108 may form a corresponding first cavity C2 (seen e.g., in FIG. 15B). The rear central portion 104 may further comprise at least one second hole 110 extending from the upper surface 106 to the lower surface 108 (seen e.g., in FIG. 4). The at least one second hole 110 may be configured to receive corresponding at least one second fastener 112 (seen e.g., in FIG. 5A).

The rear mount assembly 100 may further comprise a rear transverse bar 126 (seen e.g., in FIGS. 4, 5, 5A, 63). The rear transverse bar 126 may be defined by a first end 128, a second end 130, and a rear central part 132 therebetween. The rear central part 132 may be defined by a first top surface 134. The rear transverse bar 126 may comprise one or more holes corresponding to the at least one second hole 110 of the rear central portion 104 of the rear mount bracket 102. The one or more holes of the rear central part 132 may be configured to receive the at least one second fastener 112 when the rear mount bracket 102 is attached to the rear transverse bar 126. In an embodiment, when attached, the first top surface 134 of the rear central part 132 of the rear transverse bar 126 is configured to abut the lower surface 108 of the rear central portion 104 of the rear mount bracket 102. The rear transverse bar 126 may be configured to be oriented in the lateral direction Y of vehicle 1 when attached. In an exemplary embodiment, the rear transverse bar 126 may have a rectangular cross-section.

The rear mount assembly 100 may further comprise a pair of rear isolators 138 (seen e.g., in FIGS. 4-5). The isolators 138 may be standard in the art for damping the connection between components (here between the engine-transmission assembly and the frame 20 or chassis) with the use of elastomers such as rubber. The pair of rear isolators 138 may be configured to be attached to the rear transverse bar 126. In an embodiment, a first rear isolator 140 may be attached to the first end 128 of the rear transverse bar 126 and a second rear isolator 142 may be attached to the second end 130 of the rear transverse bar 126. The pair of rear isolators 138 may be attached to the rear transverse bar 126 using one or more rear fasteners. The attachment of the rear part E2 of the engine assembly 10 (seen e.g., in FIG. 3) with the rear mount assembly 100 (seen e.g., in FIG. 4) ensures secure connection of the rear part E2 of the engine 12 to the frame 20 so as to restrict movement of the engine assembly 10 while the vehicle 1 is in operation. Such a secure attachment that includes an isolating damping member reduces noise, vibration, and harshness (NVH) in the vehicle 1, thereby providing a smooth riding experience. In the preferred embodiment, the engine 12 and the transaxle assembly 14 and/or transmission assembly 60 are isolated together from the vehicle chassis or frame 20. Thus, the engine 12, transaxle 14 assembly, and CVT assembly 60 moves together (also preferably with the exhaust assembly 300) to reduce the complications and losses from individual isolation, while reducing the vibrations from the engine assembly 10 to the frame 20, driver, and any passengers. The vehicle 1 is thus more in control and more comfortable.

In some embodiments, the frame 20 includes a pair of straddling rear frame brackets 260 for providing support to the pair of rear isolators 138, a rear upper A-arm 402 and a rear damping member 406 (seen e.g., in FIGS. 2A, 2P, 2T-2U). The pair of straddling rear frame brackets 260 may be symmetrical brackets. The pair of straddling rear frame brackets 260 may comprise a first straddling rear frame bracket 260A and a second straddling rear frame bracket 260B. Each of the pair of straddling rear frame brackets 260 comprises a rear isolator support bracket 139, at least one rear upper A-arm mounting bracket 416, and a damper mounting bracket 144 (seen e.g., in FIG. 5C). Accordingly, each of the pair of straddling rear frame brackets 260 mounts the rear isolators 138, at least one rear upper A-arm and a rear damping member to the frame 20. The pair of rear isolators 138 may be attached to the frame 20 using the rear isolator support bracket 139. In some embodiment, the rear isolator support bracket 139 comprises a first rear isolator support bracket 139A and a second rear isolator support bracket 139B. The first rear isolator 140 may be attached to the frame 20 using the first rear isolator support bracket 139A (seen e.g., in FIG. 2B). The second rear isolator support 142 may be attached to the frame 20 using the second rear isolator support bracket 139B (seen e.g., in FIG. 2A). One or more fasteners may be used to secure the pair of rear isolators 138 to the rear isolator support bracket 139.

The rear isolators 138, when attached, are positioned so as to be in parallel with each other and with the pair of front isolators 32. In other words, each of the pair of rear isolators 138 and the pair of front isolators 32 is positioned in a same configuration. Particularly, a front central axis F1 passing through centers of the pair of front isolators 32 is parallel to a rear central axis R1 passing through centers of the pair of rear isolators 138 (seen e.g., in FIG. 3). More particularly, as the pair of rear isolators 138 are positioned parallel to each other, the centers of the pair of rear isolators 138 lie on a same central axis, defining the rear central axis R1. Such positioning of the pair of rear isolators 138 results in a less space required at the rear part E2 of the engine assembly 10 for attachment, thereby reducing an overall space envelope required when the engine assembly 10 is installed in the engine area 24. Further, the reduced space envelope may facilitate more space for other parts of the vehicle 1, for instance, a larger engine assembly 10 or a better suspension assembly. In some embodiments, the rear isolators 138 and the front isolators 32 are positioned such that enabling mounting or shifting of the engine 12 to the right side of the vehicle 1, thereby providing more room for aligning the continuous variable transmission (CVT) assembly 60 on the left side of the vehicle 1.

The present disclosure further sets forth a frame structure portion F of a frame 20 of an off-road vehicle 1 (seen e.g., in FIG. 6). The frame structure portion F may be defined by a front frame structure 200, a first side structure S1, and a second side structure S2. The first side structure S1, and the second side structure S2 may be upper side structures. In some embodiments, the frame structure portion F may also comprise a rear frame structure 80, a third side structure S3, a fourth side structure S4, and a fifth side structure S6 (seen e.g., in FIGS. 2P, 2Q. 2R, 2T). The third side structure S3, and the fourth side structure S4 may be lower side structures. The fifth side structure S6 may be an intermediate side structure. In some embodiments, the front frame structure 200 may be configured to facilitate installation of the engine assembly 10 within the engine area 24. The front frame structure 200 may comprise a first side portion 202 defining a first side of the front frame structure 200 and a second side portion 206 defining a second side of the front frame structure 200. The first side portion 202 and the second side portion 206 may be configured to be attached to any one of the first side structure S1 and the second side structure S2. For instance, in an exemplary embodiment, the first side portion 202 may be attached to the first side structure S1 and the second side portion 206 may be attached to the second side structure S2. The first side portion 202 and the second side portion 206 may be attached with the first side structure S1 and the second side structure S2, respectively, using one or more fastening mechanism or may be welded together for attachment.

In some embodiments, the front frame structure 200 may further comprise a front central portion 210 (seen e.g., in FIGS. 7, 9-10). The front central portion 210 may be removably attached to the first side portion 202 and the second side portion 206. In an embodiment, the first side portion 202, the front central portion 210, and the second side portion 206 may be attached in a sequential manner. Particularly, the front central portion 210 comprises a first proximal end 222 configured to be attached to the first side portion 202 and a first distal end 224 configured to be attached to the second side portion 206 (seen e.g., in FIG. 9). More particularly, the first proximal end 222 of the front central portion 210 may be received within a first bracket 204 of the first side portion 202 and the first distal end 224 of the front central portion 210 may be received within a second bracket 208 of the second side portion 206 (seen e.g., in FIGS. 8-9). The front central portion 210 may be attached to the first side portion 202 and the second side portion 206 using at least one fourth fastener 226. Such arrangement makes the front central portion 210 easily removable from the frame 20, which facilitates easy installation of the engine assembly 10 in the engine area 24. Further, the front central portion 210 may be easily attached to the frame 20 after installation of the engine assembly 10. Thereby, making the attachment of the front central portion 210 quick and easy.

The front central portion 210 may comprise a first member 212, a second member 214, and a first cross member 216 attached therebetween (seen e.g., in FIG. 7). The first member 212 may be attached to the first side portion 202 and the second member 214 may be attached to the second side portion 206. Particularly, the first member 212 may be received within the first bracket 204 of the first side portion 202 and the second member 214 may be received within the second bracket 208 of the second side portion 206.

In some embodiments, the first cross member 216 may be defined by a first member end 218 configured to be attached to the first member 212 and a second member end 220 configured to be attached to the second member 214 (seen e.g., in FIG. 7). In some embodiments, the first cross member 216 may be attached to the first member 212 and the second member 214 by welding. In other embodiments, the first cross member 216 may be attached to the first member 212 and the second member 214 by other fastening mechanism, such as by one or more fasteners, a snap fit mechanism, or the like.

In an embodiment, the front frame structure 200 may be attached to the first side portion 202 and the second side portion 206 after installation of the engine assembly 10 in the engine area 24. In a preferred embodiment, the front frame structure 200 may be positioned at least partially forward of the installed engine assembly 10 (seen e.g., in FIG. 5). In other words, the front frame structure 200 may be positioned at least partially in front of the installed engine assembly 10 when viewed from the front portion of the frame 20. The front frame structure 200 may further be positioned in the lateral direction Y of the vehicle 1 when attached in the first side portion 202 and the second side portion 206. Such arrangement ensures an additional space at a top part of the engine assembly 10, thereby providing simple arrangement/placement of the engine assembly 10 with respect to the frame 20. In an embodiment, the front frame structure 200 may be made of a metal, specifically steel, and may have a rectangular cross-section.

The front central portion 210 may comprise a front surface and a back surface (seen e.g., in FIGS. 9-10). In an embodiment, the front surface may be configured to attach a seat frame 230 therewith. The front surface may be attached with the seat frame 230 using one or more fifth fasteners 232. In a preferred embodiment, the seat frame 230 may be attached with the front surface using four fifth fasteners 232.

The present disclosure further relates to a method of installing an engine assembly 10 in an off-road vehicle 1. It is to be noted that the term ‘engine assembly 10’ relates to an engine 12 and a transaxle assembly 14 and/or transmission assembly 60 of the off-road vehicle 1. The engine assembly 10 may comprise a front part E1 and a rear part E2. In a preferred embodiment, a front part of the engine 12 constitutes the front part E1 of the engine assembly 10 and a rear part of a transaxle assembly 14 constitutes the rear part E2 of the engine assembly 10. The engine assembly 10 may be configured to be attached to a frame 20 using a front mount assembly 30 at the front part E1 and a rear mount assembly 100 at the rear part E2. The front mount assembly 30 may comprise a front horizontal bar 26 and a pair of front isolators 32.

The rear mount assembly 100 may comprise a rear mount bracket 102, a rear transverse bar 126, and a pair of rear isolators 138. The rear mount bracket 102 may comprise a rear central portion 104 having a first side edge 116, a second side edge 118, a supporting flange 120 extending upwardly from each of the first side edge 116, and the second side edge 118, an upper surface 106, a lower surface 108, and at least one first hole configured to receive at least one first fastener 124. The rear transverse bar 126 may comprise a first top surface 134, at least one hole corresponding to the second hole 110 and is configured to receive at least one second fastener 112.

In an embodiment, the pair of front isolators 32 and the pair of rear isolators 138 may be positioned in parallel to each other. In other words, each isolator of the pair of front isolators 32 and the pair of rear isolators 138 may be configured to be positioned in a same orientation such that a center of each isolator may lie on an axis parallel to the longitudinal axis of the vehicle 1.

The vehicle 1 may be configured to extend in a longitudinal direction X. It is further to be noted that the off-road vehicle 1 may be a side-by-side vehicle 1 as described hereinabove, and all the features of the vehicle 1 as described hereinabove are included in the method of installing the engine assembly 10. Accordingly, the vehicle 1 comprises a frame 20 defining a seating area 22 and an engine area 24, and may comprise a front frame structure 200, a first side structure S1, and a second side structure S2. The front frame structure 200 may comprise a first side portion 202, a second side portion 206, and a removable front central portion 210 configured to be attached therebetween. According to a preferred embodiment, the frame 20 facilitates the installation of the engine assembly 10 either from the seating area 22 to the engine area 24 or directly to the engine area 24.

The method of installing the engine assembly 10 in the engine area 24 comprises the step of attaching the rear part E2 of the engine assembly 10, more specifically a rear part of the transaxle assembly 14, with the rear mount bracket 102 and the rear transverse bar 126 with the pair of rear isolators 138. It is to be noted that the step of attaching the rear part E2 of the engine 12 and the rear transverse bar 126 may be performed together or sequentially in any order without departing from the scope of the present disclosure. The engine assembly 10 is then received in the engine area 24. In an embodiment, the engine assembly 10 may be directly received in the engine area 24 (seen e.g., in FIG. 11A). In such embodiment, the engine assembly 10 may be attached to the rear mount assembly 100 and the front mount assembly 30 after receiving the engine assembly 10 in the engine area 24. In another embodiment, the engine assembly 10 may be received in the seating area 22 and may be guided to the engine area 24 (seen e.g., in FIG. 11B). In such embodiment, the method further includes the step of guiding the engine assembly 10, attached with the rear mount bracket 102, towards the rear transverse bar 126, attached to the pair of rear isolators 138. The rear transverse bar 126 may be attached with the pair of rear isolators 138 using at least one third fastener. In an embodiment, the engine assembly 10, with the rear mount bracket 102 attached to the rear part E2 thereof, may be moved towards the rear transverse bar 126 at least at an angle. As the rear mount bracket 102 and the rear transverse bar 126 are already attached with the rear part E2 of the engine assembly 10 and the pair of rear isolators 138, respectively, the installation of the engine assembly 10 requires the step of fastening of the at least one second fastener 112 for securement between the rear mount bracket 102 and the rear transverse bar 126. The rear mount bracket 102 is attached with the rear transverse bar 126 using the at least second fastener 112, such that the lower surface 108 of the rear central portion 104 of the rear mount bracket 102 abuts the first top surface 134 of the rear transverse bar 126, thereby making installation of the engine assembly 10 easy and quick. Once the rear mount bracket 102 is attached with the rear transverse bar 126, the removable front central portion 210 is attached to the first side portion 202 and the second side portion 206. FIG. 11C illustrates the engine assembly 10 installed in the engine area 24 in accordance with any of the embodiments discussed above. The removable front central portion 210 is configured to be positioned in a lateral direction Y of the vehicle 1, transverse to the longitudinal direction X. In such position, the removable front central portion 210 is at least partially forward of the installed engine assembly 10.

After installation of the engine assembly 10 in the engine area 24 and the attachment of the removable front central portion 210 to the front frame structure 200, a seat frame 230 is attached to the removable front central portion 210. In an embodiment, the seat frame 230 is attached to a front surface of the front central portion 210. The seat frame 230 may be attached to the removable front central portion 210 using at least one fifth fastener 232.

FIGS. 12A-12D illustrate exemplary methods of removing (or, in the reverse, installing) the engine assembly 10 from the engine area 24 of the vehicle 1. After removing the front central portion 210 of the front frame structure 200, the engine assembly 10, preferably including the engine 12, the transaxle assembly 14, and the continuous variable transmission (CVT) assembly 60, is moved forwardly from the engine area 24 along with the rear mount bracket 102 attached therein. Thereafter, the engine assembly 10 is removed from the vehicle 1. In some embodiments, the engine assembly 10 is removed along with the exhaust assembly 300 which will be described in detail herein below with reference to FIGS. 16-24A.

FIGS. 13-15 illustrate different views of the installed engine assembly 10 in the engine area 24. More specifically, FIGS. 13A-13B illustrate exemplary views of the installed engine assembly 10 within the frame 20 of the off-road vehicle 1 from a first side view thereof. The first side may be considered as a rear passenger side view. FIGS. 14A-14B illustrate exemplary views of the installed engine assembly 10 within the frame 20 of the off-road vehicle 1 from a second side view thereof. The second side may be considered as a rear driver side view. FIGS. 15A-15B illustrate an exemplary top view and a bottom view, respectively, of the installed engine assembly 10 with the frame 20.

In an exemplary embodiment, the removable front central portion 210 may be configured to separate the engine area 24 with the seating area 22 after installation of the engine assembly 10.

In some embodiments, the rear frame structure 80 comprises a first frame transverse bar 250, 250′. In such embodiments, a first frame transverse bar 250 in the rear frame structure 80 may be elevated (seen e.g., in FIG. 11A) as compared to a frame transverse bar 250′ (seen e.g., in FIG. 11B). Such elevated frame transverse bar 250 provides better space envelope to the engine assembly 10 in the engine area 24. The rear frame structure 80 may also comprise a second frame transverse bar 252 that is extending between the third side structure S3 and the fourth side structure S4. The second frame transverse bar 252 is configured for providing support to rear lower A-arms and the hitch assembly 500 (seen e.g., in FIG. 2T). Each of the pair of straddling rear frame brackets 260 are configured to extend between the first frame transverse bar 250 and the third side structure S3 and the fourth side structure S4.

Reference is now made to FIGS. 16-24, which illustrate the exhaust assembly 300 in accordance with the present disclosure. The exhaust assembly 300 may include an exhaust muffler 302 and an exhaust pipe 330. The exhaust pipe 330 may be configured to be attached to an exhaust manifold 40 (seen e.g., in FIG. 16) at one end and to the exhaust muffler 302 at another end.

The exhaust manifold 40 may be coupled to the engine 12 of the vehicle 1. In an embodiment, the engine 12 may have an exhaust outlet at a rear part of the engine 12. In such embodiment, the exhaust manifold 40 may be coupled to the rear part of the engine 12. Accordingly, a length and a space required for the exhaust pipe 330 from the engine 12 to the exhaust muffler 302, in such embodiment, is less as compared to the conventional exhaust arrangement in which the exhaust manifold 40 is coupled at a front of the engine 12. In other words, the exhaust pipe 330 may be configured to extend between a rear side of the engine 12 and the exhaust muffler 302. In some embodiments, the exhaust manifold 40 may be angled with respect to the engine outlet for more efficient reception and directing of exhaust gases from the engine 12.

In some embodiments, the exhaust pipe 330 may comprise a first pipe 332 (seen e.g., in FIG. 16) and a second pipe 334 (seen e.g., in FIG. 17). A first pipe end of the first pipe 332 may be coupled with the exhaust manifold 40. In an embodiment, the first pipe 332 may be coupled with the exhaust manifold 40 using a coupler 42, for instance a V-band clamp. It is to be noted that other coupler known in the art may be used for coupling the first pipe 332 with the exhaust manifold 40. A second pipe end of the first pipe 332 may be configured to couple with the second pipe 334. The first pipe 332 may be coupled with the second pipe 334 using a coupling mechanism 340 (seen e.g., in FIG. 17). In some embodiments, the coupling mechanism 340 includes a first exhaust pipe flange 340A, a second exhaust pipe flange 340B, a first gasket 340C, and one or more fasteners 340D (seen e.g., in FIG. 24B). The first pipe 332 may be coupled with the second pipe 334 by fastening the first exhaust pipe flange 340A and the second exhaust pipe flange 340B using the one or more fasteners 340D. The first gasket 340C may be positioned between the first exhaust pipe flange 340A and the second exhaust pipe flange 340B. In some embodiments, the coupling mechanism 340 may be a ball and socket joint type coupling mechanism where a donut gasket may be used for providing tight sealing between the first pipe 332 and the second pipe 334. The first pipe 332 may have a pipe diameter. Optionally, the pipe diameter may be a common diameter conventionally used with a conventional exhaust manifold. The pipe diameter may be defined by an inner diameter and an outer diameter. In a preferred embodiment, an outer diameter of the first pipe 332 may be 41.1 mm.

An alternative coupling mechanism 340 is preferably used to accommodate slight movement or vibration between first pipe 332 and second pipe 334. In one embodiment, coupling mechanism 340 comprises a graphoil joint providing a spherical joint interface with a graphite ring in a socket with a flat flange biased towards the socket with springs. See FIG. 24K. Such coupling mechanism can be advantageous, for example, when the muffler is secured to the frame and the manifold is fixed to the engine. Although it can also be advantageous even in situations where the muffler is secured to a transaxle isolated with the engine relative to the frame/chassis.

In some embodiments, the first pipe 332 may comprise a first portion 342 (seen e.g., in FIG. 18) and a second portion 344 (seen e.g., in FIG. 17). The first pipe 332 of the exhaust pipe 330 may be positioned such that the at least the first portion 342 of the first pipe 332 is positioned at a first distance D1 from the transaxle assembly 14 in the lateral direction Y away from the transaxle assembly 14 (seen e.g., in FIGS. 18 and 22). In other words, the first pipe 332, and hence the exhaust pipe 330, is not positioned above the transaxle assembly 14. In fact, the first pipe 332 is positioned at a predefined distance from a constant velocity (CV) boot on a half shaft of the axle. Such positioning of the first pipe 332, and of the exhaust pipe 330, provides a clearance between the transaxle assembly 14 and the first pipe 332, thereby preventing transfer of heat generated due to high temperature of the first pipe 332 caused by a high temperature of the gas from the engine 12 to a nearby area, including the transaxle assembly 14, the CV boot half shaft of the axle, and in some cases, to a passenger cabin that may be placed there above. The first portion 342 of the first pipe 332 may further comprise an oxygen sensor 346 (seen e.g., in FIG. 17) to measure presence of oxygen in the gas coming from the engine 12. The second portion 344 of the first pipe 332 may be positioned partially underneath the exhaust muffler 302 (seen e.g., in FIG. 17) as explained hereinbelow.

The second pipe 334 of the exhaust pipe 330 may be coupled with the first pipe 332 using the coupling mechanism 340. In an embodiment, the second pipe 334 may be a single pipe. In another embodiment, the second pipe 334 may comprise a first part 336 and a second part 338 (seen e.g., in FIG. 19). The first part 336 may be coupled with the first pipe 332. Particularly, the first part 336 of the second pipe 334 may be coupled with the first pipe 332 using the coupling mechanism 340. In an embodiment, a diameter of the first part 336 is same as the diameter of the first pipe 332, i.e., the pipe diameter. In other words, the first part 336 may be configured to have the diameter equal to the pipe diameter.

In some embodiments, an elbow shape is formed between the first part 336 and the second part 338 of the second pipe 334. In an embodiment, the elbow shape may be hydroformed. In another embodiment, the elbow shape may be formed by stamping. In yet another embodiment, two symmetrical parts may be welded together to form the second pipe 334.

The second part 338 of the second pipe 334 may be configured to be coupled with the exhaust muffler 302. Particularly, the second part 338 of the second pipe 334 may be coupled at a first side surface or a second side surface of the exhaust muffler 302, as will be explained hereinbelow.

The exhaust muffler 302, in accordance with the present disclosure, may include a first side surface 304 (seen e.g., in FIGS. 17-18), a second side surface 306 (seen e.g., in FIGS. 16 and 18), and a curved surface 308 (seen e.g., in FIGS. 16-18) extending therebetween. In an embodiment, a cross-sectional shape of the exhaust muffler 302 is substantially elliptical. The exhaust muffler 302 is configured to be placed in the lateral direction Y of the vehicle 1 such that a length of the exhaust muffler 302 extends in the lateral direction Y. Each of the first side surface 304 and the second side surface 306 has an elliptical shape corresponding to the overall cross-sectional shape of the exhaust muffler 302. In some embodiments, each of the first side surface 304 and the second side surface 306 may comprise a major axis M1 and a minor axis M2 (seen e.g., in FIG. 16). In such embodiments, the exhaust muffler 302 is positioned such that the major axis M1 is at least at a slight angle with the horizontal plane H (seen e.g., in FIG. 16). In a preferred embodiment, such angle is an acute angle. Such arrangement facilitates positioning of the second portion 344 of the first pipe 332 below the exhaust muffler 302 (seen e.g., in FIG. 17). Alternatively, such angle may be right-angle. Such arrangement facilitates positioning of the at least partial second portion 344 of the first pipe 332 at a rear part of the exhaust muffler 302, when seen from a rear of the vehicle 1. The preferred angular position of the exhaust muffler 302 provides a favorable arrangement of the exhaust pipe 330 so as to facilitate better space distribution at a rear part of the engine area 24 in the vehicle 1.

In some embodiments, seen e.g., in FIGS. 19-20, the exhaust muffler 302 may include a catalytic tube 312, at least one perforated tube 314, and baffles 310 placed at a distance from each of the first side surface 304 and the second side surface 306. The catalytic tube 312 may be configured to have a first diameter and the at least one perforated tube 314 may have a second diameter. In an embodiment, the first diameter is greater than the second diameter. In a first embodiment, the catalytic tube 312 may be coupled directly with the first side surface 304 (seen e.g., in FIG. 19). For the same, the first side surface 304 may comprise a third hole 316. In such embodiment, the third hole 316 may have a diameter corresponding to the first diameter. In such embodiment, the baffles 310 near the first side surface 304 may have a hole corresponding to the first diameter of the catalytic tube 312 so as to pass the catalytic tube 312 therethrough. The catalytic tube 312 may have an inner diameter and an outer diameter. In a preferred embodiment, the catalytic tube 312 may have an inner diameter of 90 mm.

In the first embodiment, the second part 338 of the second pipe 334 may have a diameter corresponding to the first diameter of the catalytic tube 312. In a preferred embodiment, an inner diameter of the second part 338 of the second pipe 334 may be 90 mm. Such similar size of the inner diameters of the second part 338 and the catalytic tube 312 facilitates use of more surface of the catalytic tube 312 for purification of the gases from the engine 12.

It is to be noted that the second part 338 having the first diameter is connected to the first side surface 304 of the exhaust muffler 302 for exemplary purposes only. Alternatively, or optionally, the second part 338, and more particularly, the second pipe 334, may be coupled with the second side surface 306 of the exhaust muffler 302 (seen e.g., in FIGS. 21-22). In such embodiment, a length of the exhaust pipe 330 is significantly reduced. In such embodiment, a flex coupler may be used for connecting the exhaust manifold 40 with the first pipe 332 of the exhaust pipe 330. The need for a flex coupler depends on the relative movement of the joined pipes. Coupling the exhaust assembly 300 directly to the engine assembly 10 to be isolated therewith tends to reduce the need for a coupler that accommodates a lot of flex. Thus, the system can be simpler, more robust, and more cost-effective.

In an alternate embodiment, the exhaust muffler 302 may comprise a connecting tube 318 (seen e.g., in FIG. 20). The connecting tube 318 may be configured to connect the second pipe 334 to the catalytic tube 312 of the exhaust muffler 302. The connecting tube 318 may be configured to be placed between the first side surface 304 or the second side surface 306 and a corresponding baffle 310 placed near the first or the second side surfaces. The connecting tube 318 may comprise a second proximal end 320 configured to be coupled with the first side surface 304 or the second side surface 306. For the same, a diameter of the second proximal end 320 may correspond to the pipe diameter. In such embodiment, a diameter of the second part 338 of the second pipe 334 is equal to the pipe diameter. The connecting tube 318 may further comprise a second distal end 322 configured to be coupled with the corresponding baffle 310 near the first side surface 304 or the second side surface 306. For the same, a diameter of the second distal end 322 may correspond to the first diameter of the catalytic tube 312. The second pipe 334 of the exhaust pipe 330 may be configured to be connected to the first side surface 304 (seen e.g., in FIG. 19). It is to be noted that the second pipe 334 may also be connected to the second side surface 306 having a hole corresponding to a hole having a diameter corresponding to the first diameter of the catalytic tube 312 without departing from the scope of the present invention. The second pipe 334 of the exhaust pipe 330 may further be configured to be connected to second side surface 306 using the connecting tube 318 (seen e.g., in FIG. 20). It is to be noted that the second pipe 334 may also be connected to the first side surface 304 having the connecting tube 318 without departing from the scope of the present invention.

The exhaust muffler 302 may further comprise a tail pipe 350 (seen e.g., in FIGS. 19-20). The tail pipe 350 may be configured to emit the gas from the exhaust muffler 302 to the environment. The tail pipe 350 may be configured to be connected to the first side surface 304 or the second side surface 306 of the exhaust muffler 302 based on the connection of the second pipe 334 to the exhaust muffler 302. In other words, if the second pipe 334 is coupled with the first side surface 304, then the tail pipe 350 is preferably coupled with the second side surface 306, and vice versa.

The exhaust assembly 300 may further comprise a muffler mount 360 (seen e.g., in FIGS. 17, and 23-24). The muffler mount 360 may be coupled with the rear mount assembly 100. The muffler mount 360 may comprise a pair of muffler mount brackets 360A, 360B (seen e.g., in FIGS. 23-24). The pair of muffler mount brackets 360A, 360B may be coupled with the rear mount assembly 100 (seen e.g., in FIGS. 23-24). The securement of the pair of muffler mount brackets 360A, 360B with the rear mount assembly 100 ensures that the exhaust assembly 300 moves with the engine assembly 10 since it is on the engine assembly side of the isolation mounts. Hence, there is no requirement of providing additional coupling for attachment of the exhaust assembly 300 in the vehicle 1. Such feature facilitates reduced vibration at the time of driving the vehicle 1 because of absence of the additional coupling directly to the vehicle frame 20 required in coupling of the exhaust assembly 300. There is less relative movement of the exhaust assembly 300 relative to the engine assembly 10 from which it extends.

For attaching the exhaust assembly 300, each supporting flange 120 comprises at least one hole (not shown) at a free end thereof. The at least one hole at the free end may be used to couple the muffler mount brackets 360A, 360B therewith as explained hereinbelow.

Each of the pair of muffler mount brackets 360A, 360B may be defined by a head end 362 and a tail end 364 (seen e.g., in FIGS. 23-24). The head end 362 may be configured to be coupled to the exhaust muffler 302. The head end 362 may comprise a partial curve corresponding to at least a partial curve of the curved surface 308 of the exhaust muffler 302. In an embodiment, the head end 362 may be coupled to the exhaust muffler 302 by means of welding. The tail end 364 of each of the pair of muffler mount brackets 360A, 360B comprises at least one fourth hole 366 corresponding to the hole of the supporting flange 120 of the rear mount bracket 102 of the rear mount assembly 100. Each of the pair of muffler mount brackets 360 and the supporting flanges 120 may be coupled using at least one sixth fastener 368 (seen e.g., in FIGS. 23-24). It is to be noted that a thickness of the muffler mount brackets 360A. 360B may be more than a thickness of the exhaust muffler 302. In a preferred embodiment, the thickness of the muffler mount brackets 360A, 360B may be 1.2 mm, while the thickness of the exhaust muffler 302 may be 0.047 mm.

In some embodiments, the muffler mount 360 may comprise a pair of muffler mount brackets 360A, 360B and a connecting plate 360C that are integrally formed into a single piece (seen e.g., in FIGS. 24A-24J). Each of the pair of muffler mount brackets 360A, 360B may be defined by the head end 362, the tail end 364, and a first side end 380 and a second side end 382. The first side end 380 may comprise a curved section 380A and a linear section 380B (seen e.g., in FIGS. 24A-24B). The head end 362 of the each of the pair of muffler mount brackets 360A, 360B may be configured to be coupled to the exhaust muffler 302. The tail end 364 of each of the pair of muffler mount brackets 360A, 360B is coupled with the supporting flange 120 of the rear mount bracket 102 using the at least one sixth fastener 368. The connecting plate 360C may be configured to couple the pair of muffler mount brackets 360A, 360B, thereby distributing a load of the exhaust muffler 302 while mounting to the muffler mount 360. Preferably, the connecting plate 360C is configured to be attached to the linear section 380B of the first side end 380 of the each of the pair of muffler mount brackets 360A, 360B.

In some embodiments, the connecting plate 360C is configured to be attached with a supporting bracket 372 using one or more thirteenth fasteners 378 through one or more fifth holes 370 on the connecting plate 360C (seen e.g., in FIGS. 24A, 24C, 24E). The supporting bracket 372 is configured to provide support to a gas strut or a tilt shock 374 by coupling the gas strut or tilt shock 374 with the connecting plate 360C using one or more fasteners 376 (seen e.g., in FIG. 24C). The gas strut or tilt shock 374 is configured for resisting quick raising or lowering of a cargo box 18. The cargo box 18 is pivotably mounted to the frame 20 and is configured to pivot about a tilt axis (T1) (seen e.g., in FIG. 1F. The gas strut 374 is positioned such that a mounting axis M3 of the gas strut 374 is angled with the horizontal plane H. The mounting axis M3 is extending from one end 384 to another end 386 of the gas strut 374. In some embodiments, the mounting axis M3 may be parallel to the major axis M1 of the first side surface 304 and the second side surface 306 of the exhaust muffler 302. In some embodiments, the major axis M1 is positioned at an angle with the horizontal plane H such that the cargo box 18 pivots about the tilt axis (T1) to a maximum tilt angle without interfering with the exhaust muffler 302. In other words, the angle of the exhaust muffler 302 allows maximum tilting of the cargo box 18 and provides sufficient space between the exhaust muffler 302 and the cargo box 18 while tilting. The angle of the mounting axis M3 of the gas strut 374 is also determined by creating a beneficial mechanical advantage to the cargo box lifting and lowering. Thus, for example, when the cargo box 18 is lowered, the most force may be desired such that the mounting axis M3 might preferably be at a right angle to the cargo box 18.

It is to be noted that the exhaust muffler 302 in the present disclosure is isolated from the vehicle frame 20 and is mounted directly to the transaxle assembly 14 using a single rear mount assembly 100. Such configuration provides more flexibility and power and reduces stress on the exhaust pipe 330.

Reference is now made to FIGS. 25-33L, which illustrate the rear suspension assembly 400 in accordance with the present disclosure. The rear portion of the frame 20 facilitates coupling and support to the rear suspension assembly 400. The rear suspension assembly 400 comprises a pair of rear upper A-arms 402 and a pair of rear lower A-arms 404 (seen e.g., in FIGS. 25-29 and 33A-33F). In some embodiments, the pair of rear upper A-arms 402 and the pair of rear lower A-arms 404 are pivotably mounted to the frame 20 rearward of the transaxle assembly 14 to facilitate movement of the rear suspension assembly 400 to follow the surface of a trail or a road. Each of the pair of the rear upper A-arms 402 and the pair of the rear lower A-arms 404 are mounted to the frame 20 at a pair of rear pivot locations 432, 426, respectively that are positioned longitudinally rearward towards the rear side R1 of the vehicle 1 (seen in e.g., in FIGS. 28-29, 33L). The rear pivot locations 432, 426 may be referred as arm mount locations in other words. Such rearward and outboard configuration of the rear pivot locations in the frame 20 enables significant rearward positioning of the pair of the rear upper A-arms 402 and the pair of the rear lower A-arms 404, which, in turn, enables sufficient rearward positioning of the CVT assembly 60, the engine 12, and the transaxle assembly 14 without interfering with the rear suspension assembly 400. For example, such rearward configuration of the rear pivot locations 432, 426 enables to shift the engine 12 and the transaxle assembly 14 rearwardly about 2.5 inches. Such rear positioning of the CVT assembly 60, the engine 12, and the transaxle assembly 14 improves traction and acceleration of the rear wheels 414 by shifting the center of mass rearwardly. It also reduces diving of the front end of the vehicle 1 when going airborne. Such rear positioning further allows better fitting of the engine-transaxle assembly 14 in a smaller chassis while still providing ample rider passenger space in the cabin. Further, the pair of the rear pivot locations 432, 426 are positioned closer to a first CV joint 428A and a second CV joint 428B, respectively. In other words, the pair of the rear pivot locations 432, 426 are positioned closer to a corresponding CV joint vertically. Thus, a half shaft 410 is more aligned and/or less angled in the lateral direction Y, thereby reducing half-shaft plunge, which in turn reduces noise, vibration, and harshness (NVH) in the vehicle 1. In some embodiments, the respective rear upper and rear lower A-arms are equal in length.

The pair of the rear upper A-arms 402 may comprise a rear upper right A-arm 402A and a rear upper left A-arm 402B (seen e.g., in FIGS. 25-29 and 33A-33D). In some embodiments, the rear upper right A-arm 402A and the rear upper left A-arm 402B may be identical, such that the rear upper right A-arm 402A and the rear upper left A-arm 402B are interchangeable if either the rear upper right A-arm 402A or the rear upper left A-arm 402B is flipped. Each of the pair of the rear upper A-arms 402 comprises a rear upper forward member 434 and a rear upper rearward member 436 (seen e.g., in FIGS. 30, 33C). The rear upper forward member 434 of each of the pair of the rear upper A-arms 402 comprises a first section 438A extending from a first wheel mounting end 462, a second section 438B attached to the first section 438A at least at a first angle (α₁) and extending towards the rear side R1 of the vehicle 1, and a third section 438C attached to the second section 438B and extending towards the frame 20, thereby forming a curved rear upper forward member. Accordingly, the rear upper forward member 434 of each of the pair of the rear upper A-arms 402 is curved at an inboard end. In other words, each of the rear upper forward member 434 is curved or bend around the CVT assembly 60 and/or the transaxle assembly 14. The curved rear upper forward member of each of the pair of the rear upper A-arms 402 is configured to facilitate positioning of a rear damping member 406 rearward thereto, thereby providing an additional space and preventing conflict with the CVT assembly 60 and/or the transaxle assembly 14. Such configuration of the curved rear upper forward member clears or frees up space in the engine area 24 in a rearward direction, thereby enabling to accommodate and locate transmission components specifically a CVT housing or cover, the engine 12, and the transaxle assembly 14 rearward and avoids conflict with the CVT assembly 60, the engine 12, and the transaxle assembly 14. A length of each of the first section 438A, the second section 438B, and the third section 438C may be selected as per requirement. For instance, in some embodiments, a length of the first section 438A is larger than a length of the third section 438C, vice versa, while in other embodiments, the length of the first section 438A, second section 438B, and third section 438C are equal. The rear upper rearward member 436 of each of the pair of the rear upper A-arms 402 comprises a fourth section 440 that is extending from the first wheel mounting end 462 towards the frame 20 (seen e.g., in FIG. 30, 33C).

Each of the pair of the rear upper A-arms 402 are mounted to the frame 20 at a pair of rear upper pivot locations 432 using a pair of rear upper A-arm mounting brackets 416 (seen e.g., in FIGS. 27,29, 33L, 33K). Each of the pair of rear upper A-arm mounting brackets 416 comprises a rear upper forward member mounting bracket 416A and a rear upper rearward member mounting bracket 416B. In some embodiments, each of the pair of straddling rear frame brackets 260 includes the rear upper forward member mounting bracket 416A for mounting the rear upper forward member 434 to the frame 20. The rear upper rearward member mounting bracket 416B may be positioned in the fifth side structure S6 for mounting the rear upper rearward member 436 to the frame 20 (seen e.g., in FIG. 2U). In some embodiments, each of the pair of the rear upper A-arms 402 comprises upper collar members that constitute a first frame mounting end 464 to each of the pair of the rear upper A-arms 402 (seen e.g., in FIGS. 30 and 33D). The rear upper forward member 434 and the rear upper rearward member 436 of each of the pair of the rear upper A-arms 402 comprises a first upper collar member 442A and a second upper collar member 442B, respectively, for mounting to the frame 20 at a corresponding rear upper pivot location 432 using the pair of rear upper A-arm mounting brackets 416 (seen e.g., in FIGS. 27-28, 30, and 33D). In some embodiments, each of the pair of the rear upper A-arms 402 comprises rear upper wheel mounting brackets that constitute the first wheel mounting end 462 to the corresponding rear upper A-arm 402 (seen e.g., in FIGS. 30 and 33H). Each of the rear upper forward member 434 and the rear upper rearward member 436 of each of the pair of the rear upper A-arms 402 comprises a first upper wheel mounting bracket 444A and a second upper wheel mounting bracket 444B respectively for mounting to the rear wheels 414 via at least one seventh fastener (seen e.g., in FIGS. 30 and 33H). The first upper wheel mounting bracket 444A and the second upper wheel mounting bracket 444B may comprise at least one fifth hole and at least one sixth hole respectively for mounting to the rear wheels 414 via the at least one seventh fastener secured to the knuckle 470. The first upper wheel mounting bracket 444A and the second upper wheel mounting bracket 444B may be mounted to a pair of upper arms 472 of a knuckle 470 (seen e.g., in FIG. 33).

Each of the pair of the rear upper A-arms 402 may comprise at least two upper cross members extending between the rear upper forward member 434 and the rear upper rearward member 436, thereby providing an enclosed space 422 therewithin (seen e.g., in FIGS. 30, 33A). The rear damping member 406 (with or without a spring, such as a coil spring, over the damping member) is configured to pass through the enclosed space 422 when attached to a corresponding rear lower A-arm (seen e.g., in FIGS. 27, 33A). The upper cross members may comprise a first upper cross member 420A positioned towards the first wheel mounting end 462 and a second upper cross member 420B positioned towards the frame 20 (seen e.g., in FIGS. 30 and 33C). The first upper wheel mounting bracket 444A and the second upper wheel mounting bracket 444B are attached to the first upper cross member 420A (seen e.g., in FIG. 33H). The first upper cross member 420A and the second upper cross member 420B may be unequal in length.

FIGS. 31, 33A, 33I show that the first upper cross member 420A and the second upper cross member 420B are not parallel to each other. Optionally, the first upper cross member 420A and the second upper cross member 420B may be parallel to each other.

In some embodiments, each of the pair of the rear upper A-arms 402 comprises a pair of gussets 430 that is attached to the first wheel mounting end 462 to provide support thereto (seen e.g., in FIG. 20, 33H). The pair of gussets 430 may comprise a first gusset 430A and a second gusset 430B. The first gusset 430A is attached to the first upper cross member 420A at one end and to the rear upper forward member 434 at another end. The second gusset 430B is attached to the first upper cross member 420A at one end and attached to the rear upper rearward member 436 at another end (seen e.g., in FIGS. 30 and 33H).

The pair of the rear lower A-arms 404 may comprise a rear lower right A-arm 404A and a rear lower left A-arm 404B (seen e.g., in FIGS. 25-28, 33A, 33E, 33F). In some embodiments, the rear lower right A-arm 404A and the rear lower left A-arm 404B may be identical, such that the rear lower right A-arm 404A and rear lower left A-arm 404B are interchangeable. Optionally, the rear lower right A-arm 404A and the rear lower left A-arm 404B may be non-identical. Each of the pair of the rear lower A-arms 404 comprises a rear lower forward member 446 and a rear lower rearward member 478 (seen e.g., in FIG. 30). In some embodiments, each of the pair of the rear lower A-arms 404 comprises a rear lower forward member 446, a rear central member 488, and a rear lower rearward member 478 (seen e.g., in FIGS. 33E-33F). The rear lower forward member 446 and the rear lower rearward member 478 of each of the pair of the rear lower A-arms 404 comprises a fifth section 448A extending from a second wheel mounting end 466, and a sixth section 448B attached to the fifth section 448A at least at a second angle (α₂) and extending towards the frame 20 (seen e.g., in FIG. 30). A length of the fifth section 448A and the sixth section 448B may be selected as per requirement. For instance, in some embodiments, a length of the fifth section 448A is larger than a length of the sixth section 448B, vice versa. In some embodiments, the length of the fifth section 448A is equal to the length of the sixth section 448B. In a rear view of the vehicle 1, the fifth section 448A of each rear lower rearward member 478 is inclined upwards from the second wheel mounting end 466 and the sixth section 448B of each rear lower rearward member 478 is linearly extended towards the frame 20 in a lateral direction Y (seen e.g., in FIGS. 25-26). Such configuration of the rear lower rearward member 478 increases ground clearance of the vehicle 1. In some embodiments, the rear central member 488 of each of the pair of the rear lower A-arms 404 comprises a seventh section 448C that is extending longitudinally from the second wheel mounting end 466 in a lateral direction Y. The rear lower rearward member 478 of each of the pair of the rear lower A-arms 404 comprises an eighth section 448D that is attached to the rear central member 488 at one end and extending towards the frame 20 (seen e.g., in FIG. 33E). The eighth section 448D of the rear lower rearward member 478 is inclined upwards from the rear central member 488. A length of the seventh section 448C and the eighth section 448D may be selected as per requirement.

Each of the pair of the rear lower A-arms 404 are mounted to the frame 20 at a pair of rear lower pivot locations 426 using a pair of rear lower A-arm mounting brackets 418 (seen in e.g., in FIGS. 27-28, 33L). Each of the pair of rear lower A-arm mounting brackets 418 includes a rear lower forward member mounting bracket 418A and a rear lower rearward member mounting bracket 418B. In some embodiments, the pair of rear lower A-arm mounting brackets 418 are positioned in the third side structure S3 and the fourth side structure S4 (seen e.g., in FIGS. 2R, 2U). Each of the pair of the rear lower A-arms 404 comprises lower collar members that constitute a second frame mounting end 468 to each of the pair of the rear lower A-arms 404. The rear lower forward member 446 and the rear lower rearward member 478 of each of the pair of the rear lower A-arms 404 comprises a first lower collar member 450A and a second lower collar member 450B, respectively, for mounting to the frame 20 at a corresponding rear lower pivot location 426 using the pair of rear lower A-arm mounting brackets 418 (seen e.g., in FIGS. 30 and 33E). Each of the pair of the rear lower A-arms 404 comprises rear lower wheel mounting brackets 452 that constitute the second wheel mounting end 466 to the corresponding rear lower A-arm 404 (seen e.g., in FIGS. 28, 30, 33E, 33H). Each of the rear lower forward member 446 and the rear lower rearward member 478 of each of the pair of the rear lower A-arms 404 comprises a first lower wheel mounting bracket 452A and a second lower wheel mounting bracket 452B that is connected by a central plate 452C for mounting to the rear wheels 414 via at least one eighth fastener (seen e.g., in FIG. 30). The first lower wheel mounting bracket 452A and the second lower wheel mounting bracket 452B may comprise at least one seventh hole and at least one eighth hole respectively for mounting to the rear wheels 414 via the at least one eighth fastener secured to the knuckle 470. The first lower wheel mounting bracket 452A and a second lower wheel mounting bracket 452B may be mounted to a pair of lower arms 474 of the knuckle 470 (seen e.g., in FIG. 33).

Each of the pair of the rear lower A-arms 404 may comprise at least two lower cross members 424A, 424B, and 424C extending between the rear lower rearward member 478 and the rear lower forward member 446 (seen e.g., in FIGS. 28, 30). In some embodiments, the at least two lower cross members 424A, and 424C extending between the rear lower forward member 446 and the rear central member 488 (seen e.g., in FIGS. 33E, 33J). The lower cross members 424A, 424B, and 424C may be parallel to each other. The lower cross members 424A, 424B, and 424C may be unparallel to each other. The lower cross members may comprise a first lower cross member 424A, a second lower cross member 424B, and a third lower cross member 424C (seen e.g., in FIGS. 28, 30, 33E, 33J). The lower cross members 424A, 424B, and 424C extend between the rear lower rearward member 478 and the rear lower forward member 446. Optionally, the third lower cross member 424C may extend between the rear lower forward member 446 and the rear central member 488 (seen e.g., in FIGS. 33E, 33J) while the first lower cross member 424A extends between the rear lower rearward member 478 and the rear lower forward member 446. The rear central member 488 extends between the first lower cross member 424A and the third lower cross member 424C. In some embodiments, the first lower cross member 424A is positioned towards the second frame mounting end 468. The third lower cross member 424C is positioned towards the second wheel mounting end 466. The second lower cross member 424B is positioned in between the first lower cross member 424A and the third lower cross member 424C. The first lower wheel mounting bracket 452A, the second lower wheel mounting bracket 452B, and the central plate 452C are attached to the third lower cross member 424C (seen e.g., in FIG. 30). The first lower cross member 424A, the second lower cross member 424B, and the third lower cross member 424C may have unequal lengths.

Each of the pair of the rear lower A-arms 404 may further comprise a pair of mounting interfaces 408 placed between the at least two lower cross members 424A, 424B, and 424C. The pair of mounting interfaces 408 may be extending from the first lower cross member 424A to the third lower cross member 424C (seen e.g., in FIGS. 30, 33H, 33I). In some embodiments, the pair of mounting interfaces 408 may extend from the rear lower rearward member 478 outboard to the rear lower forward member 446. The pair of mounting interfaces 408 may be extending from an outboard end of the first lower cross member 424A to the third lower cross member 424C diagonally. The pair of mounting interfaces 408 comprises a first mounting interface 408A and a second mounting interface 408B (seen e.g., in FIG. 30). The pair of mounting interfaces 408 are preferably parallel to each other such that the first mounting interface 408A is parallel to the second mounting interface 408B.

In some embodiments, each of the pair of mounting interfaces 408 comprises a first edge 454A, a second edge 454B, and a mounting plate 454C extending upwardly from the first edge 454A to the second edge 454B (seen e.g., in FIG. 30). The mounting plate 454C may have a triangular shape. Alternatively, the mounting plate 454C may have any other suitable shape, such as, a rectangular shape. The mounting plate 454C of each of the pair of mounting interfaces 408 comprises an inner surface 460A and an outer surface 460B. The inner surfaces 460A of mounting plate 454C of each of the pair of mounting interfaces 408 face each other when the pair of mounting interfaces 408 are secured on the at least two lower cross members 424A and 424C. The rear damping member 406 is mounted to the pair of mounting interfaces 408.

The mounting plate 454C of each mounting interface 408 comprises at least one ninth hole 456 for mounting the rear damping member 406 with each of the pair of the rear lower A-arms 404 (seen e.g., in FIG. 30). More specifically, the rear damping member 406 is mounted to the pair of mounting interfaces 408 of each of the pair of the rear lower A-arms 404 via the at least one ninth hole 456 using at least one fastener. In some embodiments, the mounting plate 454C of each mounting interface 408 may be stamped at an inner surface 460A thereof to form a circular elevated portion 458 in the inner surface 460A (seen e.g., in FIG. 30). The elevated portion 458 may be present at least around the at least one ninth hole 456 and may be configured to provide a support to the rear damping member 406, thereby securing the rear damping member 406 to the pair of mounting interfaces 408 while restricting any undesired movement of the rear damping member 406 between the pair of mounting interfaces 408. The rear damping member 406 is mounted to the frame 20 using the damper mounting bracket 144 of each of the pair of straddling rear frame brackets 260 (seen e.g., in FIG. 25). The pair of mounting interfaces 408 are projected upwardly from the rear lower A-arms 404, thereby enabling the rear damping member 406 to stand taller while mounting to the pair of mounting interfaces 408 in each of the pair of the rear lower A-arms 404. Such configuration of the pair of mounting interfaces 408 and the rear damping member 406 improves stability and cornering ability.

In some embodiments, the pair of the mounting interfaces 408 comprises a third mounting interface 496A and a fourth mounting interface 496B (seen e.g., in FIGS. 33H, 33I). The third mounting interface 496A and the fourth mounting interface 496B may be extending parallel to the rear central member 488. The third mounting interface 496A and the fourth mounting interface 496B may be extending from the first lower cross member 424A to the third lower cross member 424C (seen e.g., in FIG. 33H). In particular, the third mounting interface 496A and the fourth mounting interface 496B are positioned in between the rear forward member 446 and rear central member 488. The third mounting interface 496A and the fourth mounting interface 496B may have any suitable shape. In some embodiments, the third mounting interface 496A and the fourth mounting interface 496B comprise an upper edge 495A, a lower edge 495B, a mounting section 495C, a first vertical edge 495D, and a second vertical edge 495E. The edges 495A, 495B, 495D, 495E form an outer periphery of the mounting section 495C (seen e.g., in FIG. 33H).

The mounting section 495C may comprise at least one tenth hole 498 for mounting the rear damping member 406 with each of the pair of the lower A-arms 404 (seen e.g., in FIG. 33A). More specifically, the rear damping member 406 is mounted to the pair of the mounting interfaces 408 of each of the pair of the lower A-arms 404 via the least one tenth hole 498 using at least one fastener. In some embodiments, the mounting section 495C of third mounting interface 496A and the fourth mounting interface 496B comprises a depressed portion 499 in an outer face 497B thereof (seen e.g., in FIG. 33H). The least one tenth hole 498 is positioned at the depressed portion 499. The depressed portion 499 may be formed by stamping the mounting section 495C at the outer face 497B, thereby at least a portion of the mounting section 495C is depressed at the outer face 497B and elevated at an inner face 497A. More particularly, the mounting section 495C is depressed around the least one tenth hole 498, thereby the elevated portion prevents any undesired movement of the rear damping member 406 while mounting to the the pair of the lower A-arms 204.

The pair of the mounting interfaces 408 further comprises a first plate 496C and a second plate 496D. The first plate 496C may be positioned between the third mounting interface 496A and the fourth mounting interface 496B at the lower edge 495B and extending in the lateral direction Y. In other words, the first plate 496C is positioned below third mounting interface 496A and the fourth mounting interface 496B, bridging across between them (seen e.g., in FIG. 33J). One end of the first plate 496C is configured to extend from the second wheel mounting end 466 and is attached to the third lower cross member 424C and another end of the first plate 496C is attached to the rear forward member 446 and the rear central member 488. The first plate 496C may be partially covers the bottom of the pair of the mounting interfaces 408 at the lateral direction Y. The second plate 496D may be a vertical plate that is positioned between the second vertical edge 495E of each of the third mounting interface 496A and the fourth mounting interface 496B. In other words, the second plate 496D spans between the second vertical edge 495E of each of the third mounting interface 496A and the fourth mounting interface 496B (seen e.g., in FIG. 33A).

The pair of rear upper A-arms 402 are configured to be pivoted around a pair of upper pivot axes A1, A2 and the pair of rear lower A-arms 404 are configured to be pivoted around a pair of lower pivot axes B1, B2 (seen e.g., in FIGS. 31, 33C, 33D). The pair of upper pivot axes A1, A2 and the pair of lower pivot axes B1, B2 are parallel to each other. In other words, the pair of the rear upper pivot locations 432 and the pair of the rear lower pivot locations 426 are parallel to each other. Further, a respective rear upper A-arm and rear lower A-arm of each of the pair of the rear upper A-arms 402 and each of the pair of the rear lower A-arms 404 are parallel A-arms. The rear upper left A-arm 402B is configured to be pivoted around a first upper pivot axis A2 and the rear upper right A-arm 402A is configured to be pivoted around a second upper pivot axis A1. Each of the first upper pivot axis A1 and the second upper pivot axis A2 is parallel to the longitudinal central axis C1.

The rear lower left A-arm 404B is configured to be pivoted around a first lower pivot axis B2 and the rear lower right A-arm 404A configured to be pivoted around a second lower pivot axis B1. Each of the first lower pivot axis B1 and the second lower pivot axis B2 is parallel to the longitudinal central axis C1. In some embodiments, a second distance D2 between the pair of the upper pivot axes A1, A2 is smaller than a third distance D3 between the pair of the lower pivot axes B1, B2 (seen e.g., in FIGS. 32-33). In other words, the pair of lower pivot axes B1, B2 are positioned more outboard as compared to the pair of upper pivot axes A1, A2. Such linkage arrangement creates a positive camber as the rear suspension assembly 400 is compressed, thereby improving cornering ability stability of the vehicle 1 in an off-road environment.

In some embodiments, a plane passing through each of the pair of the upper pivot axes A1, A2 and a corresponding lower pivot axis B1, B2, respectively, intersects a corresponding constant-velocity (CV) joint, thereby minimizing a half-shaft plunge. A first plane P1 (seen e.g., in FIGS. 32, 33C) passing through the first upper pivot axis A1 and the first lower pivot axis B1 intersects a first CV joint 428A (seen e.g., in FIGS. 28, 33C). A second plane P2 (seen e.g., in FIGS. 32, 33C) passing through the second upper pivot axis A2 and the second lower pivot axis B2 intersects a corresponding second CV joint 428B. The first plane P1 and the second plane P2 may be a vertical plane extending from a top to bottom of the vehicle 1. Accordingly, the pair of rear pivot locations 432, 426 and the corresponding constant-velocity (CV) joint align on a same vertical plane. In an embodiment, such arrangement is configured to minimize the half-shaft plunge to around 2 millimetres (mm). Such reduction in the half-shaft plunge results in reduction in heat generation due to friction between half shaft 410 and the transaxle assembly 14.

In some embodiments, the rear damping member 406 comprises a shock absorber and a spring over the shock absorber (seen e.g., in FIGS. 25-27, 30-32). The shock absorber is mounted to the pair of mounting interfaces 408 of each of the pair of the rear lower A-arms 404 via the at least one ninth hole 456 using at least one fastener. The rear damping member 406 comprises a first rear damping member 406A and a second rear damping member 406B that are positioned on either side of the longitudinal central axis C1. The rear damping member 406 may be configured to be secured from the frame 20 to each of the pair of the rear lower A-arms 404. In some embodiments, the rear damping member 406 is secured from the frame 20 to each of the pair of the rear lower A-arms 404 through the each of the pair of the rear upper A-arms 402. The first rear damping member 406A is secured from the frame 20 to the rear lower right A-arm 404A through the rear upper right A-arm 402A. The second rear damping member 406B is secured from the frame 20 to the rear lower left A-arm 404B through the rear upper left A-arm 402B. The curved rear upper forward member surrounds the rear damping member 406 in such a way avoiding conflict with the CVT assembly 60, the engine 12, and the transaxle assembly 14.

The rear suspension assembly 400 further includes a rear anti-roll bar 480 that is coupled to the each of the pair of the rear lower A-arms 404 (seen e.g., in FIGS. 33A-33G). The rear anti-roll bar 480 connects the rear lower right A-arm 404A and the rear lower left A-arm 404B, and vice versa. The rear anti-roll bar 480 is a U-shaped member. The rear anti-roll bar 480 includes a right-side portion 480A, a middle portion 480B, and a left-side portion 480C (seen e.g., in FIG. 33B). It is to be noted that the right-side portion 480A corresponds to rear right A-arms and the left-side portion 480C corresponds to rear left A-arms. The right-side portion 480A and the left-side portion 480C are extending forwardly. The middle portion 480B is positioned between the right-side portion 480A and the left-side portion 480C and extending laterally and rearwardly. A right vertical link 484A connects the right-side portion 480A of the rear anti-roll bar 480 to the rear lower right A-arm 404A, and a left vertical link 484B connects the left-side portion 480B of the rear anti-roll bar 480 to the rear lower left A-arm 404B (seen e.g., in FIGS. 33A, 33B, 33G, 33H). In some embodiments, the right vertical link 484A and the left vertical link 484B are longer links, thereby reducing angle changes of vertical links at a given wheel movement.

The rear suspension assembly 400 further includes a first mounting member 482 that is positioned between the rear central member 488 and the rear lower rearward member 478 of each of the pair of the rear lower A-arms 404. Further, one end of the first mounting member 482 is supported in the first lower cross member 424A. The first mounting member 482 includes a right first mounting member 482A and a left first mounting member 482B (seen e.g., in FIGS. 33A, 33E, 33H). The right vertical link 484A and the left vertical link 484B extend through a corresponding enclosed space 422 in the pair of the rear upper A-arms 402 and mounted to a corresponding mounting member 482. For example, the right vertical link 484A extends through the enclosed space 422 in the rear upper right A-arm 402A and mounted to the right first mounting member 482A via example, fasteners. Further, the rear anti-roll bar 480 is attached to the frame 20 via a frame mounting bracket 486 that is attached to a pair of second mounting members 492 (seen e.g., in FIGS. 33L, 39, 42). The pair of second mounting members 492 may be positioned between a space that is formed between the adjacent frame member 544 and a supporting frame member 490. Each of the pair of second mounting members 492 includes a pair of eleventh holes 494 for mounting the rear anti-roll bar 480 thereon using the frame mounting bracket 486 and a fastener.

The front suspension assembly 50 includes a pair of front upper A-arms 52 and a pair of front lower A-arms 54 (seen e.g., in FIG. 33M-33N). In some embodiments, the pair of front upper A-arms 52 and the pair of front lower A-arms 54 are pivotably mounted to the frame 20 forward of the seating area 22 to facilitate movement of the front suspension assembly 50 to follow the surface of a trail or a road. Each of the pair of front upper A-arms 52 are mounted to the frame 20 at a pair of front upper pivot locations using a pair of front upper A-arm mounting brackets 63 (seen e.g., in FIGS. 20, 2R). Each of the pair of front lower A-arms 54 are mounted to the frame 20 at a pair of front lower pivot locations using a pair of front lower A-arm mounting brackets 62 (seen in e.g., in FIGS. 20, 2R). The pair of front upper A-arms 52 may comprise a front upper right A-arm 52A and a front upper left A-arm 52B (seen e.g., in FIGS. 33M-33N). In some embodiments, the front upper right A-arm 52A and the front upper left A-arm 52B may be identical. Each of the pair of front upper A-arms 52 comprises a front upper forward member 53 and a front upper rearward member 55 (seen e.g., in FIGS. 330, 33P). A front damping member 58 is attached to each of the pair of front upper A-arms 52. In particular, the front damping member 58 is attached to the front upper forward member 53 using a front mounting interface 58.

The front damping member 58 includes a first front damping member 58A and a second front damping member 58A that are positioned on either side of the longitudinal central axis C1. The first front damping member 58A is attached to the front upper forward member 53 of the front upper right A-arm 52A using a first front mounting interface 58A. The second front damping member 58B is attached to the front upper forward member 53 of the front upper left A-arm 52B using a second front mounting interface 58B. Each of the pair of front lower A-arms 54 comprises a front lower forward member 57 and a front lower rearward member 59 (seen e.g., in FIGS. 33Q, 33R, 33S, 33T). FIGS. 33S-33T illustrate a front view of the front suspension assembly 50 and a rear suspension assembly 400 having damping members connected therewith in accordance with the present disclosure. FIGS. 33U-33V illustrate a rear view of the front suspension assembly 50 and the rear suspension assembly 400 having damping members connected therewith in accordance with the present disclosure. Further, FIGS. 33AA-33AI illustrates the frame 20 with the rear suspension assembly 400 and a front suspension assembly 50.

Reference is now made to FIGS. 34-40, which illustrate the hitch assembly 500 in accordance with the present disclosure. The hitch assembly 500 is configured to be attached to the frame 20. In particular, the hitch assembly 500 is attached to the rear frame structure 80. In other words, the hitch assembly 500 may be secured to a frame structure facilitating attachment of the rear suspension assembly 400 of the vehicle 1. The hitch assembly 500 may be supported by a second cross member 90 of the frame 20 of the vehicle 1. The hitch assembly 500 may include a second cavity H2 to receive a drawbar therewithin.

The hitch assembly 500 may include a base plate 502 and a top member 520. The top member 520 may be configured to be coupled to the base plate 502. The base plate 502 and the top member 520, when coupled together, may be configured to form the second cavity H2 for receiving a drawbar therewithin. It is to be noted that dimensions of the second cavity H2 may be designed such as to receive the drawbar therewithin with a small amount of clearance. In an embodiment, the top member 520 may be coupled to the base plate 502 by means of welding.

The top member 520 may be an inverted U-shaped channel (seen e.g., in FIG. 35). The top member 520 may extend from a rear end 532 towards a front end 534 thereof. The top member 520 may be defined by a pair of side walls 522 and a top wall 524. Each of the pair of side walls 522 may include a first side wall edge 526 and a second side wall edge 528. The first side wall edge 526 of each of the pair of side walls 522 may be configured to be attached to the base plate 502. The second side wall edge 528 of each of the pair of side walls 522 may abut a pair of edges of the top wall 524. In other words, the top wall 524 may extend between the second side wall edge 528 of each of the pair of side walls 522, thereby making the top member 520 in shape of an inverted U-shaped channel. Preferably, the top wall 524 and side walls 522 are integrally formed such as by bends between the top walls 524 and the side walls 522. Each of the pair of side walls 522 may include a twelfth hole 530 proximal to the rear end 532. The twelfth hole 530 at each of the pair of side walls 522 may be configured to receive a hitch pin after receiving the drawbar within the second cavity H2.

The base plate 502 of the hitch assembly 500 may be defined by a second top surface 504 and a second bottom surface 506 (seen e.g., in FIG. 36). The second top surface 504 of the base plate 502 may be configured to be coupled with the first side wall edge 526 of each of the side walls 522 of the top member 520 to form the second cavity H2. The base plate 502 may be divided into three sections, a pair of side sections 514 and a middle section 512. The base plate 502 may be configured to be coupled to the top member 520 at the middle portion 512 on the second top surface 504 thereof.

The base plate 502 may further be defined by a forward end 510 and a rearward end 508 (seen e.g., in FIG. 35). The base plate 502 may be supported by a portion of the rear frame structure 80 of the frame 20. In some embodiments, the base plate 502 may be supported by a portion of the rear frame structure 80 proximal to the rear suspension assembly 400 (seen e.g., in FIGS. 34-35). Particularly, the base plate 502 may be supported by a second cross member 90, which is designed for attachment of the rear suspension assembly 400 with the frame 20. More particularly, the base plate 502 may be supported by the second cross member 90 adjacent to the forward end 510 thereof. Accordingly, the hitch assembly 500 may be configured to get a first support at the forward end 510 of the base plate 502 from the second cross member 90 of the frame 20.

It is submitted that the top member 520 may be coupled with the base plate 502 such that the top member 520 extends from the rearward end 508 of the base plate 502 towards the forward end 510 such that the rearward end 508 of the base plate 502 is substantially aligned with the rear end 532 of the top member 520. Such arrangement provides better alignment of the hitch assembly 500.

In some embodiments, each of the pair of side sections 514 of the base plate 502 may include an aperture 518 (seen e.g., in FIG. 36). The aperture 518 may be configured to facilitate securement of a hook or ring therewith, such as for securing a safety chain. The aperture 518 may further be used to tie a rope, recovery strap, or chain therewith. Accordingly, the aperture 518 may provide additional support and provision for securing the external load attached by to the drawbar. It may also be used for recovery efforts.

The base plate 502 may further include an outside flange 516 at each of the side sections 514 (FIGS. 35-37). Particularly, the outside flange 516 may extend upwardly from an outer side of each of the pair of side sections 514. The outside flange 516, at each side, may be fixed to an adjacent frame member 544, defining a rear structure of the frame (seen, e.g., in FIG. 35). Accordingly, the attachment of the outside flanges 516 with the adjacent frame members 544 may provide a second support to the hitch assembly 500, especially for the base plate structure surrounding the apertures 518.

The hitch assembly 500 may further include a supporting member 535 (seen e.g., in FIGS. 35-37 and 41-46). The supporting member 535 is configured to be positioned above the base plate 502. The supporting member 535 is configured to receive the top member 520 therewithin.

In some embodiments, the supporting member 535 includes at least one supporting plate 536 (seen e.g., in FIGS. 35-37). The at least one supporting plate 536 may be configured to be coupled to the second top surface 504 of the base plate 502. The at least one supporting plate 536 may be configured to be positioned substantially transverse to the base plate 502. In some embodiments, the at least one supporting plate 536 may be configured to be positioned perpendicular to the base plate 502. Optionally, the at least one supporting plate 536 may be configured to be positioned at an acute angle or an obtuse angle with the base plate 502.

In some embodiments, the at least one supporting plate 536 may be defined by a bottom edge 538 and a plurality of side edges 542 (seen e.g., in FIGS. 36-37). The bottom edge 538 of the at least one supporting plate 536 may include a cut-out portion 540. The cut-out portion 540 may be defined so as to receive the top member 520 therewithin. In other words, the cut-out portion 540 may correspond to an outer periphery of the top member 520 so as to comfortably receive the top member 520 therewithin. The plurality of side edges 542 of the at least one supporting plate 536 may be configured to abut and be fixed to an adjacent frame member 544 on both sides thereof (seen e.g., in FIG. 35). For the same, each of the plurality of side edges 542 of the at least one supporting plate 536 may have a shape corresponding to the adjacent frame member 544 (seen e.g., in FIG. 35). Accordingly, the at least one supporting plate 536, and hence the hitch assembly 500, may get a third support. The at least one supporting plate 536 may be coupled to the second top surface 504 of the base plate 502 by means of welding.

In some embodiments, the supporting member 535 may include a pair of supporting plates 536A, 536B (seen e.g., in FIGS. 36-37). The pair of supporting plates 536 may be positioned on the second top surface 504 of the base plate 502 such that the pair of supporting plates 536 are substantially transverse to the base plate 502. In some embodiments, the pair of supporting plates 536 may be configured to be positioned perpendicular to the base plate 502. Optionally, the pair of supporting plates 536A, 536B may be configured to be positioned at an acute angle or an obtuse angle with the base plate 502.

The pair of supporting plates 536A. 536B may be placed at a fourth distance D4 from each other (seen e.g., in FIG. 36). In other words, a first supporting plate 536A of the pair of supporting plates 536 may be placed at a fourth distance D4 from a second supporting plate 536B thereof. The fourth distance D4 between the two plates may correspond to an outer diameter of the adjacent frame member 544. Both plates 536 are preferably welded to frame member 544.

In some embodiments, each of the pair of supporting plates 536A, 536B may have different widths (seen e.g., in FIG. 37). For instance, the first supporting plate 536A may have a first width W1 and the second supporting plate 536B may have a second width W2. In an embodiment, the first width W1 may be smaller than the second width W2. Further, an upper portion of the first supporting plate 536A may abut and be welded to the second supporting plate 536B (seen e.g., in FIGS. 36-37). For the same, the upper portion of the first supporting plate 536A may have a curve C3 to facilitate such abutment. It is to be noted that the pair of supporting plates 536A, 536B are positioned such that at least a portion of both the pair of the supporting plates 536A, 536B is parallel to each other. Specifically, a lower portion of each of the pair supporting plates 536A, 536B is parallel to each other.

Each of the pair of supporting plates 536A, 536B may be defined by a bottom edge 538 and side edges 542. The bottom edge 538 of each of the pair of supporting plates 536A. 536B may be configured to have a cut-out portion 540. The cut-out portion 540 of each of the pair of supporting plates 536A, 536B may be corresponding to an outer periphery of the top member 520 so as to receive the top member 520 therewithin. The edges of the cut-out portions 540 may be welded or otherwise secured to the top member 520. In an embodiment, the side edges 542 of the pair of supporting plates 536A, 536B may abut an adjacent frame member 544 at each side thereof. For the same, each of the side edges 542 of the pair of supporting plates 536 may have a shape corresponding to the adjacent frame member 544. It is to be noted that the adjacent frame member 544 may be a hollow pipe and the pair of supporting plates 536A, 536B may be shaped according to an outer diameter and a shape of the hollow pipe.

Accordingly, the hitch assembly 500 may get additional support from the adjacent frame member 544 at each side thereof (seen e.g., in FIGS. 35-37). In some embodiments, the adjacent frame member 544 may be configured to be placed proximal to the rear frame structure 80 of the rear suspension assembly 400. For the same, the rear frame structure 80 may include an extension 546 (seen e.g., in FIGS. 35-37) attached to the rear frame structure 80. In an embodiment, the adjacent frame member 544 is a circular hollow pipe configured to be fitted on the extension 546. The adjacent frame member 544 may have a diameter.

FIGS. 38-40 illustrate different views of the hitch assembly 500 coupled to the frame 20 of the vehicle 1. More specifically, FIG. 38 illustrates a bottom isometric view of the second rear frame structure having the hitch assembly 500 attached thereto, while FIGS. 39-40 illustrate a rear view and a bottom view, respectively, of the hitch assembly 500 coupled to the frame 20 of the vehicle 1.

In some embodiments, the supporting member 535 is an inverted U-shaped channel (seen e.g., in FIGS. 41-46). The supporting member 535 may extend from a left end 552 to a right end 554. The left end 552 corresponds to a left side of the vehicle 1 when viewed from a rear end of the vehicle 1 (seen e.g., in FIG. 43). The right end 554 corresponds to a right side of the vehicle 1 when viewed from the rear end of the vehicle 1. The supporting member 535 includes a forward supporting plate 537A, a rearward supporting plate 537B, and a top supporting plate 537C (seen e.g., in FIG. 41). The forward supporting plate 537A and the rearward supporting plate 537B may be positioned or coupled on the second top surface 504 of the base plate 502 such that the forward supporting plate 537A, and the rearward supporting plate 537B are substantially transverse to the base plate 502. Each of the forward supporting member 537A and rearward supporting member 537B includes a bottom edge 538, a pair of side edges 542, and a top edge 548. The top supporting plate 537C includes a plurality of side edges 550 (seen e.g., in FIG. 46). The top edge 548 of each of the forward supporting member 537A and rearward supporting member 537B abut a pair of edges 550 of the top supporting plate 537C, thereby forming the inverted U-shaped channel. Preferably, the forward supporting plate 537A, the rearward supporting plate 537B, and the top supporting plate 537C are integrally formed as a single piece.

The bottom edge 538 of each of the forward supporting member 537A and rearward supporting member 537B abuts the second top surface 504. The pair of side edges 542 of the forward supporting member 537A and rearward supporting member 537B may be configured to abut and be fixed to the adjacent frame member 544 on both sides thereof (seen e.g., in FIG. 42). The forward supporting plate 537A and the rearward supporting plate 537B are preferably welded to the adjacent frame member 544.

The forward supporting plate 537A, and the rearward supporting plate 537B may be placed at a fifth distance D5 from each other (seen e.g., in FIG. 46). In other words, the forward supporting plate 537A may be placed at the fifth distance D5 from the rearward supporting plate 537B thereof. The fifth distance D5 between the forward supporting plate 537A and the rearward supporting plate 537B may correspond to an outer diameter of the adjacent frame member 544.

The bottom edge 538 of each of the forward supporting plate 537A and the rearward supporting plate 537B may be configured to have a cut-out portion 540. The cut-out portion 540 of each of the forward supporting plate 537A and the rearward supporting plate 537B may be corresponding to an outer periphery of the top member 520 so as to receive the top member 520 therewithin. The edges of the cut-out portions 540 may be welded or otherwise secured to the top member 520.

In some embodiments, the forward supporting plate 537A may have a third width W3 and the rearward supporting plate 537B may have a fourth width W4. The third width W3 and the fourth width W4 are substantially same (seen e.g., in FIG. 46).

In some embodiments, the base plate 502 and the top member 520 may be used as a hitch mount, i.e., without use of the supporting plates 536. Such arrangement may be referred as a partial hitch. In such embodiments, the partial hitch may be configured to be attached to the frame 20 for getting support therefrom. In an embodiment, the partial hitch may be attached to the adjacent frame member 544, by means of welding, at each of the first side and the second side for providing support thereto.

It is to be noted that different components of the hitch assembly 500 may be attached or coupled with each other and with corresponding frame member by means of welding. Accordingly, a firm coupling is achieved in the frame 20 of the vehicle 1, including the hitch assembly 500.

The hitch assembly 500 of the present disclosure is structured so as to get support from the frame 20 at different points, for instance, the first support from the second cross member 90 of the frame 20, the second and the third supports from the adjacent frame member 544 of the rear frame structure 80. Hence, the hitch assembly 500 receives an increased overall support. Such structure facilitates better distribution of load when an external load is attached thereto using a drawbar. Moreover, because of the firm attachment of the hitch assembly 500 with the frame 20, for instance, at the rear frame structure 80, the drawbar attached with the hitch assembly 500 is better supported with application of an external load. Hence, a strong attachment between the drawbar and the hitch assembly 500 is achieved. The apertures 518 are also better supported for loads, including recovery loads, applied thereto. As a result, even in the case of off-axis loads, such as pulling a load that is not directly rearward of the vehicle 1, the hitch assembly 500 provides stable attachment.

Referring to FIGS. 47-58, the engine 12 is removably and rigidly coupled with the transaxle assembly 14 using a first coupling plate 602 and a second coupling plate 604, thereby minimizing vibration and misalignment of the engine assembly 10. It is to be noted that the engine assembly 10 may include the engine 12 and the transaxle assembly 14 and/or transmission assembly 60. The first coupling plate 602 is configured to couple the engine 12 and the transaxle assembly 14 at the first side (F5) of the longitudinal central axis C1 (seen e.g., in FIGS. 47-50). In other words, the first coupling plate 602 is configured to couple the engine 12 and the transaxle assembly 14 at the left side of the vehicle 1. The second coupling plate 604 is configured to couple the engine 12 and the transaxle assembly 14 at the second side (S5) of the longitudinal central axis C1 (seen e.g., in FIGS. 47, 51-52). In other words, the second coupling plate 604 is configured to couple the engine 12 and the transaxle assembly 14 at the right side of the vehicle 1. In some embodiments, the first coupling plate 602 and the second coupling plate 604 may be formed to fit a specific shape or contour of mounting surfaces of the engine 12 and the transaxle assembly 14. Accordingly, such formation of coupling plates reduces a potential gap between the coupling plates and the engine assembly 10 and ensures custom fitting between the coupling plates and the engine assembly 10 to maintain CVT clutch alignment and to prevent noise, vibration, and harshness (NVH) in the vehicle 1. The first coupling plate 602 and the second coupling plate 604 may be formed using a permanent mould casting, preferably aluminum permanent mould casting.

The first coupling plate 602 comprises a first plate 602A and a finger member 602B extending from the first plate 602A (seen e.g., in FIGS. 53-54). Each of the first plate 602A and the finger member 602B includes a first surface 614A and a second surface 614B that is opposite to the first surface 614A. In some embodiments, the first surface 614A and the second surface 614B may be an outer surface and an inner surface of the first coupling plate 602, respectively. The second surface 614B is positioned towards the mounting surfaces of the engine 12 and the transaxle assembly 14 (seen e.g., in FIG. 49). The first coupling plate 602 comprises one or more thirteenth holes 610 for coupling the engine 12 and the transaxle assembly 14 by receiving one or more ninth fasteners 606. Similarly, the mounting surfaces of the engine 12 and the transaxle assembly 14 comprise one or more holes corresponding to the one or more thirteenth holes 610 at the first side (F5) of the longitudinal central axis C1 and are configured to receive the one or more ninth fasteners 606 through the one or more thirteenth holes 610 while coupling the engine 12 and the transaxle assembly 14 (seen e.g., in FIGS. 48-49). In some embodiments, the finger member 602B is configured to provide support to a backside of the CVT assembly 60, thereby preventing heat deterioration and rubbing between the transaxle assembly 14 and the CVT assembly 60. The finger member 602B may also be used to support cables or other engine components.

The second coupling plate 604 comprises a second plate 604A and a plurality of tabs 604B extending vertically from an outer periphery of the second plate 604A (seen e.g., in FIGS. 57-58). The second coupling plate 604 comprises a third surface 618A and a fourth surface 618B. In some embodiments, the third surface 618A and the fourth surface 618B may be an outer surface and an inner surface of the second coupling plate 604, respectively. The third surface 618A is positioned towards the mounting surfaces of the engine 12 and the transaxle assembly 14 (seen e.g., in FIG. 51). The second coupling plate 604 comprises one or more fourteenth holes 612 for coupling the engine 12 and the transaxle assembly 14 by receiving one or more tenth fasteners 608 (seen e.g., in FIGS. 56-57). Similarly, the mounting surfaces of the engine 12 and the transaxle assembly 14 comprise one or more holes corresponding to the one or more fourteenth holes 612 at the second side (S5) of the longitudinal central axis C1 and are configured to receive the one or more tenth fasteners 608 through the one or more fourteenth holes 612 while coupling the engine 12 and the transaxle assembly 14 (seen e.g., in FIGS. 51-52). Further, FIG. 59 illustrates an exemplary left side view of the frame 20 and the first coupling plate 602 connecting or coupling the engine 12 and the transaxle assembly 14 at the first side (F5) of the vehicle 1. FIG. 60 illustrates an exemplary right-side view of the frame 20 and the second coupling plate 604 connecting or coupling the engine 12 and the transaxle assembly 14 at the second side (S5) of the vehicle 1.

In some embodiments, the second coupling plate 604 is configured to provide support for mounting an air conditioning (AC) compressor 620 to the engine 12 (seen e.g., in FIGS. 61-63, 65-67). FIG. 64 illustrates a left-side view of the engine assembly 10 having the air conditioning (AC) compressor 620 mounted therewith. FIGS. 68-74 illustrate the frame 20 that secures the engine assembly 10 mounted with the air conditioning (AC) compressor 620 using the second coupling plate 604.

FIG. 60A shows another preferred embodiment of a second coupling plate 604C secured between the engine 12 and transaxle assembly 14 on the right side of the engine-transaxle assembly 10. Plate 604C is secured to the engine 12 with three fasteners and to the transaxle assembly with two fasteners. Plate 604C is strengthened with ribs 613C extending at various angles from a transverse plate portion fastened to the engine 12 and a generally longitudinal plate portion secured with the two fasteners to the transaxle assembly 14. The coupling plate 604C shown in FIG. 60A is suited to a vehicle that does not include an external air conditioning compressor. The plate is preferably a single piece. It is preferably constructed of aluminum.

FIGS. 60B and 60C illustrate coupling of the right side of the engine-transaxle assembly 10 with a two-plate assembly that is adapted to accommodate a compressor 609. As shown in FIG. 60B without the compressor installed, the two-plate assembly includes a first alternate coupling plate 604D and a second alternate coupling plate 604E. First plate 604D is positioned above second plate 604E and includes mounting fixtures 605 for securing the compressor 609. Second coupling plate 604E preferably includes three mounting locations for securement to the engine 12 and one mounting location for securement to the transaxle 14. The top two mounting locations of plate 604E are also used to secure first coupling plate 604D to the engine 12. First coupling plate 604D is secured in at least one location to transaxle assembly 14 at an upper portion thereof. Strengthening ribs are also provided in this compressor-mount embodiment.

FIG. 60C shows the compressor-mount embodiment with the compressor 609 installed.

The compressor 609 mounts to the mounting fixtures on the coupler plates. Preferably an idler wheel 607 is provided on the side of the engine with a belt 611 driving the compressor. The compressor is preferably a variable-volume compressor to provide air conditioning for the vehicle. Nesting the compressor 609 rearward of the engine and to the right of the transaxle assembly provides good space utilization and component packaging as it positions the compressor in an available space that does not get in the way of other vehicle components.

Referring to FIG. 75, which illustrates an engine cooling assembly 700 of the vehicle 1 that is configured to connect with the engine 12 for managing temperature of the engine 12 during combustion process. The engine cooling assembly 700 includes a radiator 702, an expansion tank 704, a coolant feed pipe 706, and a coolant return pipe 708 (seen e.g., in FIGS. 75, 82-88). The radiator 702 is configured to supply the coolant, via the coolant feed pipe 706, to cool the engine 12 during the combustion process. The radiator 702 is configured to cool the hot coolant, received via the coolant return pipe 708, for further cooling of the engine 12. In some embodiments, the radiator 702 is positioned at the front portion of the frame 20 (seen e.g., in FIGS. 89-93). The coolant feed pipe 706 is configured to extend from the radiator 702 rearwardly to the engine 12 and supply coolant to the engine 12. The coolant feed pipe 706 includes a first feed pipe 706A, a second feed pipe 706B, and a bypass pipe 706C (seen e.g., in FIGS. 75, 77, 79, 81). The first feed pipe 706A is configured to extend from the radiator 702 rearwardly and connect with the second feed pipe 706B (seen e.g., in FIG. 75). The first feed pipe 706A may be an aluminum pipe. The second feed pipe 706B is configured to connect with a coolant pump 712 (seen e.g., in FIGS. 77, 79, 81). In some embodiments, the second feed pipe 706B is configured to extend over the front mount assembly 30 (seen e.g., in FIGS. 75-79, 81). The coolant pump 712 is configured to supply the coolant to the engine 12 via the bypass pipe 706C. In some embodiments, the bypass pipe 706C is configured to extend behind an air plenum 710 and connect to the engine 12 (seen e.g., in FIGS. 75-76, 78). The second feed pipe 706B and the bypass pipe 706C may be a rubber pipe.

The coolant return pipe 708 is configured to extend from the engine 12 forwardly to the radiator 702 and return a hot coolant from the engine 12 to the radiator 702. The coolant return pipe 708 includes a first return pipe 708A and a second return pipe 708B. The first return pipe 708A is configured to extend from the engine 12 forwardly and connect with the second return pipe 708B which is further connected with the radiator 702 (seen e.g., in FIG. 75). In some embodiments, at least a portion of the first return pipe 708A is positioned behind the air plenum 710 and a remaining portion of the first return pipe 708A extending below the front mount assembly 30 (seen e.g., in FIGS. 75-79, 81). The first return pipe 708A may be a rubber pipe. The second return pipe 708B may be an aluminum pipe. In some embodiments, the radiator 702 includes one or more fans 716 (seen e.g., in FIGS. 82, 84, 86-87). The one or more fans 716 (e.g., electric fans) may be used to circulate air across radiator fins to aid in cooling the coolant in the radiator 702.

FIG. 84A is a circuit diagram to explain a preferred method of controlling the two fans 716 shown in FIG. 84. The electronics control the two fans to reduce fan noise when only minimal or moderate engine cooling is needed. In the past, for normal cooling a single fan was switched on at high speed. Both fans are typically turned on at high speed with high cooling requirements. In the preferred embodiment with the circuitry shown in FIG. 84A, the following options are available: (0) both off, (1) both on at low speed, and (2) both on at high speed. This provides low noise in all but the most demanding cooling situations compared to the typical fan control systems.

Mode 0 is shown in FIG. 84A. In this mode, the right and left fans are switched to a series wiring with Control Relay SPDT1 closed to series between Right Relay SPST2 and Left Relay SPDT1. However, Right Relay SPST2 is open for no voltage being applied across the Right and Left Fans.

Mode 1 is activated in the configuration shown in FIG. 84A once Right Relay is closed. This sets up a series circuit-Right and Left Fans being in series with the voltage split between them such that both fans are at low speed.

Mode 2 is activated by closing Right Relay, switching Control Relay to Ground, and switching Left Relay directly to power (BLK/PNK wire) rather than to Control Relay. In this configuration, Right and Left Fans are in parallel such that both receive full voltage for both at high speed.

In some embodiments, after attaching rubber tubes of the coolant feed pipe 706 and the coolant return pipe 708 behind the air plenum 710, the engine 12 is installed or placed in the engine area 24. Thereafter, the rubber pipes are attached to the aluminum pipes of the coolant feed pipe 706 and the coolant return pipe 708. In some embodiments, the coolant feed pipe 706 and the coolant return pipe 708 may be extended using additional coolant pipes (seen e.g., in FIGS. 86-88) while using the engine cooling assembly 700 in longer wheelbase vehicles such as crew vehicles. For example, additional aluminum coolant pipes are added to the coolant feed pipe 706 and the coolant return pipe 708. FIGS. 89-95 illustrate the frame 20 and the engine cooling assembly 700 connected with the engine 12.

Additional embodiments of a cooling system adapted to an extended vehicle 100 such as a crew cab vehicle are shown in FIGS. 88A and 88B. The extended frame 20A to accommodate two rows of seating includes an extended wheelbase such that the engine is farther from the front-positioned radiator 702. In a preferred embodiment, extended coolant feed pipe 706D and extended coolant return pipe 708D are provided to accommodate the longer vehicle. Such extended pipes include pipe couplers 707 to secure to standard-length pipes 706 and 708. In preferred embodiments, these pipe extensions include angled portions 706D and 708D to provide room for a propeller shaft carrier bearing 709A. This bearing is preferably included due to the extended length of the of the propeller shaft 709.

Referring to FIGS. 96-100, which illustrates a heating, ventilation, and air conditioning (HVAC) assembly 800 configured for temperature management inside vehicle's cabin. The HVAC assembly 800 includes the air conditioning (AC) compressor 620, a condenser 802, an evaporator 806, a blower 808, and AC vents 810. The air conditioning (AC) compressor 620 is configured to compress the refrigerant and convert the refrigerant from a low-pressure gas into a high-pressure gas. The high-pressure gas is transferred via an inlet line of the cooling lines to the condenser 802. The condenser 802 may be located in front of the radiator 702. As air (from the car's motion or from a fan when the car is stationary) flows over the condenser 802, heat from the high-pressure gas is released, causing the refrigerant to condense and change from a gas to a liquid state. Thereafter, the high-pressure liquid refrigerant passes through an expansion valve or orifice tube which restricts the flow of the high-pressure liquid refrigerant and generates a low-pressure, cold liquid-gas mixture. The cold liquid-gas mixture then enters the evaporator 806, which is located inside the vehicle's cabin. The blower 808 blows cabin's warm air over the evaporator 806 where the refrigerant evaporates by absorbing heat from the warm air and cooling the warm air. The cooled air is blown into the vehicle cabin, via AC vents 810, using the blower 808. The evaporated refrigerant is then returned to the air conditioning (AC) compressor 620 via an outlet line of the cooling lines to start a next cycle.

FIGS. 101 through 106 illustrate an engine air intake assembly 900 of the vehicle 1. The engine air intake assembly 900 includes an air filter assembly 902 and an engine intake duct member 904 (seen e.g., in FIG. 101). The air filter assembly 902 may include an inlet port (not shown) and an outlet port 908 (seen e.g., in FIGS. 103, 105, 106). The air filter assembly 902 may be mounted to the frame 20 using a filter mounting bracket 916 (seen e.g., in FIGS. 2P, 104). The engine intake duct member 904 is configured to draw air from the environment via an air intake opening 906 and direct the air to the air filter assembly 902 via the inlet port. The air filter assembly 902 is configured to filter the air from debris and other contaminants before directing to the engine 12 via the outlet port 908. The outlet port 908 may be connected with an inlet conduit 912 to direct the filtered air to the engine 12 for combustion process (seen e.g., in FIG. 107). The inlet conduit 912 may be coupled to the air intake manifold 38 or a throttle body, for example via a hose clamp (seen e.g., in FIGS. 61, 65). In some embodiments, the engine intake duct member 904 includes a first intake duct member 904A, a second intake duct member 904B, and a third intake duct member 904C. The first intake duct member 904A may be an angled member (seen e.g., in FIGS. 101, 104, 106). The first intake duct member 904A may be configured to extend from the air filter assembly 902 laterally towards the left side of the vehicle 1. In other words, the first intake duct member 904A may be extending under a passenger compartment from side to side. One end of the first intake duct member 904A is connected with the inlet port of the air filter assembly 902 and another end of the first intake duct member 904A is connected with the second intake duct member 904B. The second intake duct member 904B may be a vertical member. One end of the second intake duct member 904B is connected with the first intake duct member 904A and another end of the second intake duct member 904B is connected with the third intake duct member 904C. One end of the third intake duct member 904C is connected with the second intake conduit 904B. In some embodiments, the second intake duct member 904B and the third intake duct member 904C are configured to be positioned between a seat back panel 910 and one or more seats 914 of the vehicle 1. The third intake duct member 904C may be configured to extend laterally towards the air intake opening 906. The air intake opening 906 is positioned on a left side panel 910A of the seat back panel 910 (seen e.g., in FIG. 102). An end portion 904D of the third intake duct member 904C is configured to align with the air intake opening 906 on the left side panel 910A and configured to draw the air via the air intake opening 906 from the left side of the vehicle 1 (seen e.g., in FIGS. 102, 106). FIGS. 107-113 illustrates the engine air intake assembly 900 and the exhaust assembly 300 secured to the frame 20. In some embodiments, the air intake opening 906 may be positioned on a rear side panel 910C of the seat back panel 910 (seen e.g., in FIGS. 114, 117), thereby the left side panel 910A is configured similar to a right-side panel 910B (seen e.g., in FIGS. 115, 116). The end portion 904D of the third intake duct member 904C is configured to align with the air intake opening 906 on the rear side panel 910C and configured to draw the air via the air intake opening 906 from the rear side of the vehicle 1.

FIG. 117A illustrates a preferred embodiment of the intake duct 904. Lower resonance chambers 905A and upper resonance chambers 905B tune the intake for reduced noise and vibration. Preferably three lower chambers 905A are used, each with a different closed volume. Preferably four upper chambers 905B are used, each with a different closed volume. Lower chambers are situated along the first intake duct member 904A. Upper chambers are situated at the end of second intake duct member 904B next to third intake duct member 904C.

End portion 904D of third intake duct member 904C includes a bulb seal 906A that presses and seals against the side panel of the vehicle around an opening in the side panel to admit air. The end portion 904D also includes a debris trap 907 in the form of undulations forming an M-shape volume with lower portions into which moisture and debris heavier than air may settle before progressing to the air filter assembly 902. Drainage ports are optionally provided at the bottoms of each low portion of the debris trap.

With further regard to FIGS. 118-124, in some embodiments, a CVT housing 1000 includes an outer CVT cover 1002, an inner CVT cover 1004, a CVT intake duct member 1006, and a CVT exhaust duct member 1008 (seen e.g., in FIGS. 118-123). In some embodiments, the outer CVT cover 1002 is removably or releasably coupled to the inner CVT cover 1004 using one or more twelfth fasteners 1020 (seen e.g., in FIGS. 118-119). The CVT intake duct member 1006 is configured to provide air flow (i.e., cold air) to the CVT housing 1000. The CVT exhaust duct member 1008 is configured to blown out the air outside the CVT housing 1000. In some embodiments, the air exhausted out from the CVT housing 1000 into the atmosphere or is used to cool the oxygen sensor 346 or other sensor as shown in e.g., in FIGS. 128-132. In some embodiments, the CVT intake duct member 1006 and the CVT exhaust duct member 1008 are positioned on the inner CVT cover 1004 (seen e.g., in FIGS. 118-123). In other words, the CVT intake duct member 1006 and the CVT exhaust duct member 1008 are positioned at an inboard side of the CVT housing 1000, thereby air flows on the inboard side of the CVT housing 1000. The outer CVT cover 1002, such as a wrapping outboard side, improves the air flow on the inboard side with less turbulence.

The CVT housing 1000 is configured to house a drive clutch 1022 and a driven clutch 1024 (seen e.g., in FIGS. 122, 123). The CVT housing 1000 is further configured to house a flywheel 1030 (seen e.g., in FIGS. 127A-127B). The CVT housing 1000 is configured to separate the flywheel 1030 from the drive clutch 1022 using a removable wall member 1010. In some embodiments, the removable wall member 1010 is positioned between the flywheel 1030 and the drive clutch 1022 (seen e.g., in FIG. 127D). The removable wall member 1010 comprises a first tab 1010A and a second tab 1010B (seen e.g., in FIGS. 118, 124, 125). The first tab 1010A is configured to fit into a first slot 1004A. The second tab 1010B is configured to engage with an interior wall of the inner CVT cover 1004 at a location 1004B (seen e.g., in FIG. 120A). The first slot 1004A is positioned at an inner CVT cover lip that is adjacent to an air opening of the CVT housing 1000. The first tab 1010A and the second tab 1010B are configured to enable the removable wall member 1010 to engage with the inner CVT cover 1004, prevent rotation of the removable wall member 1010, and avoid interruption of the removable wall member 1010 with the air flow. The removable wall member 1010 is further fastened to the inner CVT cover 1004 using at least one eleventh fastener 1018 through fifteenth holes 1010C of the removable wall member 1010 and the inner CVT cover 1004 (seen e.g., in FIG. 123). The removable wall member 1010 comprises a plurality of fifteenth holes 1010C along a perimeter of the removable wall member 1010 (seen e.g., in FIG. 124) for mounting the removable wall member 1010 to the inner CVT cover 1004. The at least one eleventh fastener 1018 is passing thorough the plurality of fifteenth holes 1010C and through a thicker portion of the inner CVT cover 1004 (seen e.g., in FIGS. 120A, 123). Accordingly, the removable wall member 1010 functions as a backing plate between the flywheel 1030 and the drive clutch 1022. In some embodiment, a flat plate 1016 is positioned between the removable wall member 1010 and the drive clutch 1022 to reduce a gap between the removable wall member 1010 and an inner drive clutch sheave 1028 which in turn reduces the air flow between the removable wall member 1010 and the drive clutch 1022 (seen e.g., in FIGS. 120A, 124, 125, 127C). In some embodiments, the flat plate 1016 is a fibrous material.

In some embodiments, a retaining wall 1012 of the removable wall member 1010 extends outwardly from the removable wall member 1010 and narrows at a top of the retaining wall 1012. The retaining wall 1012 further expands at a lower end near an outlet path 1032 of the CVT housing 1000 (seen e.g., in FIG. 120A). Such configuration of the removable wall member 1010 provides Fibonacci sequence configuration for the retaining wall 1012, thereby the air flows along the retaining wall and exits in a desired channel instead of spreading out everywhere. Thus, enabling to optimally release pressure as the air flows out. Further, such configuration produces a higher volume of air intake along the desired channel with less turbulence. In some embodiments, the outer CVT cover 1002 comprises a honeycomb structure 1014 on its outer surface which attenuates noise, prevents vibrations, and stiffens the ribs (seen e.g., in FIGS. 118-119, 121A, 128).

In another preferred embodiment of the CVT housing 1000, an additional exit recess 1033 is provided at the exit corner of the housing before the air flows through CVT exhaust duct member 1008. See FIG. 120C (inside view) and 120D (outer housing view). This additional recess follows the curve of the end of the housing. It provides additional flow to reduce back pressure or resistance to flow to the exhaust duct member 1008. It also helps to channel the flow to the exhaust duct member 1008.

The present disclosure further relates to a method of installing the CVT housing 1000 in the vehicle 1 (seen e.g., in FIGS. 127A-127D). The method comprises the steps of placing the inner CVT cover 1002 over a drive shaft of the engine 12 and fastening to the engine assembly 10, then positioning the flywheel 1030 inside the inner CVT cover 1002 and attaching the flywheel 1030 to the drive shaft. Thereafter, the removable wall member 1010 is positioned after the flywheel 1030 by engaging the first tab 1010A and the second tab 1010B with the interior wall of the inner CVT cover 1002 and fastened to the inner CVT cover 1002 using at least one eleventh fastener 1018. After that, the drive clutch 1022 is installed on the drive shaft so that the removable wall member 1010 act as the backing plate between the drive clutch 1022 preferably the inner drive clutch sheave 1028 and the flywheel 1030. FIGS. 128-129 illustrate the CVT housing 1000 and the exhaust assembly 300. FIGS. 130-132 illustrate the engine 12 that is coupled with the transaxle assembly 14, the CVT transmission assembly 60 having the CVT housing 1000, and the exhaust assembly 300.

In some embodiments, the CVT intake duct member 1006 includes a first intake duct portion 1006A and a second intake duct portion 1006B. In some embodiments, the first intake duct portion 1006A is configured to be positioned within a geometry (e.g., first recess (R2)) defined by the seatback panel 910, as shown for example in FIGS. 133, 134. In some embodiments, the first recess (R2) is positioned on a rear side of the seatback panel 910. In some embodiments, the first intake duct portion 1006A extends vertically, within the first recess (R2), up to a ROPS lower cross member 918. A top portion 1006C of the first intake duct portion 1006A draws air via an area or cavity 920 defined by the ROPS lower cross member 918 and the seatback panel 910. In some embodiments, the cavity 920 extends longitudinally from side to side. The cavity 920 may be bounded from above by the ROPS lower cross member 918 and below by a portion of the seatback panel 910. In some embodiments, the first intake duct portion 1006A is positioned adjacent and parallel to the second intake duct member 904B of the engine air intake assembly 900 (seen e.g., in FIGS. 133-135, 139). FIGS. 136-137 illustrate side views of the CVT intake duct member 1006 and the engine air intake assembly 900. FIG. 138 illustrates a front view of the CVT intake duct member 1006 and the engine air intake assembly 900 of the engine 12. FIG. 139 illustrates a rear view of the CVT intake duct member 1006 and the engine air intake assembly 900 of the engine 12. In some embodiments, the first intake duct portion 1006A is routed up to a headrest 922, preferably behind driver seat's headrest (seen e.g., in FIGS. 140-144). In such configuration, an opening of the top portion 1006C is facing the rear side of the vehicle 1, thereby drawing air, from the rear side of the vehicle 1, to the CVT housing 1000 (seen e.g., in FIG. 140).

The second intake duct portion 1006B is connected to the CVT housing 1000. The second intake duct portion 1006B is configured to provide air to the CVT housing 1000. One end of the second intake duct portion 1006B is connected to the first intake duct portion 1006A and another end of the second intake duct portion 1006B is connected to the CVT housing 1000. In some embodiments, the second intake duct portion 1006B is connected to the inner CVT cover 1004 at a CVT inlet port 1026 (seen e.g., in FIGS. 122, 128, 130, 135, 140). In some embodiments, the CVT inlet port 1026 is upward of a rotational axis (R3) of the drive clutch 1022. In other words, the CVT inlet port 1026 is positioned at a top of the inner CVT cover 1004 (seen e.g., in FIGS. 122, 128-129, 135). In some embodiments, the CVT inlet port 1026 is offset and forward of the rotational axis (R3) of the drive clutch 102 (seen e.g., in FIG. 140). Airflow provided to the CVT housing 1000 exits the CVT housing 1000 via the CVT exhaust duct member 1008. The CVT exhaust duct member 1008 is connected to the inner CVT cover 1004 at a CVT outlet port 1034 (seen e.g., in FIGS. 122, 128-129, 135). In some embodiments, the CVT outlet port 1034 is positioned at the top of the inner CVT cover 1004. The CVT outlet port 1034 may be rearward and upward of the rotational axis (R3) of the drive clutch 102 (seen e.g., in FIG. 140). In some embodiments, the CVT exhaust duct member 1008 is configured to extend from the CVT outlet port 1034 and face towards the oxygen sensor 346 of the exhaust assembly 300. Accordingly, an opening 1036 of the CVT exhaust duct member 1008 facing towards the oxygen sensor 346, thereby the CVT exhaust duct member 1008 blows out the air, from the CVT housing 1000, towards the oxygen sensor 346 (seen e.g., in FIGS. 128, 130). In some embodiments, the CVT exhaust duct member 1008 is configured to extend from the CVT outlet port 1034 towards the seatback panel 910 and further extend within a second recess (R4) defined by the seatback panel 910 (seen e.g., in FIGS. 141-142). In such configuration, the CVT exhaust duct member 1008 is parallel to the first intake duct portion 1006A of the CVT intake duct member 1006. So that, the CVT exhaust duct member 1008 is routed up to the headrest 922, preferably behind the driver seat's headrest (seen e.g., in FIGS. 140-144). Accordingly, the opening 1036 of the CVT exhaust duct member 1008 facing the rear side of the vehicle 1, thereby blowing air from the CVT housing 1000 to the environment (seen e.g., in FIG. 140).

FIGS. 145-147 illustrates a fuel tank 1300, the engine cooling assembly 700 and a steering assembly 2. The fuel tank 1300 is positioned under a driver seat. As shown in FIG. 145, the fuel tank 1300 is held between the seat support frame 230 and a lower frame structure 240. The fuel tank 1300 includes a fuel duct 1302 and a fuel cap 1304. The fuel duct 1302 extending towards a fuel fill recess. The fuel cap 1304 is securable to an end of the fuel duct 1302. The steering assembly 2 is positioned forward of the driver seat 914A. The steering assembly 2 includes a steering wheel 1352, a power steering unit 1354, and a steering rack 1356. The power steering unit 1354 is positioned between the steering wheel 1352 and the steering rack 1356. In some embodiments, the steering assembly 2 may be connected to the front wheels 51 via a steering linkage 1362. In some embodiments, the steering assembly 2 may be connected to the rear wheels 414 via the steering linkage. The steering assembly 2 may include a steering tilt assembly 1358. The steering tilt assembly 1358 includes a shock absorber 1360 to adjust the tilt configuration of the steering wheel 1352 (seen e.g., in FIG. 147).

FIGS. 148A-178 illustrate a door assembly 4 of the vehicle 1. The door assembly 4 includes one or more doors 1402, a door latch assembly 1404, and other components (seen e.g., in FIG. 148A-148B). The door latch assembly 1404 includes a striker plate 1406, a door handle 1408, a bracket 1410, a spring 1412, a slider or square rod 1414, a washer 1418, an E-Clip 1416, a nut welded bracket 1422, fasteners 1420, 1424, 1426, pad 1428, and a rubber grommet 1430. The door 1402 and door latch assembly 1404 is more streamlined to avoid a projecting striker bar. The door assembly 4 shown uses a plate with a ramp to interface with a biased pin having a complementary ramp on the end.

The striker plate 1406 (see FIG. 169A) is ramped on both sides and can be used for front doors and rear doors. One end is positioned up for the front doors while the other end is positioned up for the rear doors.

Turning now to FIGS. 179-181, the dashboard assembly and display interface mounting is illustrated. The dash 1502 preferably holds the display interface 1504 in a central portion thereof. The display interface 1504 can include the vehicle gauges, a GPS system, and a touchscreen interface for the user to change the screen and vehicle options. The display interface is recessed slightly into the dash with a shade 1506 above, and at least slightly overhanging, the front display surface. The dash is preferably formed of a polyethylene material.

FIG. 180 is a rear view of the dash 1502 with the rear interface and mounting of the display interface 1504 shown. An insert panel 1508 fastens the display interface 1504 and is, in turn securable to the dash 1502. The panel 1508 is preferably formed of a polypropylene material. The insert panel 1508 includes an opening through which a GPS/gauge coupler from the display interface extends for coupling the electronics. The insert panel includes a flexible portion that can slightly move to insert and secure the display interface 1504. A living hinge is provided to do so. Once the display is inserted and the insert panel is secured the display is fixed relative to the dash 1502. A grommet 1512 provides a vibration-absorbing interface mounting for the display interface as it is secured between the panel 1508 and the display interface. The grommet is preferably formed of a rubber material. The electronics preferably include a GPS and radio coupler 1516 and an electronics coupler 1514 to electrically couple the display interface gauges to the engine and other vehicle parameters and device signals (e.g., engine parameters, transmission parameters, suspension parameters, etc.).

The exploded view of FIG. 181 helps to understand the dash assembly. The dash includes a dash opening 1518 to engage with the insert panel 1508 that secures the display interface 1502. Various fasteners, preferably six-four through the back and two through the top, secure the insert panel to the dash with the back of the display interface being partially exposed through the dash opening 1518. The display interface is securable to the insert panel from the outside with fasteners from behind the dash. Likewise, the insert panel is securable to the dash 1502 from the outside with fasteners from behind the dash. This provides an assembly with fewer injection-molded parts. The top of the display interface/gauge 1502 tucks under the shade 1506 while the sides of the display interface are partially exposed in the preferred embodiment.

FIGS. 182-188 illustrate seating assemblies with center consoles that may be deployed for a two-seat configuration or stowed for a three-seat configuration. FIG. 182 shows a seat assembly 1602 including a driver seat 1604, a passenger seat 1606, and a center seat 1608 between the driver seat and the passenger seat. The back of the center seat includes a center console 1610 that may be pivoted down from a bottom hinge to be accessible between the driver seat 1604 and the passenger seat 1606. The center console 1610 is situated on the back of the center seatback 1626. The center console 1610 when not deployed, is positioned within a rear panel storage space 1612 behind the seats. The storage panel 1612 is supported with frame member 1614 secured at least to the top of panel 1612.

The center console 1610 is optionally formed with various features for the comfort and convenience of the passenger and driver. In preferred embodiments, the console 1610 includes driver and passenger arm rests 1616 and 1618, respectively. It also includes storage compartments 1620 for drinks, phones, sunglasses, or other small items. The center console is releasably secured in a stowed position within the rear panel storage space 1612 with a magnet 1622 that engages with a metal interface portion 1624 of the metal frame member 1614. The magnet is fixed to a forward/upward portion of the center console to align with the frame member when the console is in the stowed position. The type and size of magnet 1622 is selected to securely engage the interface portion 1624 to retain the stowed position without being too difficult for the vehicle occupants to pull the console to a deployed position.

The seat assembly 1602 with the driver seat 1604 cut away is shown in FIGS. 183-184 with both the deployed and stowed configurations. In the stowed configuration, a center seatback 1626 is usable with the center seat 1608. The seatback 1626 is fixed to the underside of the console 1610. Also illustrated in FIG. 184 is center buckle 1628 for the center seating occupant.

As illustrated in FIG. 185, when the center console 1610 is deployed, the soft material of seatback 1626 compresses against a soft material of the seat bottom of center seat 1608. The region of interference and compression is a seat interference zone 1630 that damps relative movement between the console/seatback and the bottom portion of center seat 1608. This compression state with zone 1630 is maintained by engagement of a latch plate 1632 extending from a cable 1633 engaged with buckle 1628. See FIG. 186. A plate retainer 1634 includes a tab to engage with an opening in latch plate 1632 when the latch plate 1632 is not engaged with the buckle 1628. See FIG. 187. Thus, the position of the center console 1610 is maintained when deployed and the vehicle moves over rough terrain. Use of the buckle 1628 already in place for a center occupant (when the console is stowed) provides an efficient manner of securing the center console 1610.

An alternative embodiment for securing the console 1610 in a stowed position with the center seatback 1626 ready for use is shown in FIG. 188. In this embodiment, a stud 1636 and grommet hole 1638 is used in place of the magnet 1622 and interface 1624. The stud 1636 is aligned with the grommet hole 1638 when the console 1610 is pivoted upwardly. The grommet hole 1638 is held by a bracket 1640 extending from frame 1614. The specific configuration of the storage compartments of the console 1610 is different from the magnet embodiment to accommodate the positioning of the stud. Note that the stud and grommet may be position-reversed is another alternative embodiment.

The center seat and console system described provides an easy-to-use and secure, damped arrangement for both the seatback use and the center console use while the vehicle is used.

The fasteners used throughout the present disclosure may be nut and bolt fasteners used in automobile industry. In some embodiments, the bolt in such fasteners may have a hex-head, followed by a hex-headed cap screw and a stud.

It is to be noted that different values and parameters mentioned in the description are exemplary in nature and are not intended to bound the specification in any manner.

Finally, while the present invention has been described above with reference to various exemplary embodiments, many changes, combinations, and modifications may be made to the exemplary embodiments without departing from the scope of the present invention. For example, the various components may be implemented in alternative ways. These alternatives can be suitably selected depending upon the particular application or in consideration of any number of factors associated with the operation of the device. In addition, the techniques described herein may be extended or modified for use with other types of devices. These and other changes or modifications are intended to be included within the scope of the present invention.

What is claimed is:

1. An off-road vehicle comprising a rear mount assembly for attaching an engine assembly to a frame, the rear mount assembly comprising:
a rear mount bracket defined by a rear central portion having a first side edge, a second side edge, and a supporting flange extending upwardly from each of the first side edge and the second side edge, the rear mount bracket configured to be attached to a rear part of the engine assembly at the supporting flange thereof;
a rear transverse bar defined by a first end, a second end, and a rear central part extending therebetween, the rear central part having a first top surface, the rear transverse bar configured to be attached to the rear central portion of the rear mount bracket at the first top surface of the rear central part; and
a pair of rear isolators configured to be attached to the rear transverse bar.

2. The off-road vehicle of claim 1, wherein a lower surface of the rear central portion abuts the first top surface of the rear transverse bar when attached therewith.

3. The off-road vehicle of claim 1, wherein the pair of rear isolators comprises a first rear isolator configured to be attached to the first end of the rear transverse bar and a second rear isolator configured to be attached to the second end of the rear transverse bar and wherein the first rear isolator and the second rear isolator are positioned in parallel to each other when attached with the first end and the second end of the rear transverse bar.

4. The off-road vehicle of claim 1, wherein the pair of rear isolators are positioned in parallel to a pair of front isolators of a front mount assembly.

5. The off-road vehicle of claim 1, wherein the engine assembly comprises an engine and a transaxle, the engine and transaxle being coupled together with at least one bracket, the at least one bracket having a portion secured to the engine with a member extending transverse to the longitudinal axis of the vehicle and a portion secured to the transaxle with a member extending substantially parallel to the longitudinal axis of the vehicle.

6. The off-road vehicle of claim 5, wherein the at least one bracket includes fixtures to secure a compressor.

7. The off-road vehicle of claim 1, further comprising a rear suspension assembly having a frame, the vehicle extending from a front side to a rear side and having a longitudinal central axis passing therethrough, the rear suspension assembly comprising:
a pair of rear upper A-arms; and
a pair of rear lower A-arms;
each of the pair of the rear upper A-arms comprising a rear upper forward member and a rear upper rearward member, the rear upper forward member of each of the pair of the rear upper A-arms comprising a first section extending from a first wheel mounting end, a second section attached to the first section at least at a first angle and extending towards the rear side of the vehicle, and a third section attached to the second section and extending towards the frame, thereby forming a curved rear upper forward member.

8. The off-road vehicle of claim 1, further comprising a hitch assembly comprising:
a base plate; and
a top member configured to be coupled to the base plate;
wherein the base plate and the top member, when coupled, form a second cavity corresponding to a drawbar for receiving the drawbar therewithin.

9. An off-road vehicle comprising an exhaust assembly, the off-road vehicle extending in a longitudinal direction parallel to a horizontal plane and comprising a frame, an engine assembly coupled with the frame using a front mount assembly and a rear mount assembly, the exhaust assembly comprising:
an exhaust muffler;
an exhaust pipe; and
a muffler mount bracket, the muffler mount bracket defined by a head end and a tail end and is coupled to the exhaust muffler at the head end and to the rear mount assembly at the tail end.

10. The off-road vehicle of claim 9, wherein the exhaust muffler is defined by a first side surface and a second side surface, each of the first side surface and the second side surface having a major axis and a minor axis, wherein the exhaust muffler is positioned in a transverse direction of the vehicle such that the major axis is at least at an angle with the horizontal plane.

11. The off-road vehicle of claim 10, wherein the major axis M1 is positioned at a first angle with the horizontal plane H such that a cargo box pivots about a tilt axis T1 to a maximum tilt angle without interfering with the exhaust muffler.

12. The off-road vehicle of claim 10, wherein the exhaust muffler comprises a connecting tube, the connecting tube being coupled to the any one of the first side surface and a second side surface at a second proximal end and to a corresponding baffle near the first side surface or the second side surface at a second distal end, the proximal end having a diameter corresponding to a pipe diameter of the exhaust pipe and the second distal end having a diameter corresponding to the first diameter.

13. The off-road vehicle of claim 9, wherein the exhaust pipe comprises a first pipe configured to be coupled to an exhaust manifold and a second pipe configured to be coupled to the exhaust muffler, the first pipe being secured to the second pipe with a flexible coupler.

14. The off-road vehicle of claim 9, further comprising a CVT laterally adjacent the engine assembly, wherein the engine assembly defines a first width, and wherein the exhaust pipe between the engine and the muffler falls laterally within the first width.

15. The off-road vehicle of claim 14, wherein the engine and CVT define a second width and wherein the exhaust muffler is positioned laterally within the second width.

16. The off-road vehicle of claim 9, further comprising an engine cooling system comprising a radiator and ducts extending from the radiator to the engine, the ducts including straight ducts coupled to curved ducts, the straight ducts extending beneath a passenger cabin of the vehicle, the ducts under the passenger cabin being primarily metal, the ducts fluidly connecting the straight ducts to the radiator being a substantially elastomeric material.

17. The off-road vehicle of claim 16, further comprising two fans adjacent the radiator and a fan control system providing a fan modes in which both fans run at low speed, both fans are off, and both fans run at high speed.

18. An off-road vehicle comprising a mount assembly for a display interface in the vehicle, the mount assembly comprising:
a dashboard having an opening therein; and
a display mount configured to engage the dashboard opening, the display mount having an opening to secure a display interface;
wherein the display mount is securable to the dashboard from the outside;
wherein the display interface is securable to the display mount from the outside;
the mount assembly further comprising fasteners securable between the dashboard and the display mount from behind the dashboard.

19. The off-road vehicle of claim 18, wherein the display mount includes a mount surface secured to a remainder of the display mount with a living hinge to provide some flexibility between the mount surface and the remainder.

20. The off-road vehicle of claim 18, wherein the display mount covers a top of a display while leaving portions of the sides of such display exposed.

21. The off-road vehicle of claim 18, further comprising a door and a door latch, the door latch including a latch pin and a lever secured to the door, the lever being pivotally coupled to the latch pin to pull the latch pin axially to release the pin from engagement with a vehicle frame.

22. The off-road vehicle of claim 18, further comprising a seating configuration with a driver seat, a passenger seat, and a center seat, the center seat having a seatback with a center console on a back thereof, the seatback being releasably securable in an upward, deployed position with a coupler engagement with a frame member.

23. The off-road vehicle of claim 22, wherein the center console further includes a latch plate couplable to a seat belt buckle for the center seat.

24. An off-road vehicle comprising a continuously variable transmission (CVT), the CVT comprising a drive clutch, a driven clutch, and a housing, the housing also enclosing a flywheel, the CVT including a removable wall member between the flywheel and the drive clutch.

25. The off-road vehicle of claim 24, further comprising a chassis forming an occupant portion and an engine portion, an engine air intake duct coupled to the engine to provide combustion air to the engine, the air intake duct extending from an engine air planum to behind the occupant portion of the vehicle and forward of the engine, the duct including a debris trap near an intake opening of the duct at the side of the vehicle.
